(19) United States
(12) Patent Application Publication
(10) Pub. No.: US 2025/0281781 A1
(43) Pub. Date: Sep. 11, 2025

(54) QUENCHING DEVICE, HYDROGEN PRODUCTION DEVICE, HYDROGEN PRODUCTION METHOD AND REACTOR FOR PHOTOCHEMICAL REACTION

(71) Applicants: MITSUBISHI CHEMICAL CORPORATION, Tokyo (JP); JAPAN TECHNOLOGICAL RESEARCH ASSOCIATION OF ARTIFICIAL PHOTOSYNTHETIC CHEMICAL PROCESS, Tokyo (JP)

(72) Inventors: Hideyoshi HORIE, Tokyo (JP); Manabu OKUYAMA, Tokyo (JP); Kaoru HORIUCHI, Tokyo (JP); Motohiko SUMINO, Tokyo (JP); Nobuko KARIYA, Tokyo (JP); Takeshi KANEDA, Tokyo (JP); Naoyuki SAKAMOTO, Tokyo (JP); Yoshitada MINO, Tokyo (JP)

(73) Assignees: MITSUBISHI CHEMICAL CORPORATION, Tokyo (JP); JAPAN TECHNOLOGICAL RESEARCH ASSOCIATION OF ARTIFICIAL PHOTOSYNTHETIC CHEMICAL PROCESS, Tokyo (JP)

(21) Appl. No.: 18/773,130

(22) Filed: Jul. 15, 2024

Related U.S. Application Data
(63) Continuation of application No. PCT/JP2023/001165, filed on Jan. 17, 2023.

(30) Foreign Application Priority Data
Jan. 17, 2022 (JP) 2022-005161
Jan. 17, 2022 (JP) 2022-005162
Jan. 17, 2022 (JP) 2022-005163
Jan. 17, 2022 (JP) 2022-005164
Dec. 28, 2022 (JP) 2022-212508
Dec. 28, 2022 (JP) 2022-212509
Dec. 28, 2022 (JP) 2022-212511
Dec. 28, 2022 (JP) 2022-212512

(51) Int. Cl. A62C 4/02; A62C 3/06; B01J 19/12

(52) U.S. Cl. CPC A62C 4/02; A62C 3/06; B01J 19/127; B01J 2219/00265; B01J 2219/1203

(57) ABSTRACT

A gist of the present invention provides a flame extinction device which is excellent in flame propagation suppressive effect and in shock wave propagation suppressive effect, and a hydrogen production device including the flame extinction device. A flame extinction device (1) includes: a flame propagation suppression section (3) having a porous portion on the first pipe (10) side and/or the second pipe (22) side when seen from a connective piping section (20); and a pressure reduction section (2) that reduces a risen internal pressure at an end part of a third pipe (23) which is not orthogonal to any of the first pipe (10) and the second pipe (22).

This application is a Continuation of PCT International Application No. PCT/JP2023/001165 filed in Japan on Jan. 17, 2023, which claims the benefit of Patent Application No. 2022-005161 filed in Japan on Jan. 17, 2022, Patent Application No. 2022-005162 filed in Japan on Jan. 17, 2022, Patent Application No. 2022-005163 Jan. 17, 2022, Patent Application No. 2022-005164 filed in Japan on Jan. 17, 2022, Patent Application No. 2022-212511 filed in Japan on Dec. 28, 2022, Patent Application No. 2022-212512 filed in Japan on Dec. 28, 2022, Patent Application No. 2022-212508 filed in Japan on Dec. 28, 2022, and Patent Application No. 2022-212509 filed in Japan on December 28, the entire contents of which are hereby incorporated by reference.

### TECHNICAL FIELD

A first gist and a second gist of the present invention relate to a flame extinction device and a hydrogen production device using the flame extinction device. A third gist of the present invention relates to a photochemical reactor having a photocatalyst, and a device and a method for producing hydrogen and oxygen using the photochemical reactor. A fourth gist of the present invention relates to a device and a method for producing hydrogen and oxygen by decomposing water with a photocatalyst. The term “hydrogen production device” means a “device for producing hydrogen and oxygen” in the third gist of the present invention, and means a “hydrogen-oxygen production device” in the fourth gist of the present invention. The “hydrogen production method” means a “method for producing hydrogen and oxygen” in the third gist of the present invention, and means a “hydrogen-oxygen production method” in the fourth gist of the present invention. In any of the first gist through the fourth gist of the present invention, the term “means” can be replaced with the term such as “device” or “method” as appropriate.

### BACKGROUND ART

### [Background Art of First Gist and Second Gist of Present Invention]

In apparatuses, pipes, storage tanks, and the like in which combustible gases are generated, caused to pass through, and stored, deflagration and detonation may occur if the gas is ignited for any reason. As a result, a shock wave may occur and flame propagation may occur in the apparatuses, pipes, and storage tanks. Such a shock wave and flame propagation may further cause breakage of the apparatus and, in some cases, a serious accident that affects human life.

In order to prevent such an accident, a flame arrester has been used to block flame and a shock wave that propagate through a flow path including the apparatus, pipe, and storage tank. In view of the function of the flame arrester, the flame arrester is demanded to cause a combustible gas to pass therethrough with a small pressure loss in a normal state. Meanwhile, in a case of occurrence of deflagration or detonation, the flame arrester is demanded to have excellent flame extinction performance, performance to stop a shock wave due to deflagration or detonation, shock resistance, and the like.

In recent years, a hydrogen gas has attracted attention as an energy source. In particular, in order to obtain green hydrogen which does not generate carbon dioxide in production, a large number of methods have been proposed in which water is decomposed by using energy of sunlight to obtain hydrogen. However, it is likely that a configuration in which hydrogen and oxygen are simultaneously generated from water is employed from the viewpoint of cost. In such a case, a separator membrane is disposed downstream to separately obtain a hydrogen-rich mixed gas and an oxygen-rich mixed gas. However, a mixed gas of hydrogen and oxygen generated by complete decomposition of water using a photocatalyst has a stoichiometric composition of “hydrogen:oxygen=2:1” that derives highest explosion power. Moreover, energy (minimum ignition energy) for ignition is extremely low, i.e., approximately 0.02 mJ, which is approximately 1/10 of hydrocarbon. Therefore, such a mixed gas is extremely easy to ignite. In a case of explosion, the mixed gas easily transitions to a detonation state where the explosion velocity exceeds the sonic velocity.

For example, the inside of a transportation pipe provide between (i) a reactor for complete decomposition of water, which includes a photocatalyst, and (ii) the gas separation membrane for separating a hydrogen gas and an oxygen gas generated here has the hydrogen-oxygen stoichiometric gas composition described above. Therefore, the transportation pipe can be said to be in a potentially dangerous state. In particular, in a case where pressurization is carried out for transportation of the generated gas, the power of detonation is also quite different from a normal state. In a case where the hydrogen-oxygen mixed gas is a hydrogen detonating gas having a stoichiometric composition, a detonation propagation velocity thereof is approximately 3000 m/s at an atmospheric pressure. However, in some cases, the detonation propagation velocity exceeds 6000 m/s in experiments by the inventors of the present invention. Once transitioned to detonation, it is not easy to suppress influence of a shock wave thereof and suppress flame propagation.

As a device for suppressing flame propagation, a flame arrester and the like have conventionally been known. Depending on a structure of a flame arrester element, there are a mesh (wire gauze) type, a crimp ribbon (corrugated plate) type, a porous plate type, and the like. As constituent materials, metals, ceramics, and the like are used.

A safety device called a flashback arrester or a flashback suppressor is known to include a composite function in which a valve for preventing backflow of gas is closed by various mechanisms.

Patent Literature 1 discloses a flame arrester made of inorganic fiber cloth.

Patent Literature 2 discloses a hydrogen combustion device in which a flame extinction element including a set of holes smaller than a flame extinction diameter is disposed in a hydrogen supply line. Patent Literature 2 discloses a test in which one half side of a pipe (gas ignition side) provided with the flame extinction element is filled with a mixed gas of hydrogen:oxygen=2:1, and the mixed gas is ignited and flame propagation to the other half side (gas supply source) is confirmed.

Patent Literatures 3 and 4 indicate that a water-sealed flashback arrester may be provided midway through a hydrogen supply line, and a rupture disk may be provided for releasing a pressure of water if a pressure of the water-sealed part has risen.

In addition, for the background art of the second gist of the present invention, Patent Literature 5 indicates that: a rupture disk is provided at a vent of a structure; a bag is provided for collecting scattered substances at the release side of the vent; and when the bag is expanded and developed, it is possible to collect substances scattered due to explosion while suppressing an internal pressure of the structure.

### (Background Art of Third Gist of Present Invention)

In regard to development of a high-performance light-energy conversion system using sun energy as renewable energy, the importance of the development has sharply increased in recent years from the viewpoint of aiming at suppression of global warming and shift away from dependence on depleting fossil resources. Among those, a technique for producing hydrogen by decomposing water using sun energy can be used not only as a current petroleum refining technique and a raw material supply technique for ammonia and methanol, but also as an energy carrier in fuel cells. Social demands for development of that technique are increasingly growing.

Water decomposition reaction by a photocatalyst has been widely studied from long ago.

The decomposition reaction of water in an acidic aqueous solution on photocatalytic particles has been inferred as follows.

H₂O+2 h⁺→1/2O₂+2H⁺ (1):

2H⁺+2e⁻→H₂ (2):

Various reaction devices using such a photocatalyst and methods for producing hydrogen and oxygen by decomposing water using the reaction device have been proposed. Various types of reactor vessels for causing a photocatalyst to react with water are known. Many of the reactor vessels are flat-shaped in order to easily receive sunlight. Among those, Patent Literature 6 discloses an example in which a cylindrical vessel is used. The cylindrical vessel is excellent in terms of strength and gas-tightness under a condition in which a pressure is a positive pressure. The cylindrical vessel can also deal with blockage or the like caused downstream of the reactor.

The reaction device in Patent Literature 6 uses a cylindrical vessel, and is provided with a top plate and a substrate which are made 4 light transmissive material. A groove is provided to the upper surface of the substrate, and a photocatalytic layer is formed on the inner surface of the groove. By stacking the top plate onto the substrate, a reaction device is constituted in which the groove serves as a flow path hole. A pipe flow is formed by causing water to flow in a water screen form along the inner peripheral surface of the flow path hole, i.e., the groove bottom surface, the groove side surface, and the groove top surface, and nitrogen is caused to pass through as a central gas flow. By externally irradiating the reaction device with light, hydrogen and oxygen are generated and taken out from the device together with the nitrogen gas.

### (Background Art of Fourth Gist of Present Invention)

In a hydrogen-oxygen production process in which water is decomposed using a photocatalyst to generate a gas (hereafter sometimes referred to as a raw gas) containing hydrogen and oxygen, and hydrogen and oxygen are separated from the raw gas by a separator membrane, if condensate water is attached to the separation membrane, the performance to separate hydrogen and oxygen decreases.

Patent Literature 7 discloses a method in which water is separated from a raw gas using a gas-liquid separator membrane, and then hydrogen and oxygen are separated using a membrane.

In this method, however, although condensate water is removed from the raw gas by the gas-liquid separator membrane, water vapor is not removed. Therefore, water vapor condenses on the separator membrane for hydrogen or oxygen, and the separation performance of the separator membrane decreases.

Patent Literature 8 discloses a method and a device in which water vapor is separated from a gas containing hydrogen, oxygen, and water vapor using a molecular sieve membrane, and then the hydrogen is separated by a membrane. However, in the method and the device disclosed in Patent Literature 8, there is a risk that condensate water is attached to the molecular sieve membrane, and removal of water and water vapor is insufficient.

The inventors of the present invention have also noticed a new problem in which, if the humidity of the gas which passes through in such a manner is reduced, ignition by static electricity is problematic. In this case, the passing gas is a mixed gas containing hydrogen and oxygen, which has an extremely high burning velocity and easily enters a state called detonation. Therefore, it is necessary to consider a structure that can ensure flame extinction and that can localize damage. Although Patent Literature 9 indicates some flame extinction structures, those structures do not seem to be sufficient against a mixed gas containing hydrogen and oxygen.

### CITATION LIST

### Patent Literature

[Patent Literature 1]
Japanese Patent Application Publication Tokukai No. 2014-258
[Patent Literature 2]
Japanese Patent Application Publication Tokukai No. 2017-219221
[Patent Literature 3]
Japanese Patent Application Publication Tokukai No. 2018-194212
[Patent Literature 4]
Japanese Patent Application Publication Tokukai No. 2020-26921
[Patent Literature 5]
Japanese Patent Application Publication Tokukai No. 2014-130028
[Patent Literature 6]
Japanese Patent Application Publication Tokukai No. 2009-233606
[Patent Literature 7]
International Publication No. 2013/021508
[Patent Literature 8]
Japanese Patent Application Publication Tokukai No. 2018-202413
[Patent Literature 9]
Japanese Patent Application Publication Tokukai No. 2014-258

### SUMMARY OF INVENTION

### Technical Problem

### [Object to be Attained by First Gist of Present Invention]

Simple flame arresters do not sufficiently have excellent flame extinction performance against occurrence of deflagration or detonation, or performance to stop a shock wave due to deflagration or detonation and shock resistance. In particular, such simple flame arresters are insufficient for a mixed gas of hydrogen and oxygen which has an extremely high burning velocity. In a flashback arrester, a flashback suppressor, and the like which includes a mechanism such as a valve, basically, a direction of stopping flame propagation is limited to one direction, and it takes time for the valve to operate. Under such conditions, it is not practical to rely on such apparatuses in view of inability to appropriately suppress detonation or the like with high explosion velocity and assuming only a dry gas.

An object of the present invention is to provide a flame extinction device which is excellent in flame propagation suppressive effect and in shock wave propagation suppressive effect, and a hydrogen production device including the flame extinction device.

### [Object to be Attained by Second Gist of Present Invention]

In particular, in a hydrogen production device using sunlight as an energy source, it is difficult to stop sunlight itself, even if any abnormality, specifically, ignition has occurred. Therefore, it is difficult to completely stop generation of hydrogen. Therefore, even in a case where a flame extinction device or a pressure release device operates and flame propagation has subsided, hydrogen continues to be generated. Therefore, once a safety valve, a rupture disk unit, or the like is released, thereafter, a hydrogen gas or the like that has a risk of ignition is released into the surrounding area.

Even if the scale of hydrogen explosion or detonation of a hydrogen-oxygen mixed gas is small, the sound pressure is large, and damage may be caused to surrounding other apparatuses by a shock wave.

The collection bag disclosed in Patent Literature 5 is intended to prevent destruction of a power plant building or the like while assuming hydrogen explosion, and is provided in a building or the like rather than a device itself. If it is intended to reduce an explosion pressure of the entire building while mainly preventing scatter of radioactive dust, the collection bag virtually does not function as a safety device for preventing collapse of the building, unless the gas passes through the collection bag.

An object of the present invention is to provide (i) a flame extinction device including a mechanism that suppresses damage to other apparatuses due to propagation of a shock wave to the outside of the system in operation of the flame extinction device, that simultaneously prevents excessively large sound pressure propagation to the outside, and that continuously prevents leakage of a raw gas or the like from the flame extinction device to the outside of the system, and (ii) a hydrogen production device including the flame extinction device.

### [Object to be Attained by Third Gist of Present Invention]

In the reaction device disclosed in Patent Literature 6, it is necessary to control a gas rate of the central gas flow and a supply rate of the liquid so that a pipe flow is formed. In the first place, obtained hydrogen and oxygen are diluted, and it is therefore difficult to recover hydrogen and oxygen. If a pipe flow is not formed, a microreactor has a structure in which a large number of minute reactors are connected to each other, and thus the device is complicated. Therefore, it is difficult to apply such a device to a large area such as production of hydrogen by water decomposition using sunlight.

There is also a tendency that a photocatalytic ability cannot be achieved at a small scale in a reaction device that has a practical size and includes water and a photocatalyst.

As another problem, in a large-scale reaction device including a photocatalyst and water, safety measures are necessary. This is because a generated gas is a detonating gas, which ignites with slight energy, explodes, and may transition to detonation (that is a phenomenon in which combustion propagates at a supersonic speed, and which is difficult to control due to the supersonic speed and an accompanied shock wave). In a normal chemical process, an explosive range is avoided by dilution. However, such a measure makes it difficult to recover hydrogen. Therefore, it is necessary to safely recover the generated gas and separate hydrogen without dilution.

In the conventional technique, a mechanism is known in which a flashback arrester (flame arrester) is provided to a gas transportation pipe for a combustible gas, and flame extinction is carried out in a case of possible ignition. However, such a mechanism is not sufficient as a device breakage prevention mechanism against a mixed gas (such as a detonating gas) which has extremely high power in explosion.

In a case where an amount of the detonating gas itself is large, the explosion power itself will be large, and the scale of destruction is necessarily large, even if measures to prevent breakage of the device against such a detonating gas are taken. Therefore, it is necessary to reduce the amount of detonating gas present in the system and also, if any problem occurs, it is necessary to prevent generation of a new detonating gas in a comparatively short time. For example, if the diameter of the reaction tube is reduced, the amount of a reactant (e.g., water) which is decomposed by photoreaction can be reduced. However, an actual artificial photosynthesis plant has a size of at least several hundred meters in all directions. An increase in the number of reaction tubes in accordance with reduction of the tube diameter directly leads to difficulty in maintenance and is dangerous in another sense.

Meanwhile, a photocatalyst is often used in a combination of a photocatalyst and a promoter. Here, the promoter often exists in contact with the photocatalyst, and is usually very small in size. Therefore, a specific surface area is also large, and the promoter is dissolved in water and slightly lost anyhow. As a result, the ability of the photocatalyst to decompose water is likely to decrease. In order to prevent this, it is preferable to reduce a region where water in contact with the photocatalyst can be present. As described above, however, it is not preferable for an artificial photosynthesis plant to increase the number of reaction tubes.

In view of this, as a result of diligent studies by the inventors, it has been found that, in a case where a substance to react (which can be water in a case of hydrogen production using a photocatalyst) is caused to be present between an outer cylinder and an inner cylinder of a double-tube structure, such a configuration improves the catalytic efficiency of the initial photocatalyst, and it is possible to extend the lifetime of the photocatalyst, and it is possible to achieve safety and a light weight with a small retention amount of detonating gas. Moreover, it has been found that, by combining with a specific safety device, it is possible to provide a photochemical reaction system including a safety device with which, if an explosion occurs, the explosion does not lead to detonation or which can localize a range of detonation and limit a range of crisis to a narrower range. Thus, the present invention has been accomplished.

An object of the present invention is to connect (i) a photochemical reactor that has a high reaction velocity, achieves a long lifetime of photocatalyst, and is easily controlled in operation to (ii) a method and device for producing hydrogen and oxygen using the photochemical reactor.

### [Object to be Attained by Fourth Gist of Present Invention]

An object of the present invention is to provide a hydrogen-oxygen production device, a hydrogen-oxygen production method, and a method for operating a hydrogen-oxygen production device, which can sufficiently remove both liquid water and water vapor from a raw gas containing hydrogen and oxygen generated by decomposing water with a photocatalyst. Furthermore, preferably, an aspect is provided which is combined with a device that can rapidly extinguish flame if ignition of a raw gas occurs when humidity has decreased and the raw gas is liable to ignite.

### Solution to Problem

### [Means for Attaining Object in First Gist of Present Invention]

As a result of studies, the inventors of the present invention have found a structure that can suppress flame propagation even in detonation caused when an oxygen-hydrogen mixed gas ignites, and thus accomplished the present invention.

The gist of the present invention is as follows.

<1> A flame extinction device that is disposed between (i) a first pipe to which a raw gas is supplied from one end side and (ii) a second pipe which is disposed at an angle with the first pipe, the flame extinction device having constituent elements (1) through (3) below:
(1) a connective piping section that allows a raw gas to flow from the first pipe to the second pipe and that simultaneously has a branch to a third pipe;
(2) a flame propagation suppression section that is provided between the connective piping section and the first pipe and/or the second pipe and that has a housing, as well as a bent portion, a narrowed portion, and a porous portion in a flow path in the housing; and
(3) a pressure reduction section that is disposed at an end part of the third pipe which is not orthogonal to an extension line of the first pipe in a flowing direction of the raw gas in the first pipe.

<2> The flame extinction device described in <1>, which includes a part in which a diameter of the narrowed portion of the flow path in the housing is 0.3 mm or more and 4.5 mm or less.

<3> The flame extinction device described in <1> or <2>, in which: a pipe of the connective piping section has a substantially circular cross section.

<4> The flame extinction device described in any one of <1> through <3>, in which: a pressure resistance P(tube) (MPa(G)) of the connective piping section satisfies a formula below:

2≤P(tube)≤30.

<5> The flame extinction device described in any one of <1> through <4>, in which: the pressure reduction section includes a reversible pressure release device; and a lowest release pressure P(release) (MPa(G)) of the reversible pressure release device satisfies a formula below:

0.1≤P(release)≤0.98.

<6> The flame extinction device described in any one of <1> through <4>, in which: the pressure reduction section includes a rupture disk; and a burst pressure P(burst) (MPa(G)) of the rupture disk satisfies a formula below:

0.25≤P(burst)≤12.

<7> The flame extinction device described in <6>, in which: the rupture disk is disposed to have a planar shape or a convex shape with respect to the third pipe.

<8> The flame extinction device described in any one of <1> through <7>, further including: a shock absorption section that surrounds the pressure reduction section.

<9> The flame extinction device described in any one of <1> through <8>, in which: the housing has a metallic portion.

<10> The flame extinction device described in any one of <1> through <9>, in which: a porous body constituting the porous portion has a substantially columnar outer shape with a substantially columnar internal space that penetrates from top to bottom at a center in a radial direction of the porous body.

<11> The flame extinction device described in any one of <1> through <10>, in which: a porous body constituting the porous portion contains metal or ceramic.

<12> The flame extinction device described in any one of <1> through <11>, in which: a porous body constituting the porous portion has gaps each having a width of 0.50 μm or more and 2.45 μm or less in a longitudinal direction.

<13> The flame extinction device described in any one of <1> through <11>, in which: a porous body constituting the porous portion has gaps each having a width of 50 μm or more and 100 μm or less in a longitudinal direction.

<14> The flame extinction device described in any one of <1> through <13>, in which: the raw gas is a mixed gas containing hydrogen and oxygen.

<15> The flame extinction device described in any one of <1> through <14>, in which: the raw gas is a mixed gas which entrains water and contains hydrogen, oxygen, and water vapor.

<16> The flame extinction device described in <14> or <15>, in which: the mixed gas is a gas obtained by decomposing water.

<17> The flame extinction device described in any one of <1> through <16>, in which: the raw gas is in an explosive range.

<18> The flame extinction device described in any one of <1> through <17>, in which: a pressure of the raw gas is a raised pressure.

<19> A hydrogen production device including: a generation section that generates a hydrogen-containing gas; and a flame extinction device that communicates with the generation section, the flame extinction device being the flame extinction device described in any one of <1> through <18>.

<20> The hydrogen production device described in <19>, in which: the generation section generates hydrogen while utilizing sunlight.

### [Means for Attaining Object in Second Gist of Present Invention]

The inventors of the present invention have found that, in a case where a shock absorption section is provided which surrounds or makes contact with a pressure reduction section that reduces a pressure of the flame extinction device, it is possible to prevent a gas released from the pressure reduction section to the outside from being continuously released to the outside from the system after flame extinction, and thus accomplished the present invention.

The gist of the present invention is as follows.

<1> A flame extinction device that is disposed between (i) a first pipe to which a raw gas is supplied from one end side and (ii) a second pipe, the flame extinction device having constituent elements (1) through (4) below:
(1) a connective piping section that allows a raw gas to flow from the first pipe to the second pipe and that simultaneously has a branch to a third pipe;
(2) a flame propagation suppression section that is provided between the connective piping section and the first pipe and/or the second pipe and that has a housing, as well as a bent portion and a narrowed portion in a flow path in the housing;
(3) a pressure reduction section that is disposed via the third pipe; and
(4) a shock absorption section that surrounds and/or makes contact with the pressure reduction section.

<2> The flame extinction device described in <1>, in which the flame propagation suppression section has a porous portion.

<3> The flame extinction device described in <1> or <2>, which includes a part in which a diameter of the narrowed portion of the flow path in the housing is 0.3 mm or more and 4.5 mm or less.

<4> The flame extinction device described in any one of <1> through <3>, in which: the connective piping section has a substantially circular cross section.

<5> The flame extinction device described in any one of <1> through <4>, in which: a pressure resistance P(tube) (MPa(G)) of the connective piping section satisfies a formula below:

2≤P(tube)≤30.

<6> The flame extinction device described in any one of <1> through <5>, in which: the pressure reduction section includes a reversible pressure release device; and a lowest release pressure P(release) (MPa(G)) of the reversible pressure release device satisfies a formula below:

0.1≤P(release)≤0.98.

<7> The flame extinction device described in any one of <1> through <5>, in which: the pressure reduction section has a rupture disk; and a burst pressure P(burst) (MPa(G)) of the rupture disk satisfies a formula below:

0.25≤P(burst)≤12.

<8> The flame extinction device described in <7>, in which: the rupture disk is disposed to have a concave shape with respect to the third pipe.

<9> The flame extinction device described in any one of <1> through <8>, in which: a pressure of the shock absorption section in a normal state is substantially an atmospheric pressure.

<10> The flame extinction device described in any one of <1> through <9>, in which: the shock absorption section allows a gas to pass therethrough from outside the shock absorption section.

<11> The flame extinction device described in <10>, in which: the gas which passes through the shock absorption section contains nitrogen.

<12> The flame extinction device described in any one of <1> through <11>, in which: the housing has a metallic portion.

<13> The flame extinction device described in any one of <1> through <12>, in which: a narrowed flow path in the housing includes a nonlinear part.

<14> The flame extinction device described in any one of <2> through <13>, in which: a porous body constituting the porous portion has a substantially columnar outer shape with a substantially columnar internal space that penetrates from top to bottom at a center in a radial direction of the porous body.

<15> The flame extinction device described in any one of <2> through <14>, in which: a porous body constituting the porous portion contains metal or ceramic.

<16> The flame extinction device described in any one of <2> through <15>, in which: a porous body constituting the porous portion has gaps each having a width of 0.50 μm or more and 2.45 μm or less in a longitudinal direction.

<17> The flame extinction device described in <2> through <15>, in which: a porous body constituting the porous portion has gaps each having a width of 50 μm or more and 100 μm or less in a longitudinal direction.

<18> The flame extinction device described in any one of <1> through <17>, in which: the raw gas is a mixed gas containing hydrogen and oxygen.

<19> The flame extinction device described in any one of <1> through <18>, in which: the raw gas is a mixed gas which entrains water and contains hydrogen, oxygen, and water vapor.

<20> The flame extinction device described in <18> or <19>, in which: the mixed gas is a gas obtained by decomposing water.

<21> The flame extinction device described in any one of <1> through <20>, in which: the raw gas is in an explosive range.

<22> The flame extinction device described in any one of <1> through <21>, in which: the raw gas is used at an atmospheric pressure or in a pressurized state.

<23> A hydrogen production device including: a generation section that generates the raw gas; and a flame extinction device that communicates with the generation section, the flame extinction device being the flame extinction device described in any one of <1> through <22>.

<24> The hydrogen production device described in <23>, in which: the generation section generates hydrogen while utilizing sunlight.

### [Means for Attaining Object in Third Gist of Present Invention]

The gist of the present invention is as follows.

<1> A photochemical reactor for carrying out photochemical reaction, the photochemical reactor including: an inner cylinder; and an outer cylinder which is constituted by a material that transmits light used in reaction, a space in which a liquid is to be present being formed between the outer cylinder and the inner cylinder, a photocatalyst being provided on at least one of an outer peripheral surface of the inner cylinder and an inner peripheral surface of the outer cylinder, and both ends of the inner cylinder being sealed.

<2> The photochemical reactor described in <1>, in which: an anti-reflective film is provided to an inner peripheral surface and/or an outer peripheral surface of the outer cylinder.

<3> The photochemical reactor described in <1>, in which: a light reflective film is provided to an inner peripheral surface of the inner cylinder.

<4> The photochemical reactor described in any one of <1> through <3>, in which: the photocatalyst is a photocatalyst for water decomposition.

<5> A production device for producing hydrogen and oxygen, the production device including: the photochemical reactor described in <4>; and a separator membrane device that separates hydrogen and oxygen from a gas generated by the photochemical reactor.

<6> A method for producing hydrogen and oxygen, in which: hydrogen and oxygen are produced by causing water to be present in a space between the outer cylinder and the inner cylinder of the photochemical reactor of the production device described in <5>, and externally irradiating the outer cylinder with light.

### [Means for Attaining Object in Fourth Gist of Present Invention]

<1> A hydrogen-oxygen production device, including: a water decomposition section that generates a gas containing hydrogen and oxygen by decomposing water with a photocatalyst; a condensate water removal section that carries out a condensate water removal process with respect to the gas supplied from the water decomposition section; a humidity reduction section that carries out a humidity reduction process with respect to the gas supplied from the condensate water removal section; and a membrane separation section that separates, by a membrane, hydrogen and/or oxygen from the gas supplied from the humidity reduction section.

<2> The hydrogen-oxygen production device described in <1>, further including: a gas-liquid separation section into which the gas is introduced from the water decomposition section, the gas which has passed through the gas-liquid separation section being introduced into the condensate water removal section.

<3> The hydrogen-oxygen production device described in <1> or <2>, further including: a pipe for guiding the gas from the water decomposition section to the condensate water removal section, the pipe being provided in a downslope manner toward the water decomposition section.

<4> The hydrogen-oxygen production device described in any one of <1> through <3>, in which: the humidity reduction section includes a hygroscopic material that adsorbs moisture.

<5> The hydrogen-oxygen production device described in <4>, further including: a regenerative gas supply means for supplying a regenerative gas for removing moisture from the hygroscopic material.

<6> The hydrogen-oxygen production device described in any one of <1> through <5>, further including a flame extinction device, the flame extinction device being disposed between (I) a first pipe to which a raw gas is supplied from one end side and (II) a second pipe which is disposed at an angle with the first pipe, the flame extinction device having constituent elements (i) through (iii) below:
(i) a connective piping section that allows a raw gas to flow from the first pipe to the second pipe and
that simultaneously has a branch to a third pipe; (ii) a flame propagation suppression section that is provided between the connective piping section and the first pipe and/or the second pipe and that has a housing, as well as a bent portion, a narrowed portion, and a porous portion in a flow path in the housing; and
(iii) a pressure reduction section that is disposed at an angle at which the pressure reduction section intersects with an extension line from the first pipe in a flowing direction of the raw gas and that is disposed via the third pipe.

<7> The hydrogen-oxygen production device described in any one of <1> through <5>, further including a flame extinction device, the flame extinction device being disposed between (I) a first pipe to which a raw gas is supplied from one end side and (II) a second pipe, the flame extinction device having constituent elements (1) through (4) below:
(1) a connective piping section that allows a raw gas to flow from the first pipe to the second pipe and that simultaneously has a branch to a third pipe;
(2) a flame propagation suppression section that is provided between the connective piping section and the first pipe and/or the second pipe and that has a housing, as well as a bent portion and a narrowed portion in a flow path in the housing;
(3) a pressure reduction section that is disposed via the third pipe; and
(4) a shock absorption section that surrounds and/or makes contact with the pressure reduction section.

<8> A hydrogen-oxygen production method using the hydrogen-oxygen production device described in any one of <1> through <7>.

<9> A method for operating a hydrogen-oxygen production device described in <5>, the method including: a hydrogen-oxygen production step of stopping the regenerative gas supply means, processing the gas supplied from the water decomposition section, and obtaining hydrogen and oxygen from the membrane separation section; and a hygroscopic material regeneration step of stopping supply of the gas from the water decomposition section, activating the regenerative gas supply means, and removing moisture adsorbed by the hygroscopic material.

<10> The method described in <9>, in which: the hydrogen-oxygen production step is carried out during the daytime, and the hygroscopic material regeneration step is carried out during the nighttime.

### Advantageous Effects of Invention

### [Effect of First Gist of Present Invention]

According to the flame extinction device in accordance with the present invention, even if deflagration or detonation due to ignition or the like occurs on any of the first pipe side and the second pipe side, suppression of shock wave propagation and suppression of flame propagation to a piping section on a different side from the pipe where ignition has occurred are achieved by the structure of the flame propagation suppression section, the configuration in which the first pipe and the second pipe are not arranged in a straight line, and the combination with the pressure reduction section.

In an aspect of the present invention, in a case where a gas which passes through on a pipe side (tentatively referred to as a first pipe side for description) is ignited where the flame propagation suppression section is not provided, and deflagration or detonation occurs, propagation of flame is suppressed in the flame propagation suppression section on the second pipe side because of the following configuration. That is, the connective piping section is first divided into a second pipe direction and a third pipe direction. The second pipe direction has an angle that is not 0° with respect to a first pipe direction, and consequently the second pipe and the first pipe have a nonlinear arrangement. Meanwhile, the pressure reduction section that is on an extension line of the first pipe releases the pressure, or a gas pressure inside the connective piping section is effectively reduced by an effect of phase interference or the like achieved by generation of a reflected wave.

In contrast, in a case where a gas which passes on a pipe side (tentatively referred to as a second pipe side for description) is ignited where the flame propagation suppression section is provided, and deflagration or detonation occurs, flame propagation due to deflagration or detonation is suppressed first in the flame propagation suppression section. However, complete flame extinction and pressure reduction are not necessarily achieved. However, the force is further attenuated at the branch, and the pressure reduction section functions at the tip of the third pipe. Thus, complete flame extinction and pressure reduction are achieved.

### [Effect of Second Gist of Present Invention]

According to the flame extinction device in accordance with the present invention, “the flame propagation suppression section that has a proper configuration is connected, via the connective piping section, to the pressure reduction section that has a proper configuration, and the shock absorption section is provided which surrounds and/or makes contact with the pressure reduction section”. Therefore, even if deflagration or detonation due to ignition or the like occurs on any of the first pipe side and the second pipe side, the above configurations make it possible to suppress shock wave propagation and suppress flame propagation to a piping section on a different side from the pipe where ignition has occurred, and a combustible gas and the like released from the pressure reduction section do not diffuse outside the system because such a combustible gas and the like are accommodated in the shock absorption section.

### [Effect of Third Gist of Present Invention]

According to the photochemical reactor in accordance with the present invention, a liquid is caused to present in a space between the outer cylinder and the inner cylinder, and photocatalytic reaction is carried out by externally irradiating the outer cylinder with light. According to the present invention, the following excellent effects are brought about.

(1) The photocatalyst has a long lifetime. That is, water dissolves many substances and therefore, in a case where a large tube is used, the promoter is likely to leak and be lost anyhow. Even if elution occurs, the promoter of the photocatalyst has the property of reprecipitation with light irradiation. In a practical environment, however, irradiation with sunlight occurs during the daytime and irradiation with light does not occur during the nighttime, and these states are repeated alternately. Therefore, elution of the promoter is inevitable. In the present invention, by reducing an amount of water by employing the double tube, an amount of the promoter that leaks out is reduced. Moreover, water flows in a region near the catalyst, and therefore reprecipitation easily occurs. As a result, the phototranstormation efficiency of the photocatalyst can be maintained at a high level, and a long lifetime can be achieved.

(2) Because the double tube is employed, an amount of gas retained is not large. In a case of a single tube, reaction continues as long as being irradiated with light and water is present, even if a problem occurs. Therefore, a large amount of gas is retained. The double tube is safer because, in the first place, a volume in which a gas can be retained is small.

(3) An amount of water can be reduced, and it is therefore possible to reduce a weight.

(4) By further combining with a specific flame extinction device, a higher safety degree can be ensured.

### [Effect of Fourth Gist of Present Invention]

According to the hydrogen-oxygen production method and device in accordance with the present invention, condensate water in the raw gas is removed by the condensate water removal means, and water vapor in the raw gas is removed by the dehumidification means. Therefore, a decrease in separation performance due to attachment of water to the hydrogen or oxygen separator membrane is suppressed, and it is possible to efficiently produce hydrogen and oxygen.

### BRIEF DESCRIPTION OF DRAWINGS

FIG. 1 is a diagram schematically illustrating a configuration of an example of a hydrogen production device in accordance with an embodiment of a first gist of the present invention.

FIG. 2 is a diagram schematically illustrating a configuration of a first example of a flame extinction device in accordance with an embodiment of the first gist of the present invention.

FIG. 3 is a diagram schematically illustrating a configuration of a second example of a flame extinction device in accordance with an embodiment of the first gist of the present invention.

FIG. 4 is a diagram schematically illustrating a configuration of a third example of a flame extinction device in accordance with an embodiment of the first gist of the present invention.

FIG. 5 is a diagram schematically illustrating a configuration of a fourth example of a flame extinction device in accordance with an embodiment of the first gist of the present invention.

FIG. 6 is a diagram schematically illustrating a configuration of a fifth example of a flame extinction device in accordance with an embodiment of the first gist of the present invention.

FIG. 7 is a diagram schematically illustrating a configuration of a sixth example of a flame extinction device in accordance with an embodiment of the first gist of the present invention.

FIG. 8 is a diagram schematically illustrating a configuration of a seventh example of a flame extinction device in accordance with an embodiment of the first gist of the present invention.

FIG. 9 is a diagram schematically illustrating a configuration of an eighth example of a flame extinction device in accordance with an embodiment of the first gist of the present invention.

FIG. 10 is a diagram schematically illustrating a configuration of a first example of a flame propagation suppression section in accordance with an embodiment of the first gist of the present invention.

FIG. 11 is a diagram schematically illustrating a configuration of a second example of a flame propagation suppression section in accordance with an embodiment of the first gist of the present invention.

FIG. 12 is a diagram schematically illustrating a configuration of a third example of a flame propagation suppression section in accordance with an embodiment of the first gist of the present invention.

FIG. 13 is a diagram schematically illustrating a configuration of a fourth example of a flame propagation suppression section in accordance with an embodiment of the first gist of the present invention.

FIG. 14 is a diagram schematically illustrating a configuration of a fifth example of a flame propagation suppression section in accordance with an embodiment of the first gist of the present invention.

FIG. 15 is a diagram schematically illustrating a configuration of a sixth example of a flame propagation suppression section in accordance with an embodiment of the first gist of the present invention.

FIG. 16 is a diagram schematically illustrating a configuration of a seventh example of a flame propagation suppression section in accordance with an embodiment of the first gist of the present invention.

FIG. 17 is a diagram schematically illustrating a configuration of an eighth example of a flame propagation suppression section in accordance with an embodiment of the first gist of the present invention.

FIG. 18 is a diagram schematically illustrating a configuration of a ninth example of a flame propagation suppression section in accordance with an embodiment of the first gist of the present invention.

FIG. 19 is a diagram schematically illustrating a configuration of a tenth example of a flame propagation suppression section in accordance with an embodiment of the first gist of the present invention.

FIG. 20 is a cross-sectional view schematically illustrating a configuration of a first example of a pressure reduction section in accordance with an embodiment of the first gist of the present invention.

FIG. 21 is a cross-sectional view schematically illustrating a configuration of a second example of a pressure reduction section in accordance with an embodiment of the first gist of the present invention.

FIG. 22 is a right side view schematically illustrating a side of the pressure reduction section illustrated in FIG. 21.

FIG. 23 is a cross-sectional view schematically illustrating a configuration of a third example of a pressure reduction section in accordance with an embodiment of the first gist of the present invention.

FIG. 24 is a cross-sectional view schematically illustrating a configuration of an example of a shock absorption section in accordance with an embodiment of the first gist of the present invention.

FIG. 25 is a right side view schematically illustrating a side of the shock absorption section illustrated in FIG. 24.

FIG. 26 is a diagram schematically illustrating an experimental device used in Example 1-11.

FIG. 27 is a diagram schematically illustrating a configuration of a first example of a flame extinction device in accordance with an embodiment of a second gist of the present invention.

FIG. 28 is a diagram schematically illustrating a configuration of a second example of a flame extinction device in accordance with an embodiment of the second gist of the present invention.

FIG. 29 is a diagram schematically illustrating a configuration of a third example of a flame extinction device in accordance with an embodiment of the second gist of the present invention.

FIG. 30 is a diagram schematically illustrating a configuration of a fourth example of a flame extinction device in accordance with an embodiment of the second gist of the present invention.

FIG. 31 is a diagram schematically illustrating a configuration of a fifth example of a flame extinction device in accordance with an embodiment of the second gist of the present invention.

FIG. 32 is a diagram schematically illustrating a configuration of a sixth example of a flame extinction device in accordance with an embodiment of the second gist of the present invention.

FIG. 33 is a diagram schematically illustrating a configuration of a seventh example of a flame extinction device in accordance with an embodiment of the second gist of the present invention.

FIG. 34 is a diagram schematically illustrating a configuration of an eighth example of a flame extinction device in accordance with an embodiment of the second gist of the present invention.

FIG. 35 is a configuration diagram illustrating a flame extinction device prepared in Example in accordance with an embodiment of the second gist of the present invention.

FIG. 36 is a front view schematically illustrating a configuration of an example of a photochemical reaction device in accordance with an embodiment of a third gist of the present invention.

FIG. 37 is a side view schematically illustrating a configuration of an example of the photochemical reaction device in accordance with an embodiment of the third gist of the present invention.

FIG. 38 is a perspective view schematically illustrating an example of a manifold and a tube assembly of a photochemical reactor in accordance with an embodiment of the third gist of the present invention.

FIG. 39 is an enlarged cross-sectional view taken along the line II-II in FIG. 38.

FIG. 40 is a schematic cross-sectional view taken along the like III-III in FIG. 38.

FIG. 41 is a graph illustrating a result of Example 3-1.

FIG. 42 is a schematic cross-sectional view illustrating a device of Comparative Example 3-1.

FIG. 43 is a graph illustrating a result of Comparative Example 3-1.

FIG. 44 is a configuration diagram illustrating a hydrogen-oxygen production device in accordance with an embodiment of a fourth gist of the present invention.

FIG. 45 is a configuration diagram illustrating a membrane gas dryer.

FIG. 46 is a configuration diagram illustrating a hydrogen-oxygen production device in accordance with an embodiment of the fourth gist of the present invention.

FIG. 47 is a configuration diagram illustrating a hydrogen-oxygen production device in accordance with an embodiment of the fourth gist of the present invention.

FIG. 48 is a configuration diagram illustrating a hydrogen-oxygen production device in accordance with an embodiment of the fourth gist of the present invention.

FIG. 49 is a configuration diagram illustrating a hydrogen-oxygen production device in accordance with an embodiment of the fourth gist of the present invention.

### DESCRIPTION OF EMBODIMENTS

### [Embodiment of First Gist of Present Invention]

### Definition

In regard to the first gist of the present invention, the following expressions may be used in this specification.

Expressions such as “passage of a gas” and “a gas passes through” may be used. Such a case means that a gas including any of or all of a combustible gas, a combustion-supporting gas, an inert gas, and the like passes through the system described later. The gas may be a single gas or a mixed gas. In some cases, a liquid (such as nebulized water or water droplets) may be entrained. In addition, in a case where deflagration, detonation, or the like occurs, the gas which passes through may not necessarily be a gas having an initial composition but may be a gas which has undergone chemical combination, decomposition, or the like as a result of chemical reaction. In some cases, the term “gas” is used as a collective term including such gases.

An expression “in a normal state” may be used. This expression refers to a state in which, in any mechanical equipment, chemical equipment, and the like which involve concern about occurrence of explosion and detonation, gas generation, passage, temporary retention, and storage safe and stable, while avoiding occurrence of such an event. The expression “in a normal state” may be used regardless of whether it is in a stopped state or in an operating state.

Expressions “detonation” and “occurrence of detonation” mean a part of or all of a series of reactions in which a gas that may cause deflagration or detonation in ignition is actually ignited, deflagration occurs, and after that, in some cases, the deflagration transitions to detonation, a shock wave is generated, and detonation flame also propagates. The expressions are used in any of those meanings.

An expression “hydrogen detonating gas” indicates a hydrogen-oxygen: gas having any composition in this specification unless otherwise described. In a case where water vapor and the like are included, the expression “hydrogen detonating gas” is also used.

Expressions “in the system” and “outside the system” may be used. The expression “in the system” in this case is a part where, in mechanical equipment and chemical equipment, a combustible gas, as well as a mixed gas containing a combustible gas and a combustion-supporting gas, are generated, pass through, are temporarily retained, are stored, and are consumed. The expression “in the system” includes a part where, in equipment provided with the flame extinction device of the present invention, a combustible gas, as well as a mixed gas containing a combustible gas and a combustion-supporting gas, are generated, pass through, are temporarily retained, are stored, and are consumed. The expression “outside the system” refers to the other parts.

### [Overview]

The flame extinction device in accordance with the present invention can be used in any mechanical equipment, chemical equipment, and the like which involve concern about occurrence of explosion and detonation. The flame extinction device in accordance with the present invention is applicable to any combustible gases and a mixed gas containing a combustible gas and a combustion-supporting gas. The flame extinction device in accordance with the present invention can be suitably used in chemical equipment in which a hydrogen detonating gas in which hydrogen and oxygen coexist, which have particularly large explosion power, is generated, passes through, is temporarily retained, and is stored. The flame extinction device in accordance with the present invention can be suitably used further for “equipment in which hydrogen and oxygen are generated by electrolysis and pass therethrough”, “equipment in which hydrogen and oxygen are generated using a photocatalyst and pass therethrough”, or the like for generating hydrogen and oxygen by decomposing water. In such a case, the hydrogen-oxygen mixed gas which is generated and passes through may have a stoichiometric composition (hydrogen:oxygen=2:1). Here, there is concern that equipment is broken or alternatively secondary damage is enormously caused due to deflagration caused by ignition of the mixed gas or a shock wave or detonation flame that is generated in a case where the deflagration has subsequently transitioned to detonation. According to the studies by the inventors of the present invention, however, the flame extinction device (also referred to as “flame extinction mechanism”) in accordance with the present invention can effectively suppress influence of a shock wave or detonation flame, even in a case where a pressurized hydrogen-oxygen mixed gas having a stoichiometric composition is ignited. In view of this, in a case where hydrogen and oxygen are generated by water decomposition with a photocatalyst, it is possible to appropriately dispose the present flame extinction mechanism at various locations, such as around a photocatalytic reactor and around a hydrogen-oxygen separator membrane which is disposed downstream of the photocatalytic reactor.

The flame extinction device in accordance with an embodiment of the present invention includes, as constituent elements thereof, the following three requirements:
(1) a connective piping section that allows a raw gas to flow from a first pipe to a second pipe and that simultaneously has a branch to a third pipe;
(2) a flame propagation suppression section that is provided between the connective piping section and the first pipe and/or the second pipe and that has a housing, as well as a bent portion, a narrowed portion, and a porous portion in a flow path in the housing; and
(3) a pressure reduction section that is disposed at an end part of the third pipe which is not orthogonal to an extension line of the first pipe in a flowing direction of the raw gas in the first pipe.

In a case where the elements are included, for example, it is possible to effectively mitigate influence of a shock wave and suppress flame propagation even in a case where reaction is generated (e.g., a pressurized mixed gas having a stoichiometric composition of hydrogen and oxygen detonates) which is extremely intense than in a conventionally assumed case.

### [Basic Configuration and Effect]

First, the following description will discuss a basic configuration of the present invention.

An embodiment of the present invention is a flame extinction device that is disposed between (i) a first pipe to which a raw gas is supplied from one end side and (ii) a second pipe which is disposed at an angle with the first pipe, the flame extinction device having constituent elements (1) through (3) below:
(1) a connective piping section that allows a raw gas to flow from the first pipe to the second pipe and that simultaneously has a branch to a third pipe;
(2) a flame propagation suppression section that is provided between the connective piping section and the first pipe and/or the second pipe and that has a housing, as well as a bent portion, a narrowed portion, and a porous portion in a flow path in the housing; and
(3) a pressure reduction section that is disposed at an end part of the third pipe which is not orthogonal to an extension line of the first pipe in a flowing direction of the raw gas in the first pipe.

Here, with respect to a flow direction of the gas in a normal state, a downstream direction thereof is defined. In this case, in a case where ignition occurs in the first pipe, a shock wave propagation mitigation effect and a flame propagation suppressive effect with respect to the second pipe are expected by the flame extinction mechanism of the present invention.

The flame extinction mechanism of the present invention may be configured to bring about, in addition to the above effects, a shock wave mitigation effect and a flame propagation suppressive effect with respect to the piping section or further to the first pipe, even in a case where ignition occurs in the second pipe.

### [Photochemical Reaction Plant]

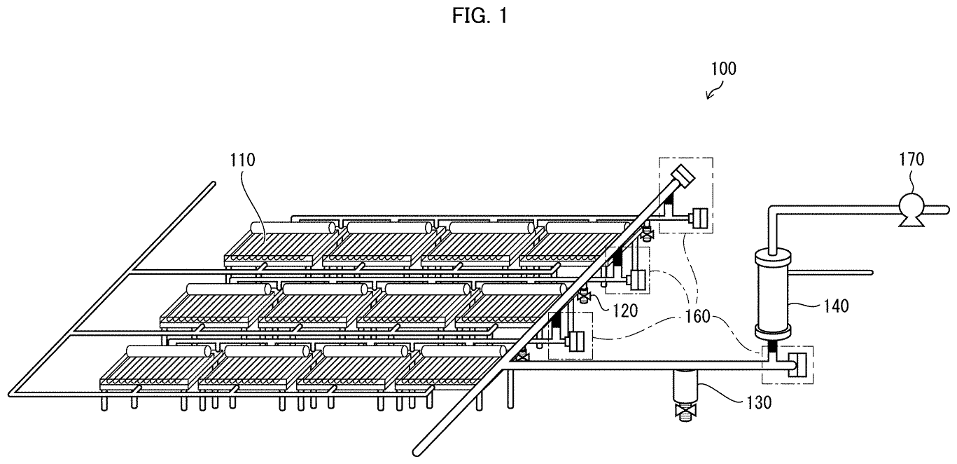

The following description will discuss an embodiment with reference to FIG. 1. FIG. 1 is a diagram schematically illustrating a configuration of a photochemical reaction plant 100 in accordance with the present embodiment.

As illustrated in FIG. 1, the photochemical reaction plant 100 includes a photochemical reaction device 110, a condensate water removal device 120, a humidity reduction device 130, a separator membrane device 140, a flame extinction device 160, and a vacuum pump 170.

The photochemical reaction device 110 includes a photochemical reactor. The photochemical reactor is a reactor that carries out photochemical reaction. Photochemical reaction is, for example, reaction that generates a high-energy substance in the presence of light from a liquid. Examples of the photochemical reaction include reaction that generates a hydrogen gas and an oxygen gas from water in the presence of a photocatalyst. The following description will discuss the present invention in more detail based on an example of generating a hydrogen gas and an oxygen gas from water.

The condensate water removal device 120 is a device that removes condensate water in the gas supplied from the photochemical reaction device 110. The condensate water removal device 120 only needs to be appropriately disposed in a gas passage from the photochemical reaction device 110. The condensate water removal device 120 may be disposed for each photochemical reaction device 110, may be disposed at a confluence position of the gas passage, or may be disposed upstream of the separator membrane device 140. Examples of the condensate water removal device 120 include a drain trap and a gas trap. Examples of the condensate water removal device 120 may include a chiller that condenses water vapor in the raw gas by cooling. The condensate water removal device 120 obtains condensate water by condensing water vapor contained in the gas generated by the photochemical reaction device 110. The condensate water removal device 120 may further include a siphon or the like that automatically drains the retained condensate water.

The humidity reduction device 130 is a device that reduces humidity of the gas. The humidity reduction device 130 is usually disposed downstream of the condensate water removal device 120 and is used to reduce humidity of the gas from which condensate water has been removed. Examples of the humidity reduction device 130 include a moisture adsorption tower that has a hygroscopic material such as silica gel, a membrane gas dryer, and a water vapor selective permeation tube described in Japanese Patent Application Publication Tokukai No. 2017-213477. Examples of the humidity reduction device 130 may also include a heater or the like (e.g., a heat exchanger) that raises a temperature of the gas to relatively reduce humidity. The humidity reduction device 130 reduces moisture from a gas which has been subjected to a condensate water removal process in the condensate water removal device 120, and thus reduces humidity of the gas.

The separator membrane device 140 is a device that separates hydrogen and oxygen from a gas generated by the photochemical reaction device 110. As such, the separator membrane device 140 only needs to be a device that can separate a specific component from the gas. The separator membrane device 140 may normally be disposed at a most downstream position of a flow path of the gas in the photochemical reaction plant 100. Alternatively, the separator membrane device 140 may be disposed at a more upstream position. It is possible to provide a plurality of separator membrane devices 140. Examples of the separator membrane device 140 include a known device having a hollow fiber membrane or a zeolite membrane as a separator membrane. The separator membrane device 140 separates, by membrane, hydrogen and/or oxygen from a gas supplied from the humidity reduction device 130.

The flame extinction device 160 is a device that reduces flame propagation that occurs in a case where explosion detonation has occurred. Flame extinction devices 160 are appropriately disposed at a plurality of locations in the flow path of the gas, for example, so that influence exerted by flame propagation is retained in a more limited region in the photochemical reaction plant 100. Specific descriptions of the flame extinction device 160 will be described later.

The vacuum pump 170 is a device for generating, in the separator membrane device 140, a pressure difference at which a specific gas passes through the separator membrane.

### [Basic Configuration of Present Invention]

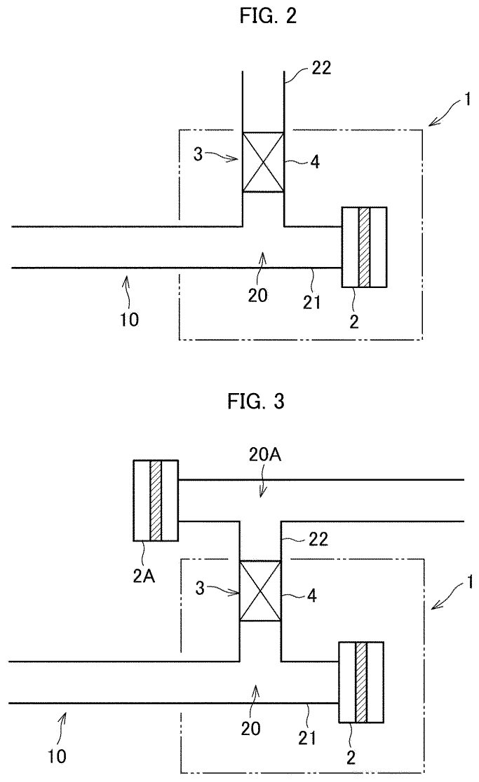

First, the following description will discuss in detail an aspect illustrated in FIG. 2, in regard to a basic configuration of the present flame extinction device and behaviors thereof. FIG. 2 illustrates an example of a basic configuration of the present flame extinction device. A flame extinction device 1 is provided between a first pipe 10 and a second pipe 22 to which a raw gas is supplied. The first pipe and the second pipe are not linearly connected to each other but are disposed so as to form a certain angle which is not 0°. Alternatively, an extension line of the first pipe and an extension line of the second pipe are not linearly connected to each other but intersect with each other so as to form a certain angle which is not 0°. The flame extinction device 1 includes therein a connective piping section 20 that allows a raw gas to flow from the first pipe to the second pipe and that simultaneously has a branch to a third pipe 21. The first pipe and the second pipe may be an integrated body including a pipe connection section therebetween. Alternatively, the first pipe, the second pipe, and the pipe connection section may be separate members which are connectable to each other.

Moreover, a pressure reduction section 2 is included which is disposed at an end part of the third pipe 21 which is not orthogonal to an extension line of the first pipe in a flowing direction of the raw gas in the first pipe. A flame propagation suppression section 3 is provided at a side where the second pipe is connected. The flame propagation suppression section includes a housing 4, as well as a narrowed portion, a bent portion, and a porous portion in a flow path in the housing. As such, the flame extinction device 1 includes: the connective piping section 20 which is connected to the first pipe 10, the second pipe 22, and the third pipe 21, a raw gas being supplied to the first pipe 10 and the second pipe 22; the flame propagation suppression section 3 that has a porous portion through which the raw gas passes, the flame propagation suppression section 3 being provided on the second pipe 22 side when seen from the connective piping section 20; and the pressure reduction section 2 that is disposed at an end part of the third pipe 21, the pressure reduction section 2 reducing an internal pressure of the third pipe 21 in a case where the internal pressure has risen. The third pipe 21 is not orthogonal to the first pipe 10.

In a case of ignition on the first pipe side in the device, a shock wave propagation mitigation effect and a flame propagation suppressive effect on the second pipe side or the further downstream side thereof are expected. Here, it is assumed that the present flame extinction device is provided in a so-called “artificial photosynthesis plant”, which is equipment in which hydrogen and oxygen are generated using a photocatalyst and pass therethrough. The following description will discuss an example in which a raw gas, i.e., a hydrogen-oxygen mixed gas flowed from the photocatalyst is ignited at the first pipe side.

From the first pipe side, a shock wave and flame after transition to detonation propagate, depending on a distance from the ignition point or a pipe diameter.

After that, the shock wave and detonation flame which have reached the present flame extinction device propagate in any direction. However, the shock wave and detonation flame have the characteristic of being comparatively easy to propagate straight. Therefore, the shock wave and detonation flame easily reach the pressure reduction section disposed at an end part of the third pipe which is not orthogonal to an extension line of the first pipe in a flowing direction of the raw gas in the first pipe. In order to suppress such propagation of a shock wave and detonation flame, the inventors of the present invention have found, from experimental and theoretical studies, that reducing pressure thereof is an important requirement. In view of this, the pressure is effectively reduced by the pressure reduction section with various methods described later.

Meanwhile, it has also been found experimentally that the above feature is not sufficient to suppress a shock wave and detonation flame which can be generated by detonation of a hydrogen detonating gas (hydrogen-oxygen mixed gas) and can propagate in any direction. In particular, for suppression of flame propagation, an appropriate flame propagation suppression section is essential. The flame propagation suppression section is joined to the pressure reduction section via the connective piping section that has one or more branches.

Here, unlike the pressure reduction section that is disposed on the extension line extending straight from the first pipe, the flame propagation suppression section is, for example, disposed to cause the gas to flow in a direction orthogonal to (i.e., crossing at 90 degrees) the extension line. That is, the flame propagation suppression section is disposed in a direction different from that (i.e., the straight direction) in which a shock wave or detonation flame is comparatively prone to propagation. With this arrangement, it is possible to effectively exert a flame propagation suppressive effect by the flame propagation suppression section while reducing detonation pressure, and thus prevent propagation of a shock wave and flame to the second pipe due to detonation.

According to the experiments by the inventors of the present invention, the flame propagation suppression section preferably includes a housing in which an internal structure can be provided, and preferably includes, at least, the following configurations. That is, in a case where the housing is provided, it is preferable to included, as a constituent unit: a narrowed portion that causes the gas to pass therethrough and that is narrowed compared with peripheral pipes and the like; a porous portion containing a porous body such as a metal sintered body or a ceramic sintered body; and a bent portion that changes the direction of flame. As for flame propagation suppression, it is important to provide a configuration that can easily decrease a temperature thereof essentially by: complicatedly bending the flow path therein; narrowing the flow path in accordance with a flame propagation distance; including a multiple mechanism which prevents flame from propagating straight; and at the same time, ensuring heat radiation from the housing. Therefore, the flame propagation suppression section preferably includes the above narrowed portion, and further preferably includes also the bent portion.

In a case where the flow path in the flame propagation suppression section is excessively narrowed in order to improve a flame extinction effect in occurrence of detonation, a pressure loss excessively increases in passage of the gas in a normal state. Therefore, there are proper ranges in various conditions. Details of configurations will further be described later. The flame propagation suppression section, the connective piping section, and the pressure reduction section combination, effectively suppress propagation of a shock wave and detonation flame.

In the present invention, it is possible to use a combination including, as a base, the basic configuration described above. The following description will discuss such a combination.

FIG. 3 is an example thereof in which two pressure reduction sections (2 and 2A) are disposed with respect to one flame propagation suppression section in order to extend the effect that can be achieved by the configuration of FIG. 2. In the example illustrated in FIG. 3, in both cases where ignition occurs on the first pipe side and ignition occurs on the second pipe side, a shock wave propagation mitigation effect and a flame propagation suppressive effect to the opposite side are expected. Functions of the constituent elements are as described in the basic configuration illustrated in FIG. 2. In FIG. 3, a configuration in the lower part is illustrated as the basic flame extinction device in accordance with the present invention. Note, however, that it is possible to regard a configuration (including the connective piping section 20A, the flame propagation suppression section 3, and the pressure reduction section 2A) in the upper part of FIG. 3 as the basic flame extinction device.

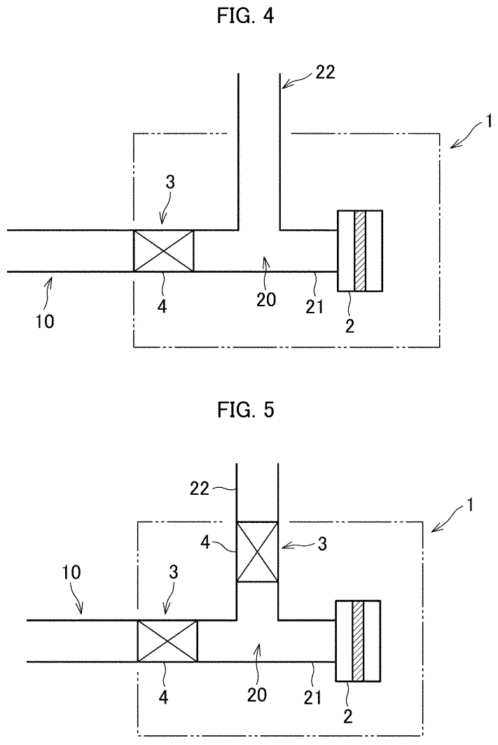

FIG. 4 illustrates a case where the flame propagation suppression section is provided on the first pipe side. That is, in the example of FIG. 4, the flame propagation suppression section 3 is provided on the first pipe side when seen from the connective piping section. In the example of FIG. 4, in a case where ignition occurs on the first pipe side similarly to the above case, a shock wave and detonation flame reach first the flame propagation suppression section. As described above, the flame propagation suppression section includes, at least, the following configurations. That is, the flame propagation suppression section includes, as a constituent unit: a housing in which an internal structure can be provided; a narrowed flow path that causes the gas to pass therethrough in the housing and that is narrowed compared with peripheral pipes and the like; and a porous portion containing a porous body such as a metal sintered body. In flame whose force has been reduced by passing through the flame propagation suppression section, the pressure decreases if released from the pressure reduction section. If the force of flame is not enough to be released, the flame does not proceed to the second pipe side because the flame overlaps with a reflected wave or the like from the pressure reduction section. Thus, the flame is suppressed.

FIG. 5 is an example in which two flame propagation suppression sections are disposed in FIG. 2 and FIG. 4. That is, in the example of FIG. 5, flame propagation suppression sections 3 and 3 are provided respectively on the first pipe side and the second pipe side when seen from the connective piping section. In the example illustrated in FIG. 5, in both cases where ignition occurs on the first pipe side and ignition occurs on the second pipe side, a shock wave propagation suppressive effect and a flame propagation suppressive effect to the opposite side are expected. Functions of the constituent elements are as described above.

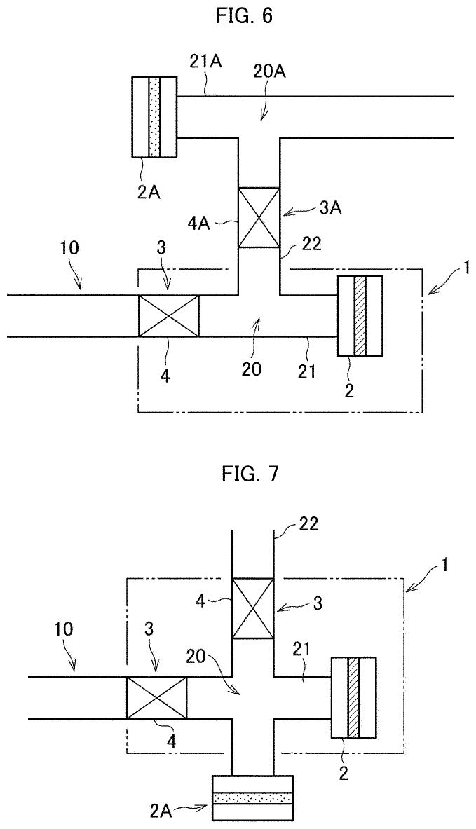

FIG. 6 and FIG. 7 illustrate an enhanced configuration of the flame extinction device in accordance with the present invention, with which it is possible to obtain a stronger flame extinction performance. In FIG. 6, a configuration which is similar to that of FIG. 4 and which is disposed in the lower part of FIG. 6 is illustrated as the flame extinction device in accordance with the present invention. Note, however, that a configuration which is similar to that of FIG. 2 and which is disposed in the upper part of FIG. 6 can be regarded as the flame extinction device in accordance with the present invention. In FIG. 7, it is possible to assume that, in a flame extinction device having a configuration similar to FIG. 5, a fourth branch pipe is additionally provided to the connective piping section, and a pressure reduction section 2A is additionally disposed at the tip thereof.

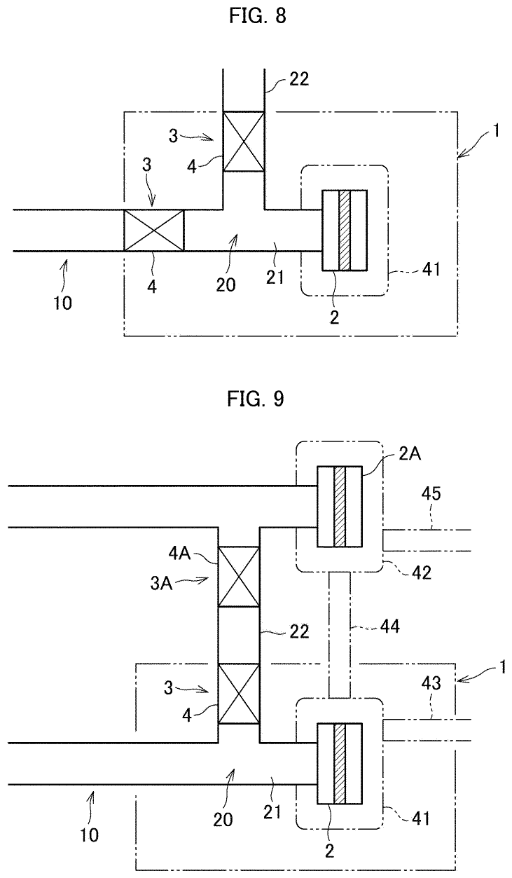

In the present invention, it is possible to employ a configuration in which a shock absorption section is provided which can accommodate a substance leaking from the pressure reduction section. With the configuration, it is possible to prevent scattering, to the surroundings, a gas which has a comparatively high temperature and a comparatively high pressure and has been released from the pressure reduction section, as well as a reaction product, particles, and the like included in the gas. Examples of such a configuration are illustrated in FIGS. 8 and 9. In FIG. 8, a shock absorption section 41 is provided to the pressure reduction section 2 in the embodiment of FIG. 5. That is, the flame extinction device 1 of FIG. 8 includes the shock absorption section 41 that surrounds the pressure reduction section 2.

In FIG. 9, the embodiment of FIG. 2 is combined in duplicate, and shock absorption sections 41 and 42 are provided for the pressure reduction sections 2 and 2A, respectively. Dilution gas passage pipes 43 and 45 are connected to the shock absorption sections 41 and 42, respectively. Moreover, a dilution gas passage pipe 44 is provided so that the shock absorption sections 41 and 42 communicate with each other via the dilution gas passage pipe 44. In FIG. 9, a configuration which is disposed in the lower part of FIG. 9 is illustrated as the basic flame extinction device in accordance with the present invention. Note, however, that a configuration which is disposed in the upper part of FIG. 9 can be regarded as the basic flame extinction device in accordance with the present invention.

As the dilution gas, it is possible to use nitrogen, a rare gas, air, carbon dioxide, or a mixed gas thereof. The dilution gas passes through in an order of the pipes 43, 44, and 45 or in a reverse direction thereof.

In a practical plant such as artificial photosynthesis, it is realistically difficult to immediately stop generation of a hydrogen-oxygen mixed gas even if any problem occurs. Therefore, even if stopping operation is carried out with some sort of method, a hydrogen-oxygen mixed gas is released for a while. Therefore, it is important to provide a shock absorption section and, more preferably, to cause an inert gas, which does not ignite, to flow here.

Alternatively, it is possible to improve flame extinction performance by causing carbon dioxide to pass through. As a further effect, it is possible to expect an effect of preventing spread, to the surroundings, of impact and sound caused when the pressure reduction section is opened.

### <Connective Piping Section>

The connective piping section in accordance with the present invention is a portion that allows a raw gas to flow from the first pipe to the second pipe and that simultaneously has a branch to the third pipe. That is, the connective piping section is a portion that is connected to the first pipe and the second pipe to which a raw gas is supplied and that is connected also to the third pipe. Here, in a case where the first pipe is extended in the gas flow direction in a normal state and the second pipe is extended in a direction opposite to the gas flow direction in a normal state, a smaller value of angles formed by these two straight lines (i.e., the flow of gas from the first pipe and the flow of gas to the second pipe) is important. The angle is preferably 30 degrees or more, preferably 60 degrees or more, particularly preferably 75 degrees or more, most preferably 90 degrees (i.e., orthogonal). If the angle is 90 degrees or more, the angle is shallow when seen from flame in the opposite direction. Therefore, the angle is most preferably 90 degrees.

What is necessary for bringing about the effect of the present invention is to hinder, at the connective piping section, propagation of detonation flame that is comparatively rich in property to propagate straight. Thus, in the connective piping section in the flame extinction device, the second pipe and the first pipe are disposed in parallel if the pipes are bent twice in opposite directions at the same angles, or the like. It is clear that such a connective piping section in which the pipes are bent multiple times can also be used as the connective piping section. In this case, a sum of absolute values of the angles at the bent parts is preferably 60 degrees or more, particularly preferably 75 degrees or more, more preferably 90 degrees or more.

A pipe cross section of the connective piping section is preferably a structure without a corner, preferably a substantially oval shape or a substantially circular shape, more preferably a substantially circular shape, and most preferably a circular shape. Such a structure is preferable from the viewpoint of enhancing pressure resistance.

The present flame extinction device can suppress flame propagation or the like due to explosion, detonation, or the like, and brings about an effect of suppressing breakage of devices and preventing secondary damage. In order to suppress propagation of a shock wave and detonation flame due to a pressurized hydrogen detonating gas, the entire flame extinction device needs to have high explosion resistance. In general, a pipe having a cylindrical cross-sectional shape, a gas storage tank having a spherical shape, and the like can achieve higher pressure resistance and explosion resistance than a pipe having a rectangular cross-sectional shape, a rectangular parallelepiped tank, and the like, even with the same pipe thickness and the same tank thickness. Therefore, a cross section of the pipe constituting the present flame extinction device is preferably substantially oval or substantially circular, more preferably substantially circular, and most preferably circular.

From a similar viewpoint, cross sections of the flame propagation suppression section and the pressure reduction section are preferably substantially oval or substantially circular, more preferably substantially circular, and most preferably circular.

Here, the term “substantially circular” means a shape that is circular if having none of an error in production, a micro-deformation in on-site installation, a micro-deformation due to welding in repair, and the like.

In order to endure an intense shock wave and pressure change in occurrence of detonation, a pressure resistance P(tube) (MPa(G)) of the pipe is preferably 2 MPa(G) or more, more preferably 4 MPa(G) or more, further preferably 8 MPa(G) or more, most preferably 16 MPa(G) or more.

Note, however, that, if the pressure resistance and explosion resistance are excessively enhanced, the thickness the pipe excessively increases. This causes problems that a weight of the pipe is excessively large and the cost is excessively high. Therefore, an upper limit thereof is preferably 30 MPa(G) or less, more preferably 27.5 MPa(G) or less, further preferably 25 MPa(G) or less, most preferably 22.5 MPa(G) or less.

That is, the pressure resistance P(tube) (MPa(G)) of the connective piping section preferably satisfies a formula below:

2≤P(tube)≤30.

Pressure resistance is obtained from a normal pressure resistance test of a pipe in accordance with the quality of material or the like. In the present invention, it is preferable to employ a pipe which can endure not only in normal generation of a raw gas but also in detonation. Meanwhile, a pipe having a strength suitable for normal use tends to generally endure detonation in the present invention. This seems to be because a time period during which detonation occurs is very short, i.e., in milliseconds, and therefore external force which is sufficient to cause breakage due to detonation is unlikely to be applied to a specific part of the pipe.

### <Flame Propagation Suppression Section>

The flame extinction device in accordance with the present invention includes at least one flame propagation suppression section. The flame propagation suppression section may include a housing and a flow path in the housing, and may further include a porous portion through which the raw gas passes, as well as a bent portion and a narrowed portion. That is, the flame propagation suppression section may further include a housing which is provided in the first pipe and/or the second pipe and through which the raw gas passes, and the housing may include therein a bent portion, a narrowed portion, and a porous portion. First, the following description will discuss the entire configuration, and subsequently discuss each of the components.

### (Entire Flame Propagation Suppression Section)

A pressure resistance of the flame propagation suppression section is preferably 0.5 MPa(G) or more, more preferably 1 MPa(G) or more, further preferably 2 MPa(G) or more, most preferably 4 MPa(G) or more. Note, however, that, if the pressure resistance and explosion resistance are excessively enhanced, the thickness of the housing excessively increases. This causes problems that the weight of the housing is excessively large and the cost is excessively high. Therefore, an upper limit thereof is preferably 25 MPa(G) or less, more preferably 20 Pa (G) or less, further preferably 15 MPa(G) or less, most preferably 10 MPa(G) or less.

### (Housing)

A material of the flame propagation suppression section is preferably a material that can achieve both pressure resistance and thermal conductivity, and is preferably a metallic material or a composite material containing a metallic material. More preferably, the housing contains a metallic material, i.e., the housing is made of metal. The material is further preferably an iron-based material or a stainless steel material. It is possible to use different materials in accordance with locations of the housing.

A shape of the housing is preferably a cylindrical shape. With such a shape, it is possible to improve pressure resistance and explosion resistance, as with the other pipes.

### (Bent Portion)

The bent portion in the housing largely changes a propagation direction of flame. The bent portion may be bent in a U-shape or an L-shape, or may have a branch in a T-shape or a cross-shape. Flame has property to propagate straight. Therefore, with the configuration above, it is possible to further improve the flame propagation suppressive function. The bent portion is preferably provided at a plurality of locations in the flow path in the housing. It is possible to provide a bent portion having a pipe shape or an embedded shape in the housing. Alternatively, it is possible to form a bent portion by being filled with appropriate particles, by a porous body, or the like described later. In particular, from the viewpoint of the flow path, the bent portion formed by being filled with particles, by a porous body, or the like randomly repeats bending, curving, branching, and integration. Therefore, such a bent portion is more preferable from the viewpoint of flame propagation suppression.

### (Narrowed Portion)

First, a cross-sectional area of the narrowed portion in the housing of the flame propagation suppression section in accordance with the present invention is preferably smaller, as compared with each of a cross-sectional area of the first pipe, a cross-sectional area of the second pipe, and a cross-sectional area of the connective piping section. This is to effectively suppress flame propagation in the flame propagation suppression section. Therefore, a cross-sectional area of the narrowed flow path (portion) in the housing is preferably 80% or less, more preferably 60% or less, further preferably 40% or less, most preferably 20% or less, with respect to a cross-sectional area of each of the other pipes. If the cross-sectional area of the narrowed portion in the housing is excessively small, a pressure loss in a gas passage in a normal state is excessively large. Therefore, the cross-sectional area is preferably 3% or more, more preferably 5% or more, further preferably 10% or more, most preferably 15% or more. In a case where diameters of the first pipe, the second pipe, and the connective piping section are different from each other, it is possible to use an average thereof as a reference.

A width (also referred to as a “diameter”) of the narrowed portion in the housing is preferably 4.5 mm or less, more preferably 4 mm or less, further preferably 3.5 mm or less, most preferably 3 mm or less. If the width (diameter) is excessively narrowed, such a width may lead to generation of an excessive pressure loss in a normal state. Therefore, the diameter of the narrowed portion is preferably 0.3 mm or more, more preferably 0.4 mm or more, further preferably 0.5 mm or more, most preferably 0.6 mm or more. That is, the diameter of the portion in the housing is selected to bring about a sufficient flame propagation suppressive function while avoiding occurrence of an excessive pressure loss in a normal state in which detonation or the like does not occur. In particular, the diameter of the narrowed portion is preferably selected while taking into consideration a balance with the pressure loss, with reference to a flame propagation limit value of a combustible gas.

The width (diameter) of the narrowed portion in the housing does not need to be uniform in the flow path. In a certain part, a dimension of approximately 0.3 mm can be selected so that sufficient flame propagation suppression can be achieved. Meanwhile, in the other part, the width (diameter) can be expanded to approximately 4.5 mm as selection that emphasizes the effect of reduction of pressure loss. The diameter of the narrowed portion is a distance between flow path wall surfaces in the narrowest part of a space through which the raw gas passes. For example, the narrowed portion may be the space described above that has a longitudinal width or a transverse width of the particular diameter described above and a transverse width or a longitudinal width wider than the particular diameter.

Examples of the narrowed portion may include a funnel-like structure and a conical structure.

### (Regarding Porous Portion)

A shape of the porous portion for flame propagation suppression may be an arbitrary shape in accordance with shapes of the housing, the narrowed flow path in the housing, and the like. For example, in a case where the housing is columnar in shape and the narrowed flow path in the housing on the first pipe side is provided at the upper part in the housing, and a similar narrowed flow path structure on the second pipe side in the housing is provided at the lower part in the housing, a porous body constituting the porous portion may be disposed in the form of column along the housing. The columnar porous portion may be a filled layer which is obtained by filling a circular tube with particles. Examples of the narrowed flow path in the housing as described above include a structure in which bending in a U-shape or an L-shape, a branch in a T-shape or a cross-shape are repeated, and a certain part has a width of 0.3 mm and the other part has a width of 2 mm. In this case, the gas passes from the upper surface to the bottom surface of the columnar porous body when seen from a macroscopic viewpoint. Meanwhile, when seen from a microscopic viewpoint, in the porous body, the gas randomly passes through gap parts which are connected to each other in the porous body.

Another shape of the porous body can more preferably be a substantially columnar shape with a substantially columnar internal space that penetrates from top to bottom in a center in a radial direction of the porous body, that is, a structure in which the porous portion is a substantially cylindrical porous body.

In a case of such a shape, a planar shape of the upper surface and the lower surface is a substantially doughnut-like shape. In such a shape, it is preferable to employ an arrangement with which, in occurrence of detonation, a shock wave or pressure change propagates from the outside of the porous body (in plan view, from the outside of the doughnut shape), and flame also enter in this direction, and then the flame and the like are caused to pass through the substantially columnar internal space of the porous body (in plan view, inside the donut shape). Such a configuration is preferable because the pressure resistance and detonation resistance of the porous body are improved, as compared with those in a case of a flow in a reverse direction (i.e., in plan view, a shock wave or pressure change enters from the inner side of the doughnut shape, and is then caused to pass outward). This is because the porous body is comparatively strong against a compressive impact but is comparatively weak against a tensile impact. In this case, when seen from a macroscopic viewpoint, the gas passes from the outer side of the columnar porous body (in plan view, the outer side of the doughnut shape) to the internal space on the inner side (in plan view, the inner side of the doughnut shape). Meanwhile, when seen from a microscopic viewpoint, in the porous body, the gas randomly passes through gap parts which are connected to each other in the porous body.

As a material of the porous body, it is possible to select any material such as metal, ceramic, or a composite material thereof. Examples of the metal include Fe, Ni, Ti, Cr, Mo, Si, Al, Mg, and the like. Alternatively, the metal may be an alloy containing an element selected from those elements. Examples of the ceramic material include Al₂O₃-based materials, SiO₂-based materials, SiC-based materials, ZrO₂-based materials, and the like. Among those, in view of high thermal conductivity and stability, the porous material is preferably constituted by metal. Furthermore, among those, it is preferable to have a comparatively high melting point, to have stability against contact with detonation flame, and to be capable of maintaining a porous shape thereof, particularly diameter described later. Specifically, the material is preferably SUS304 that is a stainless steel material which is an alloy containing Fe, Ni, Cr, and the like, more preferably a stainless steel material SUS316 containing Mo in addition to Fe, Ni, Cr, and the like, further preferably SUS316L in which an amount of C which is mixed in production is reduced, in addition to containing Mo as well as Fe, Ni, Cr, and the like. This is because of the improved water resistance and corrosion resistance.

In the porous body that is capable of allowing a gas which passes through the narrowed flow path in the housing to pass therethrough and that has gaps, “pores” which are intentionally formed are obtained with an arbitrary method. Note, however, that it is preferable to employ random pores (also referred to as “gaps”), rather than a “linear hole” which can be formed by laser processing or the like. Here, the random pores have various sizes and are formed as unsintered parts in sintering which may be formed by a high-temperature pressurization process with respect to powder of ceramic, metal, or the like. With such a configuration, the flame propagation suppressive effect can be improved.

By increasing a degree of sintering, a size of these random pores can be made smaller and the number of random pores per unit volume can be reduced. In the flame propagation suppression mechanism, it is important to set the size and the number so that a gas which passes through the narrowed flow path in the housing can pass through the random pores and that flame propagates less. A width of the pore in a longitudinal direction thereof is preferably 0.50 μm or more and 2.45 μm or less. Such “very small pores” are particularly effective for suppressing propagation of detonation flame of a hydrogen detonating gas or the like.

Meanwhile, such “very small pores” alone excessively cause a pressure loss in gas passage in a normal state. Therefore, it is preferable that the porous body also has comparatively larger pores (referred to as medium pores) which is 50 μm or more and 100 μm or less. These “very small pores” and “medium pores” can be retained as unsintered parts in sintering, and most of those are randomly connected to each other up to the surface of the porous body while being repeatedly bent, curved, branched, integrated, and the like. Such a configuration is preferable and can bring about a great flame propagation suppressive function within a moderate pressure loss.

In such a porous body, a density thereof is preferably 90% or less, more preferably 80% or less, further preferably 70% or less, most preferably 60% or less, as compared with a bulk material. The density is preferably 10% or more, more preferably 20% or more, further preferably 30% or more, most preferably 40% or more.

A material with a metal shred shape or a reticular shape was tried for flame propagation suppression. However, from the viewpoint of suppressing flame propagation of a pressurized hydrogen detonating gas, none of those could suppress flame propagation. In the flame propagation suppression section, it is possible to additionally provide a mechanism having a movable part such as a shutoff valve or a nonreturn valve. However, in a case where the passage gas is a wet gas, or the like, such a movable part may be broken. Therefore, it is preferable not to provide such a mechanism.

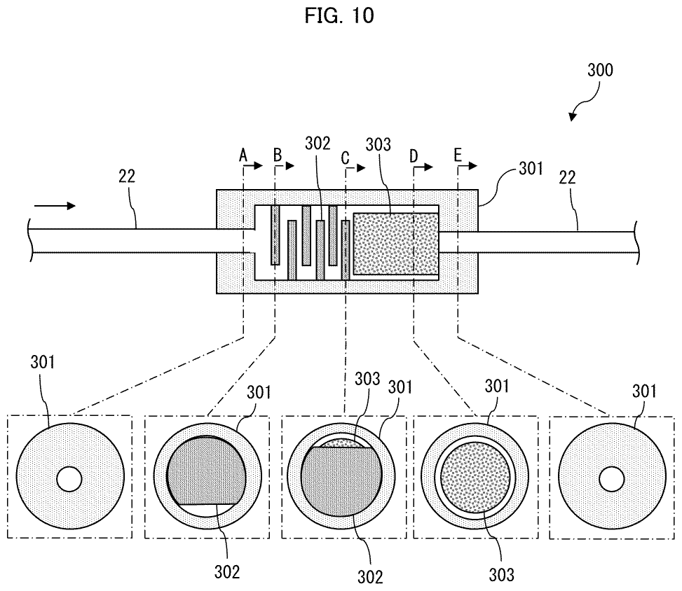

The following description will further discuss the flame propagation suppression section, with reference to FIGS. 10 through 17. Each of the flame propagation suppression sections illustrated in FIGS. 10 through 17 is disposed in the second pipe 22, and is made of metal such as SUS or brass. The porous body is a sintered body of metal.

FIG. 10 is a diagram schematically illustrating a configuration of a first example of the flame propagation suppression section in accordance with the present embodiment. As illustrated in FIG. 10, the flame propagation suppression section 300 includes a housing 301, a baffle plate 302, and a porous body 303. The housing 301 has a cylindrical peripheral wall and both end parts. The both end parts are connected to second pipes 22. As indicated by a cross-sectional shape of a part A, which is one end part of the housing 301, and a cross-sectional shape of a part E, which is the other end part, the inside of the housing 301 communicates with the second pipes 22 at the both end parts of the housing 301.

On one end side of the housing 301 in the axial direction, a plurality of baffle plates 302 are disposed, and on the other end side, the porous body 303 is disposed. As indicated by a cross-sectional shape of a part B near one end of the housing 301 and a cross-sectional shape of a part C near the center, each of the baffle plates 302 has a substantially circular planar shape with a cutout part where a partial arc of the circle has been cut off with a straight line. The baffle plates 302 are arranged so that the cutout parts of respective adjacent baffle plates 302 do not overlap each other in the axial direction. A space formed by a cutout part of a baffle plate 302 and an adjacent baffle plate 302 constitute a bent portion in the flow path of the raw gas. Spaces between baffle plates 302 adjacent to each other in the axial direction and cutout parts of the baffle plates 302 via which the spaces communicate with each other constitute a narrowed portion in the flow path of the raw gas.

The porous body 303 is disposed adjacent to the other end part of the housing 301. As indicated by a cross-sectional shape of a part D near that other end of the housing 301, the porous body 303 is a columnar porous body. A diameter of the porous body 303 is slightly smaller than an inside diameter of the housing 301. A space between an outer peripheral surface of the porous body 303 and an inner peripheral surface of the housing 301 constitutes a flow path for the raw gas. A large number of pores are continuous in the porous body 303. The pores constitute a flow path for the raw gas via which the inside of the housing 301 communicates with the pipe on the other end side described above.

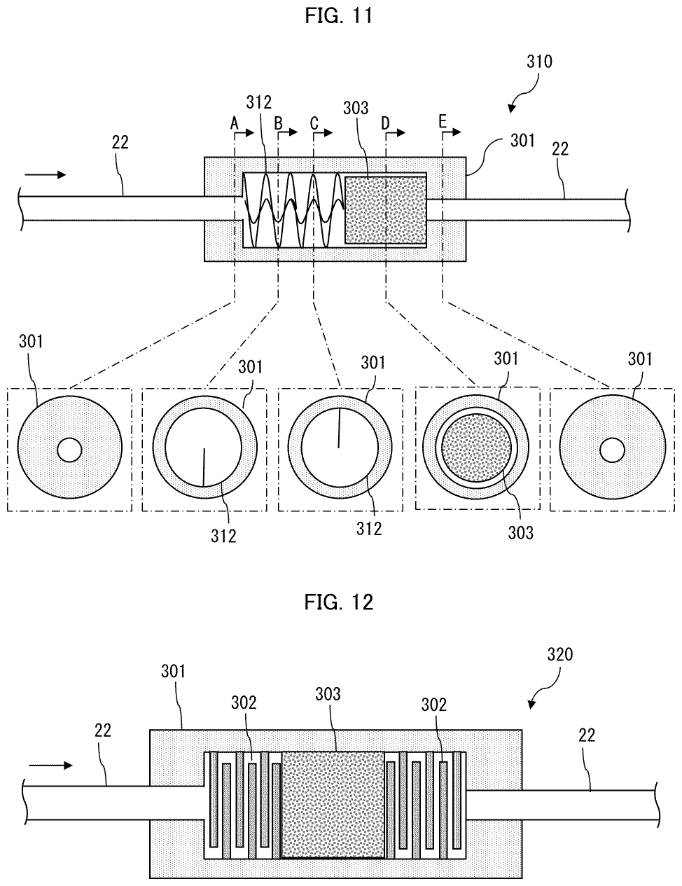

FIG. 11 is a diagram schematically illustrating a configuration of a second example of the flame propagation suppression section in accordance with the present embodiment. A flame propagation suppression section 310 illustrated in FIG. 11 has substantially the same configuration as the flame propagation suppression section 300 illustrated in FIG. 10, except that the flame propagation suppression section 310 includes a screw 312 in place of the plurality of baffle plates 302.

As indicated by a cross-sectional shape of a part B near one end of the housing 301 and a cross-sectional shape of a part C near the center, the screw 312 is fixed at the one end side inside of the housing 301, and constitutes a helical space from the one end of the housing 301 to the porous body 303. The helical space constitutes a bent portion. The screw 312 further forms a space which is narrowed from a space between the one end part of the screw 312 and the inner wall surface of the housing 301 to a space between parallel vanes of the screw 312, and the space thus serves as a narrowed portion.

FIG. 12 is a diagram schematically illustrating a configuration of a third example of the flame propagation suppression section in accordance with the present embodiment. A flame propagation suppression section 320 illustrated in FIG. 12 has substantially the same configuration as the flame propagation suppression section 300 illustrated in FIG. 10, except that the flame propagation suppression section 320 has a porous body 303 at the center of the housing 301 and a plurality of baffle plates 302 in both end parts of the housing 301. In the flame propagation suppression section 320 in FIG. 12, the plurality of baffle plates 302 are, as described above, arranged so that the cutout parts of respective adjacent baffle plates 302 do not overlap each other in the axial direction.

FIG. 13 is a diagram schematically illustrating a configuration of a fourth example of the flame propagation suppression section in accordance with the present embodiment. A flame propagation suppression section 330 illustrated in FIG. 13 has substantially the same configuration as the flame propagation suppression section 310 illustrated in FIG. 11, except that the flame propagation suppression section 330 has a porous body 303 at the center of the housing 301 and screws 312 in both end parts of the housing 301.

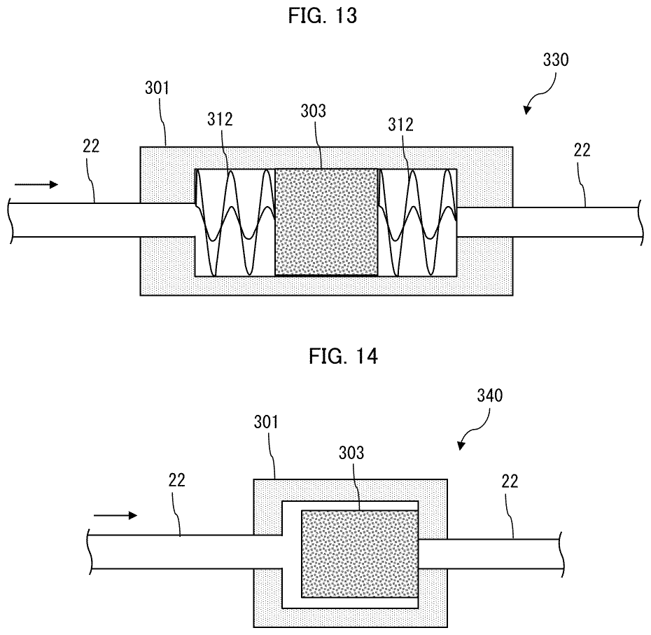

FIG. 14 is a diagram schematically illustrating a configuration of a fifth example of the flame propagation suppression section in accordance with the present embodiment. A flame propagation suppression section 340 illustrated in FIG. 14 has substantially the same configuration as the flame propagation suppression section illustrated in FIG. 10, except that the flame propagation suppression section 340 does not have a baffle plate and a porous body 303 extends from the other end to the one end part of the housing 301. The porous body 303 forms a circular first space that spreads from the pipe to the outer side in a circumferential direction at the one end part in the housing 301. Moreover, the porous body 303 forms a cylindrical second space with the inner peripheral surface of the housing 301 from the one end part to the other end in the housing 301. The first space constitutes a bent portion that is bent from the pipe. The second space constitutes a bent portion that is bent from the first space. Furthermore, the first space is a flow path that has a narrowed width from the pipe, and thus constitutes a narrowed portion.

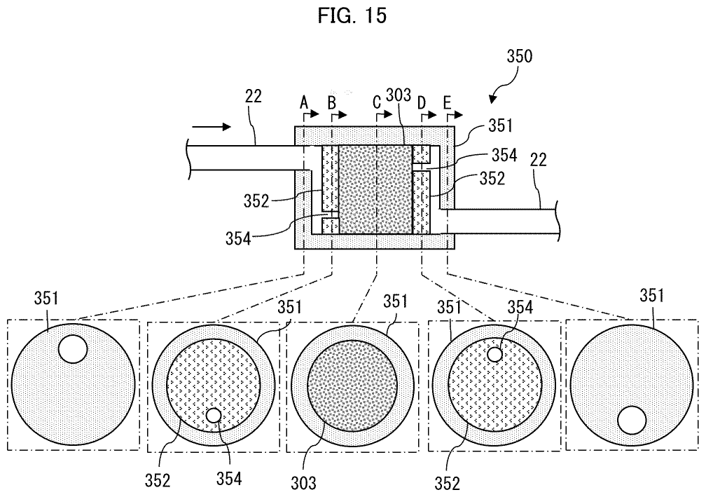

FIG. 15 is a diagram schematically illustrating a configuration of a sixth example of the flame propagation suppression section in accordance with an embodiment of the present invention. A flame propagation suppression section 350 illustrated in FIG. 15 has substantially the same configuration as the flame propagation suppression section 320 illustrated in FIG. 12 above, except that the second pipe 22 is connected to a peripheral part rather than a center part of a housing 351, as indicated by cross-sectional shapes of parts A and E which are end parts of the housing 351, and, instead of the baffle plates 302, communicating plates 352 are included which make contact with respective end surfaces of the porous body 303, as indicated by cross-sectional shapes of parts B and D which are near the end parts of the housing 351.

The communicating plate 352 is a disk having a diameter identical to an inside diameter of the housing 351 and has a communicating hole 354 that has a circular opening shape in a peripheral part. The communicating plate 352 is disposed in the housing 351 so that a position of the communicating hole 354 does not overlap with the second pipe 22 which is connected to the housing 351 in the axial direction. A space between the communicating plate 352 and an end part of the housing 351 constitutes a bent portion that is bent from the pipe. The communicating hole 354 constitutes a bent portion that is bent from the space at the end part of the housing 351 to the communicating hole. The communicating hole 354 constitutes a narrowed portion that is narrowed from the space to the communicating hole 354.

FIG. 16 is a diagram schematically illustrating a configuration of a seventh example of the flame propagation suppression section in accordance with an embodiment of the present invention. A flame propagation suppression section 360 illustrated in FIG. 16 has substantially the same configuration as the flame propagation suppression section 340 illustrated in FIG. 14, except that the flame propagation suppression section 360 includes a cylindrical porous body 363 and includes a top section 365 adjacent to one end surface of the porous body 363. The porous body 363 has a columnar space in the center that communicates with the pipe at the other end side. The top section 365 includes a disk part 366 and a shaft part 367.

The disk part 366 has a thickness that forms a space with one end of the housing 301. As indicated by a cross-sectional shape of a part B near one end of the housing 301, the disk part 366 has the same diameter as the porous body 363, and a space is formed between the outer peripheral surface thereof and the housing 301. As indicated by a cross-sectional shape of the center part C of the housing 301, the shaft part 367 is a columnar rod member having a diameter smaller than a space of the center part of the porous body 363.

A space formed by the disk part 366 in the one end part of the housing 301 constitutes a bent portion that is bent from the second pipe 22, and constitutes a narrowed portion in which a width of the flow path is narrowed from the second pipe 22. A space in the one end part and a space at the outer periphery side of the disk part 366 which communicates with the space constitute a bent portion that is bent from the space in the one end part.

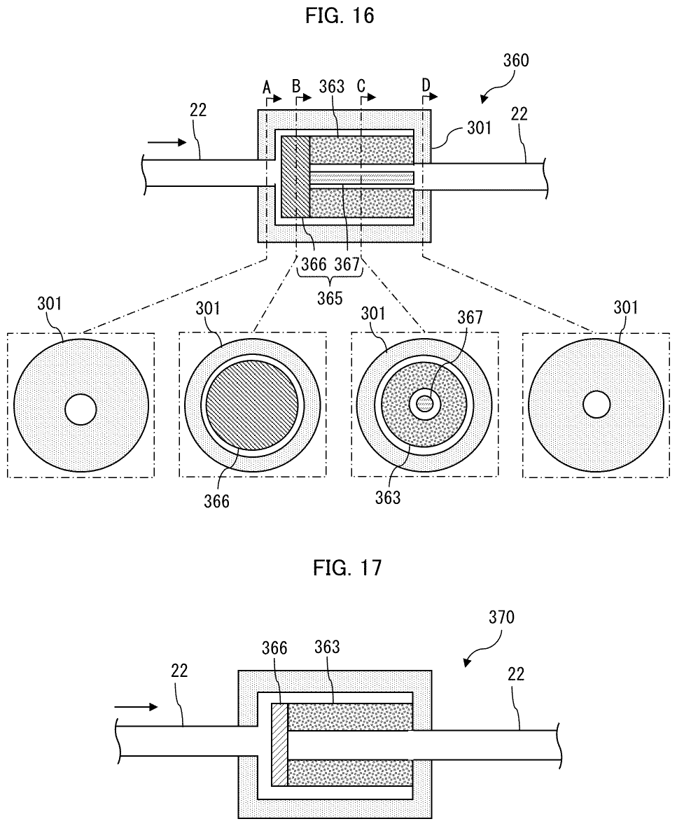

FIG. 17 is a diagram schematically illustrating a configuration of an eighth example of the flame propagation suppression section in accordance with an embodiment of the present invention. A flame propagation suppression section 370 illustrated in FIG. 17 has substantially the same configuration as the flame propagation suppression section 360 illustrated in FIG. 16, except that the flame propagation suppression section 370 does not include the shaft part 367.

In addition to the configuration described above, the flame propagation suppression section preferably includes a mechanism for cooling the housing.

The housing may play a role as a heat radiation mechanism by making contact with flame, and consequently decrease a temperature of the flame itself. Therefore, by actively cooling the housing, it is possible to more effectively cause a temperature decrease in flame, and it is expected to improve flame extinction performance. Cooling of the housing may be natural air-cooling. The air-cooling is preferable because the flame propagation suppression section can be simply constituted. With a configuration in which forced air cooling is achieved by a blower or the like, it is possible to enhance the heat radiation property of the housing. Therefore, such a configuration can be preferably employed from the viewpoint of enhancing flame extinction performance. Furthermore, cooling of the housing of the flame propagation suppression section with water can further enhance the heat radiation property of the housing. Therefore, further improvement in flame extinction performance is expected, and such a configuration can be more preferably employed. From that viewpoint, it is preferable to provide a pipe that allows a cooling water to pass through to an outer part of the housing of the flame propagation suppression section. In these configurations, as the outer shape of the housing, it is preferable to employ a shape that increases the surface area from the viewpoint of ensuring heat radiation property, and it is more preferable to employ a shape that includes a heat radiating fin or the like.

Meanwhile, it is possible to preferably employ a configuration for reducing, by means of an internal configuration, a temperature of flame which enters the flame propagation suppression section. For example, it is preferable to employ a configuration for reducing a flame temperature in which a block-like or plate-like metallic member (like the top section described above) is disposed in a propagating direction of flame which has reached the flame propagation suppression section so as to make the flame into a thin layer, and heat radiation is achieved by both the metallic member and the housing of the flame propagation suppression section.

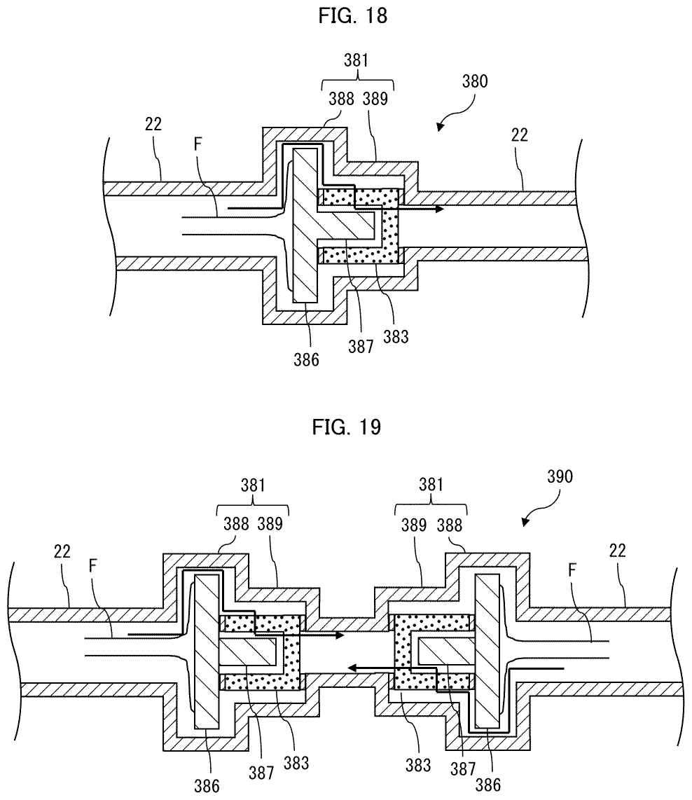

FIG. 18 is a diagram schematically illustrating a configuration of a ninth example of the flame propagation suppression section in accordance with an embodiment of the present invention. A flame propagation suppression section 380 illustrated in FIG. 18 has a configuration similar to the flame propagation suppression section 360 illustrated in FIG. 16. The flame propagation suppression section 380 illustrated in FIG. 18 includes a housing 381, a porous body 383, and a top section 385. The porous body 383 is a sintered body of metal, and the other components are all made of metal such as SUS or brass.

The housing 381 includes: a first cylindrical part 388 which has a larger diameter and is located at one end side; and a second cylindrical part 389 which has a smaller diameter and is located at the other end side. The porous body 383 is disposed at the other end side (in the second cylindrical part 389) in the housing 381. The porous body 383 has a cup-like shape with a columnar hole at the center of the columnar body. The top section 385 is constituted by a disk part 386 and a shaft part 387. The disk part 386 has a diameter slightly smaller than the inside diameter of the first cylindrical part 388. The shaft part 387 is a columnar rod member with a length slightly shorter than a depth of the hole in the porous body 383.

A space between one end of the first cylindrical part 388 and the disk part 386 constitutes a bent portion that is bent from the second pipe 22. The space also serves as a narrowed portion in which a width of the flow path of the raw gas is narrowed from the width of the pipe. For a space between an inner peripheral surface of the first cylindrical part 388 and an outer peripheral surface of the disk part 386, a space between the other end surface of the first cylindrical part 388 and the disk part 386, and a space between an inner peripheral surface of the second cylindrical part 389 and the outer peripheral surface of the porous body 383, boundary sections between adjacent spaces each also serve as a bent portion that changes a flowing direction of the raw gas. A space between the peripheral surface of the hole in the porous body 383 and the outer peripheral surface of the shaft part 387 of the top section 385 also serves as a bent portion that directs the flowing direction of the raw gas toward the other end part.

In the flame propagation suppression section 380 illustrated in FIG. 18, flame F that has reached the flame propagation suppression section 380 collides with the disk part 386 and is spread out in the radial direction. A size of the above space can be set based on a flame propagation limit value (maximum safety space) that is set based on an explosion class or the like in accordance with a type of gas. Thus, propagation of flame F is prevented. In the present invention, a size of the space in the flame propagation suppression section can be set based on a flame propagation limit value (maximum safety space) as described above. Furthermore, the top section 385 absorbs a part of heat of flame F. The housing 381 absorbs a part of heat of flame F and releases the heat outward. The housing 381 has a wider outer surface as compared with a cylindrical form as a whole. Therefore, it is easier to release heat and it is expected to bring about a further cooling effect in flame propagation.

FIG. 19 is a diagram schematically illustrating a configuration of a tenth example of the flame propagation suppression section in accordance with an embodiment of the present invention. The flame propagation suppression section 390 illustrated in FIG. 19 includes a configuration in which two flame propagation suppression sections 380 each illustrated in FIG. 18 are connected to each other so that one of disk parts 386 is opposed to the upstream side of the flow of the raw gas, and the other disk part 386 is opposed to the downstream side. The flame propagation suppression section 390 illustrated in FIG. 19 brings about a function and an effect similar to those of the flame propagation suppression section 380 illustrated in FIG. 18, with respect to flame F that propagates from both directions of the upstream side and the downstream side.

### <Pressure Reduction Section>

In a case where the pressure reduction section has a function of reducing a shock wave pressure propagating through the pipe, direct and indirect pressure changes associated with occurrence of deflagration or detonation, pressure change due to unexpected excessive chemical reaction, and the like, a form of the pressure reduction section may be selected in various ways.

### (Arrangement of Pressure Reduction Section And Shape of Connective Piping)

The pressure reduction section is disposed at an end part of the third pipe which is not orthogonal to an extension line of the first pipe in a flowing direction of the raw gas in the first pipe.

Flame and a shock wave caused due to deflagration or detonation may propagate in any direction, and the propagation of flame and a shock wave is particularly rich in property to propagate straight. Therefore, in a case where it is intended to most effectively reduce influence of flame and a shock wave propagating from the first pipe side, the pressure reduction section is preferably disposed to confront an extension line of the first pipe in a flowing direction of the raw gas in a normal state. Most preferably, the pressure reduction section is disposed to confront the flowing direction from the front. In a case of such an arrangement and while taking into consideration an arrangement of the second pipe as described above, the connective piping section is most preferably configured to have a T-shape.

Meanwhile, if the pressure reduction section is disposed at an end part of a third pipe which is orthogonal to an extension line of the first pipe in a flowing direction of the raw gas in the normal state, the effect is reduced. Therefore, the third pipe to which the pressure reduction section in accordance with an aspect of the present invention is provided is not orthogonal to any of the first pipe and the second pipe.

Among angles formed by (i) the third pipe to which the pressure reduction section is provided at the end part and (ii) an extension line of the first pipe in the flowing direction of the raw gas in a normal state, an angle of a smaller value is preferably 75° or less, more preferably 50° or less, further preferably 30° or less, further preferably 15° or less, most preferably 0°. That is, in this case, the pressure reduction section confronts, from the front, the extension line of the first pipe in the flowing direction of the raw gas in a normal state.

(Case where Pressure Reduction Section is Reversible Pressure Release Device)

The pressure reduction section in accordance with an aspect of the present invention is disposed at the end part of the third pipe, and is configured to reduce an internal pressure of the third pipe in a case where the internal pressure has risen. One form of the pressure reduction section is a case of utilizing a so-called safety valve. In this case, if an internal pressure in the pipe is equal to or greater than a specific value, the pressure is released to the outside of the system. As a result, the pressure in the pipe is reduced, and thus the state is reversibly returned to a closed state. Therefore, such a configuration may be limitedly used in a case in which pressure change or the like is assumed to be comparatively small. A lowest pressure P(release) (MPa(G)) that is released to the outside of the system is preferably 0.1 MPa(G) or more, more preferably 0.2 MPa(G) or more, further preferably 0.3 MPa(G) or more, most preferably 0.4 MPa(G) or more. This is because, in some cases, it is dangerous to inadvertently release, to the outside of the system, a combustible gas or the like which passes through the system in excessively small pressure change. Meanwhile, in a case of using such a simple method, an excessively high lowest pressure released should be avoided from the viewpoint of ensuring safety. Therefore, an upper limit of the released lowest pressure is preferably 0.98 MPa(G) or less, more preferably 0.9 MPa(G) or less, further preferably 0.8 MPa(G) or less, most preferably 0.7 MPa(G) or less.

When written in a form of formula, the lowest release pressure P(release) (MPa(G)) satisfies a formula below:

0.1≤P(release)≤0.98.

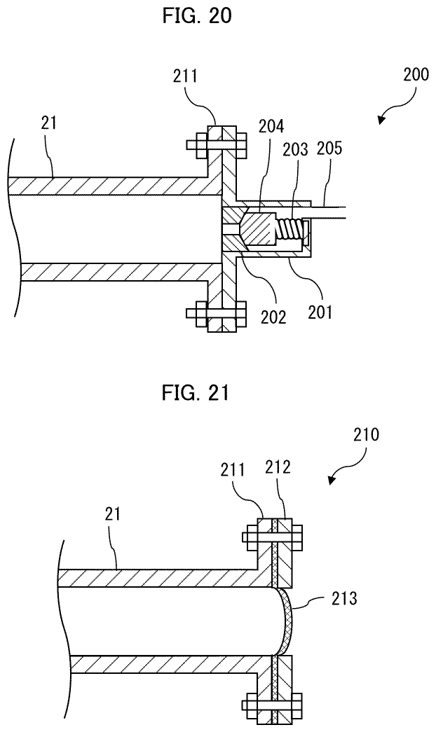

FIG. 20 illustrates an example of the pressure reduction section, which is a reversible pressure release device. FIG. 20 is a cross-sectional view schematically illustrating a configuration of a first example of the pressure reduction section in accordance with an embodiment of the present invention. FIG. 20 illustrates an aspect in which the pressure reduction section is a safety valve.

The safety valve 200 is attached to a flange 211 located at an end of the third pipe 21 by a bolt and a nut. The safety valve 200 includes: a valve seat 202 having a through hole via which the third pipe 21 and a valve chest 201 communicate with each other; a valve element 204 which is pressed against the valve seat 202 by a spring 203 in the valve chest 201; and a communicating pipe 205 via which the valve chest 201 communicates with the outside. When an internal pressure of the third pipe 21 is greater than pressing force by the spring 203 toward the valve element 204, the spring 203 contracts, and the inside of the third pipe 21 communicates with the outside via the through hole, the valve chest 201, and the communicating pipe 205. As a result, a gas inside the third pipe 21 is released from the communicating pipe 205 to the outside, and thus the internal pressure of the third pipe 21 is reduced. When the internal pressure of the third pipe 21 is less than the pressing force of the spring, the valve element 204 is pressed by the spring 203 and makes contact with the valve seat 202.

(Case where Pressure Reduction Section is Rupture Disk Unit)

The pressure reduction section may include a rupture disk unit that blocks the third pipe. In a case where the pressure reduction section is a rupture disk unit, it is possible to expect the following three effects. A first effect brought about by using the rupture disk unit is that rupture of the rupture disk irreversibly releases a pressure in the system to the outside of the system. In this case, unlike the case of the safety valve, when a rupture disk provided in the rupture disk unit once ruptures and releases an excessive pressure to the outside of the system, the part where the rupture disk has been provided is not closed. Therefore, it is possible to effectively and reliably reduce the pressure in the system. In a case where it is assumed that a shock wave pressure, direct and indirect pressure changes associated with occurrence of deflagration or detonation, and pressure change due to unexpected excessive chemical reaction are large, such a configuration is particularly suitable.

A second effect brought about by using the rupture disk unit is that a shock wave or an associated direct and indirect pressure change at the rupture disk can be suppressed by a shape of the rupture disk. This effect continues in terms of time unless the rupture disk ruptures. The rupture disk unit is constituted by a housing section that holds a rupture disk and the rupture disk that has a breakage pressure (P(burst) (MPa(G)) designed based on quality of material, thickness, size, or shape of the rupture disk. In this configuration, particularly in regard to the shape of the rupture disk, various forms can be selected from: a form in which a planer rupture disk confronts a direction in which a shock wave or pressure change propagates; a form in which a concave rupture disk confronts that direction; a form in which a convex rupture disk confronts that direction; a form in which those shapes are combined in the plane; and the like.

According to the studies by the inventors of the present invention, any one of those shapes is preferable in the flame extinction mechanism of the present invention. It has been experimentally confirmed that the shape is more preferably a vertically planar surface, a concave surface, or a convex surface, further preferably a vertically planar surface or a convex surface, most preferably a convex surface. The mechanism in this case is not clear, but it is inferred as follows. That is, in a case where the rupture disk does not rupture and does not release pressure to the outside of the system, a shock wave or a wave of pressure change is reflected by the rupture disk surface against a direction in which pressure change propagates. It is inferred that the reflection brings about an effect of interfering with an incident wave to reduce a pressure thereof. As such, an aspect of the pressure reduction section in accordance with the present invention may be a pressure reduction section that generates a reflected wave which interferes with an incident wave of a shock wave at an end part of the third pipe to reduce an internal pressure of the third pipe.

A third effect brought about by using the rupture disk unit is a synergistic effect of the second effect and the first effect described above. That is, until the rupture disk ruptures, the pressure in the system is reduced by the second effect described above. Nevertheless, in a case where the pressure in the system does not decrease, the rupture disk ruptures to reliably release the pressure in the system to the outside of the system.

In a case where a pressure reduction effect is expected based mainly on rupture of the rupture disk and release of a pressure to the outside of the system, an upper limit selection of a burst pressure P(burst) (MPa(G)) of the rupture disk is important. The upper limit is preferably 3 MPa(G) or less, more preferably 2 MPa(G) or less, further preferably 1 MPa(G) or less, most preferably 0.5 MPa(G) or less. A lower limit thereof can be selected as appropriate from gas pressures in the system in a normal state. The lower limit is preferably 0.25 MPa(G) or more, more preferably 0.30 MPa(G) or more, further preferably 0.35 MPa(G) or more, most preferably 0.40 MPa(G) or more.

Meanwhile, in a case where a pressure reduction effect is expected based mainly on selection of the shape of the rupture disk surface and effective suppression of a shock wave or pressure change which is considered to be reflection/interference, a burst pressure P(burst) (MPa(G)) of the rupture disk needs to be high to a certain extent, and selection of a lower limit thereof is important. The lower limit is preferably 5 MPa(G) or more, more preferably 6 MPa(G) or more, further preferably 7 MPa(G) or more, most preferably 8 MPa(G) or more. An upper limit thereof is preferably 12 MPa(G) or less, more preferably 11 MPa(G) or less, further preferably 10 MPa(G) or less, most preferably 9 MPa(G) or less so that it is possible to release a pressure in a case where the effect is not sufficient.

When written in a form of formula, the burst pressure P(burst) (MPa(G)) of the rupture disk satisfies a formula below:

0.25≤P(burst)≤12.

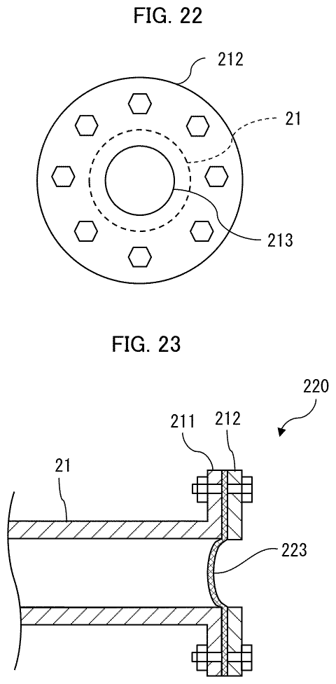

FIG. 21 and FIG. 22 illustrate an example of the pressure reduction section, which is a rupture disk unit. FIG. 21 is a cross-sectional view schematically illustrating a configuration of a second example of the pressure reduction section in accordance with an embodiment of the present invention. FIG. 22 is a right side view schematically illustrating a side of the pressure reduction section illustrated in FIG. 21.

The pressure reduction section 210 illustrated in FIG. 21 is constituted by a rupture disk 213 which is held between flanges 211 and 212 at an end of the third pipe 21. For example, the rupture disk 213 is attached by holding the rupture disk 213 between a pair of annular holders (not illustrated), and fixing the holders with a bolt and a nut to the flanges 211 and 212 via a gasket (not illustrated). Such a configuration that includes the rupture disk 213 and that attaches the rupture disk 213 to the flanges 211 and 212 is referred to as a “rupture disk unit”. The rupture disk 213 has a dome-like curved surface, and is attached so that the curved surface is convex toward the outside.

The pressure reduction section 210 illustrated in FIGS. 21 and 22 ruptures when, for example, an internal pressure of the third pipe 21 has acutely risen by detonation or the like to reach or exceed a particular pressure. As a result, the third pipe 21 is released outward, and the internal pressure of the third pipe 21 is reduced.

FIG. 23 illustrate another example of the pressure reduction section, which is a rupture disk unit. FIG. 23 is a cross-sectional view schematically illustrating a configuration of a third example of the pressure reduction section in accordance with an embodiment of the present invention. A pressure reduction section 220 illustrated in FIG. 23 is attached so that a curved surface of a rupture disk 223 is convex toward the inside of the third pipe 21 (i.e., so that the curved surface is concave toward the outside). The other configurations of the pressure reduction section 220 illustrated in FIG. 23 are substantially identical with those of the pressure reduction section 210 illustrated in FIG. 21 and FIG. 22.

The pressure reduction section illustrated in FIG. 23 does not rupture even if, for example, detonation or the like occurs in the pipe. The pressure reduction section 220 illustrated in FIG. 3 is considered to reduce an internal pressure of the third pipe 21 by generating, at the end part of the third pipe 21, a reflected wave which interferes with an incident wave of a shock wave.

The above descriptions have discussed pressure reduction by the safety valve or the rupture disk. Other than those configurations, it is possible to provide a pressure reduction section by shape control of the pipe end part itself. For example, various forms can be selected from: a form in which a planer surface confronts a direction in which a shock wave or pressure change propagates; a form in which a concave surface confronts that direction; a form in which a convex surface confronts that direction; a form in which those shapes are combined in the plane; and the like. According to the studies by the inventors of the present invention, the shape is more preferably a vertically planar surface, a concave surface, or a convex surface, further preferably a vertically planar surface or a convex surface, most preferably a convex surface. The mechanism in this case is not clear, but it is inferred as follows. That is, in a case where pressure resistance of the pipe is sufficiently ensured and pressure is not released to the outside of the system, a shock wave or a wave of pressure change is reflected at the surface of the pipe end part against a direction in which pressure change propagates. It is inferred that the reflected wave interferes with an incident wave, attenuates a pressure thereof, and consequently brings about an effect of reducing the pressure.

### <Shock Absorption Section>

The pressure reduction section in the flame extinction mechanism of the present invention is preferably provided with a shock absorption section that surrounds the pressure reduction section or that surrounds a part where pressure release occurs. In a case where the pressure reduction section brings about an effect thereof by, in particular, releasing a pressure to the outside of the system, a combustible gas in the system may be released to the atmosphere. This leads to a possibility to induce further damage in reaction with oxygen or the like in the air. In such a case, it is preferable to mitigate a pressure released from the pressure reduction section with a shock absorption section having a sufficient volume and pressure resistance, and process the pressure in the system.

In such a viewpoint, a pressure of the shock absorption section in a normal state is preferably substantially an atmospheric pressure. In the shock absorption section, it is preferable to cause a dilution gas to pass through at all times so that a gas (or, in some cases, a liquid or powder reactant, or the like) released from the pressure reduction section is not scattered to the periphery but is diluted. In this viewpoint, for example, in a case where an artificial photosynthesis plant includes pressure reduction sections at a plurality of locations, shock absorption sections that cover the pressure reduction sections at the respective locations may each preferably function alone, or it is preferable to connect the shock absorption sections to each other and cause a dilution gas to pass through the shock absorption sections.

A dilution gas which is caused to pass through the shock absorption section can be selected arbitrarily from single gases and a mixed gas thereof, provided that the gas is chemically stable and does not easily react with other elements or compounds. For example, it is possible to select helium, neon, argon, krypton, xenon, or radon, which are rare gases, or nitrogen, which is usually poor in reactivity. Among those, a mixed gas containing nitrogen or a nitrogen gas is preferable. In a case of large-scale dilution, it is preferable to intentionally cause the atmospheric air to pass through. It is possible to provide flame extinction performance by causing a carbon dioxide gas to pass through.

The shock absorption section in the flame extinction mechanism of the present invention preferably has sufficient volume, pressure resistance, and explosion resistance to bring about functions of, in a case where a pressure is released from the pressure reduction section, mitigating the pressure change and processing the pressure change in the system. In particular, it is important to prevent the pressure from the pressure reduction section from being released to the outside of the system. By doing so, it is possible to eliminate concern about secondary damage due to reaction with oxygen in the air or the like, which is concerned in a case where a combustible gas in the system is released to the atmosphere.

Therefore, the shock absorption section preferably has sufficient pressure resistance and explosion resistance, and preferably has high gas-tightness. In order to endure an intense shock wave or pressure change in occurrence of detonation, a pressure resistance P (buffer) (MPa(G)) of the shock absorption section is preferably 2 MPa(G) or more, more preferably 4 MPa(G) or more, further preferably 8 MPa(G) or more, most preferably 16 MPa(G) or more. Note, however, that, if the pressure resistance and explosion resistance are excessively enhanced, the thickness of the shock absorption section excessively increases. This causes problems that the weight of the shock absorption section is excessively large and the cost is excessively high. Therefore, an upper limit thereof is preferably 30 MPa(G) or less, more preferably 27.5 MPa(G) or less, further preferably 25 MPa(G) or less, most preferably 22.5 MPa(G) or less.

The shock absorption section preferably has a relatively large volume, which effectively reduces a pressure released from the pressure reduction section. The volume of the shock absorption section is preferably 0.1 times or more, more preferably 1 times or more, further preferably 10 times or more, most preferably 50 times or more, with respect to a value obtained by dividing a volume of all pipes in the system by the number of pressure reduction sections. However, in a case where the volume is excessively large, problems may be induced in installation or the like. Therefore, the volume of the shock absorption section is preferably 1000 times or less, preferably 500 times or less, more preferably 250 times or less, most preferably 100 times or less, with respect to a value obtained by dividing a volume of all pipes in the system by the number of pressure reduction sections.

Furthermore, a shape of the shock absorption section is preferably a columnar shape or a spherical shape. This is because, from the viewpoint of pressure resistance and explosion resistance, such a shape is superior even if the thickness of the constituent material is the same.

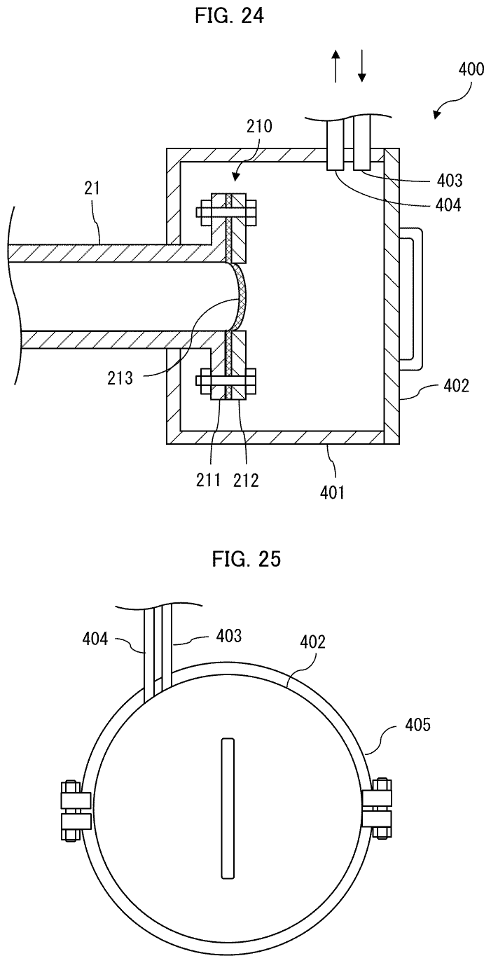

FIG. 24 is a cross-sectional view schematically illustrating a configuration of an example of the shock absorption section in accordance with an embodiment of the present invention. FIG. 25 is a right side view schematically illustrating a side of the shock absorption section illustrated in FIG. 24. The shock absorption section 400 illustrated in FIG. 24 includes a main body 401 that accommodates a pressure reduction section 210; and a lid part 402 that closes an opening of the main body 401 in an openable and closable manner. The shock absorption section 400 is made of metal such as SUS. The pressure reduction section 210 is identical with the pressure reduction section 210 illustrated in FIG. 21 described above.

The main body 401 includes a bottom part and a peripheral wall part. The bottom part is an annular plate that extends from the outer peripheral surface of the third pipe 21 to the outer side in a circumferential direction. The peripheral wall part is a cylindrical part that stands from a circumferential edge of the bottom part. Two pipes, i.e., an inlet pipe 403 and an exhaust pipe 404, penetrate through the peripheral wall part. The lid part 402 is fixed to an opening of the main body 401 by, for example, an annular bolt band 405.

The shock absorption section 400 covers the entire pressure reduction section 210 in both the axial direction and the circumferential direction of the third pipe 21. An inert gas such as a nitrogen gas passes through the inlet pipe 403 and the exhaust pipe 404, and the inside of the shock absorption section 400 is constantly in an inert gas atmosphere. In a case where the rupture disk 213 ruptures outward due to detonation in the pipe or the like, the gas in the third pipe 21 is retained in the shock absorption section 400, and propagation of kinetic energy of the rupture is limited to the inside of the shock absorption section 400.

### <Silencing Device>

In the pressure reduction section inside the flame extinction mechanism of the present invention, it is possible to additionally provide a silencing mechanism in a case of expecting a pressure releasing effect by rupture of the rupture disk. Such a configuration is preferable from the viewpoint of suppressing noise to the surrounding area. As the silencing mechanism, it is possible to employ various kinds of silencers as appropriate. It is possible to employ any of types such as an absorption type and an interference type. For the absorption type, there is concern about deterioration due to influence on a sound absorbing material by occurrence of detonation. However, the absorption type silencing mechanism has a high sound pressure suppressive effect, and can be suitably used when noise suppression is particularly intended. Meanwhile, the interference type intends to achieve noise suppression by a shape thereof or the like. Although a sound pressure suppressive effect of the interference type silencing mechanism is not relatively high, it is possible to constitute an interference type member only by a metallic material. The interference type silencing mechanism can be used in a case where it is necessary to take into special consideration in terms of durability or the like.

<Applications, Etc. Of Flame Extinction Device>

The flame extinction device in accordance with the present invention can be used in any mechanical equipment, chemical equipment, and the like which involve concern about occurrence of explosion and detonation. The flame extinction device in accordance with the present invention is applicable to any combustible gases and a mixed gas containing a combustible gas and a combustion-supporting gas. In particular, the flame extinction device in accordance with the present invention can be suitably used in chemical equipment through which a hydrogen detonating gas passes in which hydrogen and oxygen having particularly large explosion power coexist, and more suitably used in “equipment in which hydrogen and oxygen are generated using a photocatalyst and pass therethrough” or the like. The latter may be referred to as an “artificial photosynthesis plant”. In a case where a photocatalytic reactor is pressurized from the viewpoint of gas transportation, a hydrogen-oxygen mixed gas (hydrogen detonating gas) having a stoichiometric composition is to be generated in the pressurized state. In such a case, the flame extinction device in accordance with the present invention is most suitably applicable. Thus, the flame extinction device in accordance with an embodiment of the present invention is suitable for an application in which the raw gas is a mixed gas containing hydrogen and oxygen.

The hydrogen-oxygen mixed gas generated in water decomposition in such an artificial photosynthesis plant will contain saturated water vapor at that temperature. In the present invention, it is preferable to constitute all of “at least one flame propagation suppression section that includes a housing, a narrowed flow path in the housing, and a porous portion that can allow a gas which flows through the narrowed flow path in the housing to pass therethrough and that has gaps”, “at least one pressure reduction section”, and “at least one connective piping section” with a material that does not generate any particular deterioration or the like upon passage of a gas containing water vapor. With such a configuration, it is considered that a hydrogen detonating gas containing saturated water vapor has detonation power lower than that in a dry state. Therefore, it is extremely preferable to include water in the passing gas.

From this viewpoint, the flame extinction mechanism of the present invention preferably does not have a movable part. For example, the flame propagation suppression section may be provided with a shutoff valve or a nonreturn valve that prevents backflow of flame and a gas in detonation. However, there is concern that, if a gas containing saturated water vapor passes through such a shutoff valve or the like at that temperature, the gas may be condensed due to change in an outside air temperature or the like. As a result, a failure is likely to occur. Therefore, it is preferable that a spring or a movable mechanism which, in some cases, depends on melt of a low melting point metal is not included in the flame propagation suppression section. The same applies to the pressure reduction section. That is, it is more preferable to provide effective pressure reduction by a rupture disk unit or a pipe end part shape, rather than a configuration having a reversibly-movable part such as a safety valve. A pressure releasing effect of the rupture disk is achieved by irreversible rupture (breakage) thereof. Therefore, it is not necessary to eliminate the rupture disk as a movable part.

As described above, the flame extinction mechanism of the present invention can be suitably used in an artificial photosynthesis plant. In the plant, a hydrogen-oxygen mixed gas containing water vapor generated in the photocatalytic reactor is generated with a stoichiometric composition. A dehumidification tower or the like is disposed downstream thereof. A gas separator membrane is provided further downstream thereof which separates hydrogen and oxygen by a molecular sieving effect. Here, in a case where the present flame extinction mechanism is disposed at an outlet of the photocatalytic reactor, a wet gas containing hydrogen:oxygen=2:1 passes through. In the case where the present flame extinction mechanism is disposed at an outlet of the dehumidification tower, a dry gas containing hydrogen:oxygen=2:1 passes through. A ratio of hydrogen and oxygen in the gas which passes through on the permeation side of the gas separator membrane (i.e., the hydrogen-rich side at the hydrogen recovery side) depends on the performance of the separator membrane. A gas composition on the non-permeation side of the gas separator membrane (i.e., the oxygen-rich side where oxygen remains as a result of permeation of hydrogen through the separator membrane) also depends on the performance of the separator membrane.

In the flame extinction mechanism of the present invention, it has been confirmed from the experiments by the inventors that it is possible to extinguish flame even for a pressurized hydrogen detonating gas of hydrogen:oxygen=2:1 that may cause most intense detonation. From this viewpoint, the composition of hydrogen and oxygen which pass through in the artificial photosynthesis plant may vary in accordance with a process, a material, a configuration, and the like. In any case, the power is assumed to be weaker than a case where a pressurized hydrogen detonating gas of hydrogen:oxygen=2:1 detonates. Therefore, it is considered that flame extinction is possible. Therefore, it is possible to suitably use the present flame extinction mechanism for a mixed gas having an arbitrary composition which is within an explosive range in which a flow ratio of hydrogen and oxygen that pass through is 99:1 to 1:99, more preferably 96:4 to 4:96.

The flame extinction mechanism of the present invention can be suitably used in an artificial photosynthesis plant as described above. A pressure of the hydrogen-oxygen (water vapor) mixed gas that passes through can be selected as appropriate. For example, in order to reduce detonation power, a pressure in the photocatalytic reactor is preferably a reduced pressure.

However, in a case where the pressure in the photocatalytic reactor is reduced, an amount of water vapor which is entrained in generation of a hydrogen-oxygen mixed gas is enormous. Therefore, an excessively large load may applied to the subsequent dehumidification process, which necessitates caution. Further, in order to transport the generated gas to the downstream process, the pressure of the hydrogen-oxygen mixed gas is to be increased once, and it is thus necessary to provide a new process.

In another case, in a case where, although detonation power is increased compared with that in a reduced pressure state, a pressure of the photocatalytic reactor is set to an atmospheric pressure, an amount of water vapor entrained in generation of a hydrogen-oxygen mixed gas can be reduced, as compared with that in the reduced pressure state. Such a configuration is preferable. However, a problem remains in ensuring a pressure for transporting the gas to the downstream process. In order to deal with this, in a case where, although power in occurrence of detonation is increased compared with that in a reduced pressure state and an atmospheric pressure state, a pressure of the photocatalytic reactor is increased, an amount of water vapor entrained in generation of a hydrogen-oxygen mixed gas can be reduced, as compared with that in the reduced pressure state and the atmospheric pressure state. Such a configuration is more preferable. Furthermore, the problem in ensuring a pressure for transporting the gas to the downstream process is also solved. Therefore, the pressure of the hydrogen detonating gas in the photocatalyst panel part is more preferably a raised pressure. As such, in an embodiment of the present invention, the raw gas preferably has a pressure higher than an atmospheric pressure.

### <Regarding Artificial Photosynthesis Plant>

The flame extinction device in accordance with the present invention is applied to a hydrogen-oxygen production device for obtaining hydrogen and oxygen by decomposing water. In particular, there are several methods for producing green hydrogen. Known are a method for carrying out electrolysis of water using renewable energy such as sunlight, and complete decomposition of water (i.e., a method for decomposing water into hydrogen and oxygen to obtain hydrogen) using a photocatalyst.

In the method of electrolysis, hydrogen and oxygen are obtained from respective electrodes. In practice, hydrogen and oxygen that are mixed to a certain extent are taken out. In a case where a solar battery is used, sunlight is once transformed to electricity, and water is decomposed using the electricity. Therefore, energy conversion efficiencies at respective stages are multiplied, and a loss is large. Moreover, the device cost tends to increase.

In contrast, in a case of complete decomposition of water with a photocatalyst, a loss of in energy conversion is only once, and collection of light energy and water decomposition can be carried out simultaneously. Therefore, such a process is preferable. As a photocatalyst unit that decomposes water by a photocatalyst, it is possible to use any of various kinds of known ones. In the decomposition of water with a photocatalyst, it is preferable to generate hydrogen while utilizing sunlight, from the viewpoint of effective use of energy.

The photocatalyst unit is provided with a means for supplying water that is a raw material. The photocatalyst unit is, if necessary, further provided with a gas-liquid separation means for taking out a mixed gas of oxygen and hydrogen generated. The hydrogen-oxygen mixed gas thus obtained is supplied to a separation means for separating hydrogen and oxygen. The flame extinction device in accordance with the present invention can be provided at any location in the photocatalyst unit. It is inefficient to provide each of the photocatalyst units with a means for separating the hydrogen-oxygen mixed gas at this time. Therefore, oxygen-hydrogen mixed gases from the respective photocatalyst units are gathered to a certain extent and then collected, via flame extinction devices that are provided at appropriate intervals, at a location of the separation means for separating hydrogen and oxygen.

As the separation means for separating hydrogen and oxygen, it is possible to use various kinds of known methods, and is not particularly limited. It is preferable to use a separator membrane including a zeolite membrane, a silica membrane, or the like from the viewpoints of characteristics thereof and being an inorganic membrane. In particular, from the viewpoint of explosion resistance, it is important to employ an inorganic membrane. The separator membrane is used for separation into an oxygen-rich gas and a hydrogen-rich gas, and those gases may be used as they are. Alternatively, it is possible to increase purity of each of the gases with a method such as dehumidification, cooling, and quenching of a residual gas. Such a structure serves as the hydrogen production device in accordance with the present invention, or, if directed at oxygen, a production device for producing oxygen. The flame extinction device in accordance with the present invention can be provided in any location upstream or downstream the separator membrane. Even if a gas which is outside the explosive range passes through in a normal state, there is a possibility that a gas in the explosive range passes through in a case where the gas separation does not function sufficiently. Therefore, it is preferable to provide the present flame extinction device as a preventive measure in such a location. As such, the flame extinction device in accordance with an embodiment of the present invention is suitable for an application in which the flame extinction device is disposed in conjunction with the generation section for generating a hydrogen-containing gas in the hydrogen production device.

### [Main Points of Embodiment of First Gist of Present Invention]

As is clear from the above descriptions, various aspects in the first gist of the present invention indicated below are included in the gist described in paragraphs <0039> through <0060>. That is, a first aspect in the first gist of the present invention is a flame extinction device (1), including: a connective piping section (20) which is connected to a first pipe (10), a second pipe (22), and a third pipe (21), a raw gas being supplied to the first pipe and the second pipe; a flame propagation suppression section (3) that has a porous portion through which the raw gas passes, the flame propagation suppression section being provided on the first pipe side and/or the second pipe side when seen from the connective piping section; and a pressure reduction section (2) that is disposed at an end part of the third pipe, the pressure reduction section reducing an internal pressure of the third pipe in a case where the internal pressure has risen, the third pipe being not orthogonal to any of the first pipe and the second pipe.

A second aspect in the first gist of the present invention is a flame extinction device, including: a connective piping section which is connected to a first pipe, a second pipe, and a third pipe, a raw gas passing through the first pipe and the second pipe; a flame propagation suppression section that has a porous portion through which the raw gas passes, the flame propagation suppression section being provided on the first pipe side and/or the second pipe side when seen from the connective piping section; and a pressure reduction section (rupture disk 223) that is disposed at an end part of the third pipe, the pressure reduction section reducing an internal pressure of the third pipe by generating, at the end part, a reflected wave which interferes with an incident wave of a shock wave, the third pipe being not orthogonal to any of the first pipe and the second pipe.

The first aspect and the second aspect above can both provide a flame extinction device which is excellent in flame propagation suppressive effect. The second aspect can provide a flame extinction device which is further excellent in shock wave propagation suppressive effect.

In a third aspect of the first gist of the present invention, in the first aspect or second aspect: the flame propagation suppression section further includes a narrowed portion through which the raw gas passes. The third aspect is further effective from the viewpoint of suppressing flame propagation in detonation and from the viewpoint of suppressing generation of a pressure loss in a normal state.

In a fourth aspect of the first gist of the present invention, in the third aspect: a diameter of the narrowed portion is 0.3 mm or more and 4.5 mm or less. The fourth aspect is furthermore effective from the viewpoint of suppressing flame propagation in detonation and from the viewpoint of suppressing generation of a pressure loss in a normal state.

In a fifth aspect of the first gist of the present invention, in any of the first aspect through the fourth aspect: the flame propagation suppression section further includes a bent portion through which the raw gas passes. The fifth aspect is further effective from the viewpoint of suppressing flame propagation in detonation and from the viewpoint of suppressing generation of a pressure loss in a normal state.

In a sixth aspect of the first gist of the present invention, in any of the first aspect through the fifth aspect: a pipe of the connective piping section has a substantially circular cross section. The sixth aspect is furthermore effective from the viewpoint of enhancing pressure resistance.

In a seventh aspect of the first gist of the present invention, in any of the first aspect through the sixth aspect: a pressure resistance P(tube) (MPa(G)) of the connective piping section satisfies a formula below. The seventh aspect is furthermore effective from the viewpoint of achieving both improvement in pressure resistance and cost reduction.

2≤P(tube)≤30

In an eighth aspect of the first gist of the present invention, in any of the first aspect through the seventh aspect: the pressure reduction section includes a reversible pressure release device (safety valve 200); and a lowest release pressure P(release) (MPa(G)) of the reversible pressure release device satisfies a formula below. The eighth aspect is furthermore effective from the viewpoint of achieving both prevention of external leakage of the raw gas and prevention of breakage of the device.

0.1≤P(release)≤0.98

In a ninth aspect of the first gist of the present invention, in any of the first aspect through the seventh aspect: the pressure reduction section includes a rupture disk unit that blocks the third pipe; and a burst pressure P(burst) (MPa(G)) of a rupture disk (213) included in the rupture disk unit satisfies a formula below. The ninth aspect is furthermore effective from the viewpoint of achieving prevention of breakage of the device due to release in the system or interference of a shock wave.

0.25≤P(burst)≤12

In a 10th aspect of the first gist of the present invention, in the ninth aspect: the rupture disk is disposed to have a planar shape or a convex shape with respect to the third pipe. The 10th aspect is furthermore effective from the viewpoint of preventing breakage of the device due to interference of a shock wave.

An 11th aspect of the first gist of the present invention, in any of the first aspect through the 10th aspect, further includes: a shock absorption section (41) that surrounds the pressure reduction section. The 11th aspect is furthermore effective from the viewpoint of preventing diffusion of the raw gas when the inside of the system is released.

In a 12th aspect of the first gist of the present invention, in any of the first aspect through the 11th aspect: the flame propagation suppression section further includes a housing (4) which is provided in the first pipe and/or the second pipe and through which the raw gas passes; and the porous portion is provided inside the housing. The 12th aspect is further effective from the viewpoint of enhancing pressure resistance of the flame propagation suppression section. In the 12th aspect, the housing may further include one of or both of a narrowed portion and a bent portion therein. This aspect is furthermore effective from the viewpoint of enhancing pressure resistance of the flame propagation suppression section.

In a 13th aspect of the first gist of the present invention, in the 12th aspect, the housing is made of metal. The 13th aspect is furthermore effective from the viewpoint of enhancing pressure resistance and heat transfer property of the flame propagation suppression section.

In a 14th aspect of the first gist of the present invention, in any of the first aspect through the 13th aspect: the porous portion is a substantially cylindrical porous body. The 14th aspect is furthermore effective from the viewpoint of enhancing pressure resistance in occurrence of detonation.

In a 15th aspect of the first gist of the present invention, in any of the first aspect through the 14th aspect: a porous body constituting the porous portion contains metal and/or ceramic. The 15th aspect is furthermore effective from the viewpoint of enhancing heat resistance, heat transfer property, and/or chemical stability of the porous portion.

In a 16th aspect of the first gist of the present invention, in any of the first aspect through the 15th aspect: a porous body constituting the porous portion has gaps each having a width of 0.50 μm or more and 2.45 μm or less in a longitudinal direction. The 16th aspect is furthermore effective from the viewpoint of achieving both gas permeability for the raw gas and flame propagation suppression in detonation.

In a 17th aspect of the first gist of the present invention, in any of the first aspect through the 16th aspect: a porous body constituting the porous portion has gaps each having a width of 50 μm or more and 100 μm or less in a longitudinal direction. The 17th aspect is furthermore effective from the viewpoint of suppressing a pressure loss in permeation of the raw gas.

In an 18th aspect of the first gist of the present invention, in any of the first aspect through the 17th aspect: the raw gas is a mixed gas containing hydrogen and oxygen. As indicated in the 18th aspect, the flame extinction device in accordance with an aspect of the present invention is suitable for use in a device that deals with a raw gas whose explosion power is large.

In a 19th aspect of the first gist of the present invention, in the 18th aspect: the mixed gas further contains water vapor. The 19th aspect is furthermore effective from the viewpoint of reducing detonation power of the mixed gas.

In a 20th aspect of the first gist of the present invention, in any of the first aspect through the 19th aspect: the raw gas has a pressure higher than an atmospheric pressure. The 20th aspect is furthermore effective from the viewpoint of causing the raw gas to pass through in the system.

A 21st aspect of the first gist of the present invention is a hydrogen production device (photochemical reaction plant 100) including: a generation section that generates a hydrogen-containing gas; and a flame extinction device that communicates with the generation section, the flame extinction device being the flame extinction device described in any one of the first aspect through the 20th aspect. According to the 21st aspect, it is possible to provide a hydrogen production device including a flame extinction device which is excellent in flame propagation suppressive effect and in shock wave propagation suppressive effect.

In a 22nd aspect of the first gist of the present invention, in the 21st aspect: the generation section generates hydrogen while utilizing sunlight. The 22nd aspect is furthermore effective from the viewpoint of effective use of energy in generation of a raw gas.

The first gist of the present invention is not limited to the embodiments described above, but may be altered in various ways by a skilled person within the scope of the claims. Any embodiment derived from a proper combination of technical means disclosed in different embodiments is also encompassed in the technical scope of the first gist of the present invention.

### [Embodiment of Second Gist of Present Invention]

### Definition

For the second gist of the present invention, the expressions “passage of a gas”, “a gas passes through”, “in a normal state”, “detonation” or “occurrence of detonation”, “hydrogen detonating gas”, and “in the system” or “outside the system” may be used in this specification. Descriptions here of these expressions are identical with those described in paragraphs <0114> through <0119> in “Embodiment of first gist of present invention” described above.

### [Overview]

The flame extinction device in accordance with the present invention is a flame extinction device suitable for a device such as an artificial photosynthesis device using sunlight in which an emergency stop of the device itself is difficult because an explosive gas continues to be generated even in a case where an abnormality has occurred in a part of the equipment.

The flame extinction device in accordance with the present invention can be used in any mechanical equipment, chemical equipment, and the like which involve concern about occurrence of explosion or detonation. The flame extinction device in accordance with the present invention is applicable to any combustible gases and a mixed gas containing a combustible gas and a combustion-supporting gas. The flame extinction device in accordance with the present invention can be suitably used in chemical equipment in which a hydrogen detonating gas in which hydrogen and oxygen coexist, which have particularly large explosion power, is generated, passes through, is temporarily retained, and is stored. The flame extinction device in accordance with the present invention can be suitably used further for “equipment in which hydrogen and oxygen are generated by electrolysis and pass therethrough”, “equipment in which hydrogen and oxygen are generated using a photocatalyst and pass therethrough”, or the like for generating hydrogen and oxygen by decomposing water. In such a case, the hydrogen-oxygen mixed gas which is generated and passes through may have a stoichiometric composition (hydrogen:oxygen=2:1). Here, there is concern that equipment is broken or alternatively secondary damage that occurs after operation of the flame extinction device in detonation is enormously caused due to deflagration caused by ignition of the mixed gas or a shock wave or detonation flame that is generated in a case where the deflagration has subsequently transitioned to detonation. However, according to the studies by the inventors of the present invention, even in a case where a hydrogen-oxygen mixed gas having a stoichiometric composition is ignited, the flame extinction device in accordance with the present invention can effectively suppress influence of a shock wave or detonation flame and prevent subsequent leakage of the flammable gas to the outside. Therefore, it is possible to suppress occurrence of secondary damage.

In view of this, in a case where hydrogen and oxygen are generated by water decomposition with a photocatalyst, it is possible to appropriately dispose the present flame extinction device at various locations, such as around a photocatalytic reactor and around a hydrogen-oxygen separator membrane which is disposed downstream of the photocatalytic reactor.

A flame extinction device in accordance with an embodiment of the present invention is disposed between (i) a first pipe via which a raw gas is supplied to the flame extinction device section from one end side and (ii) a second pipe, the flame extinction device having constituent elements (1) through (4) below:
(1) a connective piping section that allows a raw gas to flow from the first pipe to the second pipe and that simultaneously has a branch to a third pipe;
(2) a flame propagation suppression section that is provided between the connective piping section and the first pipe and/or the second pipe and that has a housing, as well as a bent portion and a narrowed portion in a flow path in the housing;
(3) a pressure reduction section that is disposed via the third pipe; and
(4) a shock absorption section that surrounds and/or makes contact with the pressure reduction section.

### [Basic Configuration and Effect]

Here, with respect to a flow direction of the gas in a normal state, an upstream direction and a downstream direction thereof are defined. In this case, in a case where ignition occurs on the first pipe side, a shock wave propagation mitigation effect and a flame propagation suppressive effect to the second pipe side are expected by the flame extinction device of the present invention. The flame extinction device of the present invention may be configured to bring about, in addition to the above effects, a shock wave mitigation effect and a flame propagation suppressive effect to the first pipe side, even in a case where ignition occurs on the second pipe side.

In particular, at the same time, in a case where the shock wave propagation mitigation effect is achieved by pressure release in the pressure reduction section, the flame extinction device in accordance with the present invention releases pressure to the shock absorption section in the system rather than outside the system. Therefore, there is no leakage of combustible gas or the like to the outside of the system, and such a state is very preferable.

First, description will the following discuss in detail a basic configuration of the present flame extinction device and behaviors thereof, while using an aspect illustrated in FIG. 30. FIG. 30 illustrates an example of the basic configuration of the present flame extinction device. In a case of ignition at the first pipe 10 side to which a raw gas is supplied, a shock wave propagation mitigation effect and a flame propagation suppressive effect to the second pipe 22 side are expected. In particular, at the same time, in a case where the shock wave propagation mitigation effect is achieved by pressure release in a pressure reduction section 2, the flame extinction device in accordance with the present invention releases pressure to a shock absorption section 9 in the system rather than outside the system. Therefore, there is no leakage of a gas such as a combustible gas or a gas which has undergone chemical combination, decomposition, or the like as a result of chemical reaction to the outside of the system, and such a state is very preferable.

Here, it is assumed that the present flame extinction device is provided in a so-called “artificial photosynthesis plant”, which is equipment in which hydrogen and oxygen are generated using a photocatalyst and pass therethrough. Moreover, it is assumed that ignition occurs at the first pipe 10 side to which a raw gas is supplied. The following description will discuss operations of the present flame extinction device in such a case. In a case of ignition on the first pipe 10 side, a shock wave and flame after transition to detonation propagate to the connective piping section 20 that has a branch to a third pipe 21, depending on a distance of the pipe or a pipe diameter. After that, although the shock wave or detonation flame has the characteristic of being comparatively easy to propagate straight, the shock wave or detonation flame propagates in any direction, and therefore easily reaches the pressure reduction section 2 through the third pipe 21. In order to suppress propagation of a shock wave or detonation flame, from experimental and theoretical studies, the inventors of the present invention have found that reducing pressure thereof is an important requirement. In view of this, if the pressure is released at the pressure reduction section or a shock wave is comparatively weak, flame is attenuated by a reflected wave from the pressure reduction section 2. Then, the flame propagation section suppression 3 prevents propagation of flame to the second pipe 22 side.

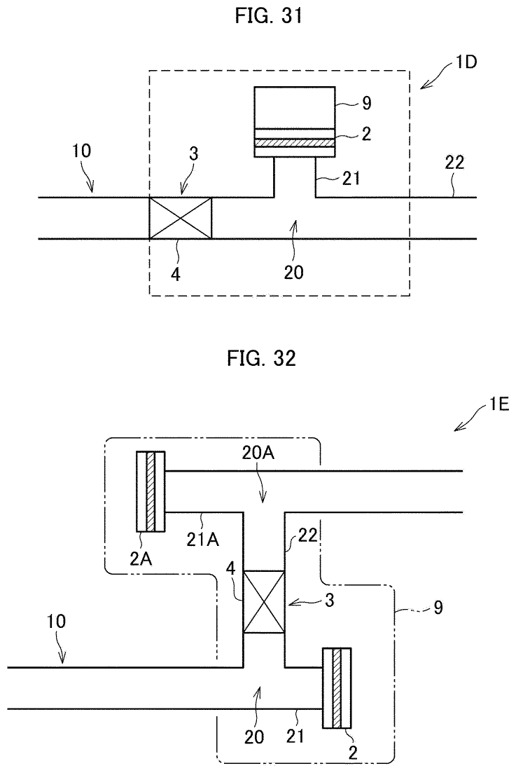

Similarly, as illustrated in FIG. 31, in a case where the flame propagation suppression section 3 is provided on the first pipe 10 side, the flame force is suppressed when the flame passes through the flame propagation suppression section 3. The flame further passes through the connective piping section 20 to reach the pressure reduction section 2. Then, the pressure is released to stop flame propagation or, similarly to the case illustrated in FIG. 30, the flame propagation is stopped by a reflected wave.

The flame extinction device in accordance with the present invention includes the shock absorption section 9 in a form of surrounding or making contact with the pressure reduction section 2. The form of surrounding means that the shock absorption section 9 does not make direct contact with the pressure reduction section 2, but covers an entire part where the gas or the like is released in an operation in which the pressure reduction section is released. The form of making contact literally means that the shock absorption section 9 is present in contact with a part where the gas or the like is released when a pressure of the pressure reduction section has been released. In a case where the pressure reduction section 2 brings about an effect thereof by, in particular, releasing a pressure to the outside, a combustible gas or a gas which has undergone chemical combination, decomposition, or the like as a result of chemical reaction, or the like in the system may be released to the atmosphere. This leads to a possibility to induce further damage in reaction with oxygen or the like in the air. Therefore, a configuration is employed in which a pressure released from the pressure reduction section 2 does not leak from the shock absorption section that has a sufficient volume, pressure resistance, and explosion resistance, and pressure is processed in the system.

It has also been found experimentally that the pressure reduction section 2 alone is not sufficient to suppress a shock wave or detonation flame which can be generated by detonation of, in particular, a hydrogen detonating gas (hydrogen-oxygen mixed gas) and can propagate in any direction. In particular, for suppression of flame propagation, a special flame propagation suppression section is essential. The flame propagation suppression section 3 is joined to the pressure reduction section via the connective piping section that has several branches. By thus disposing the pressure reduction section 2 and the flame propagation suppression section 3 in combination in the system, it is possible to effectively exert a flame propagation suppressive effect by the flame propagation suppression section 3 while reducing detonation pressure, and thus prevent propagation of a shock wave and flame to the second pipe 22 due to detonation.

The following description will discuss an embodiment with reference to FIG. 1 as an application example of the flame extinction device in accordance with the present invention. FIG. 1 is a diagram schematically illustrating a configuration of a photochemical reaction plant 100 in accordance with the present embodiment. The descriptions of the photochemical reaction plant 100 here are identical with those described in paragraphs <0127> through <0133> in “Embodiment of first gist of present invention”.

Next, the following description will discuss other aspects in addition to the foregoing basic configuration.

<Structure that Prevents Raw Gas from Flowing Straight in Connective Piping Section>

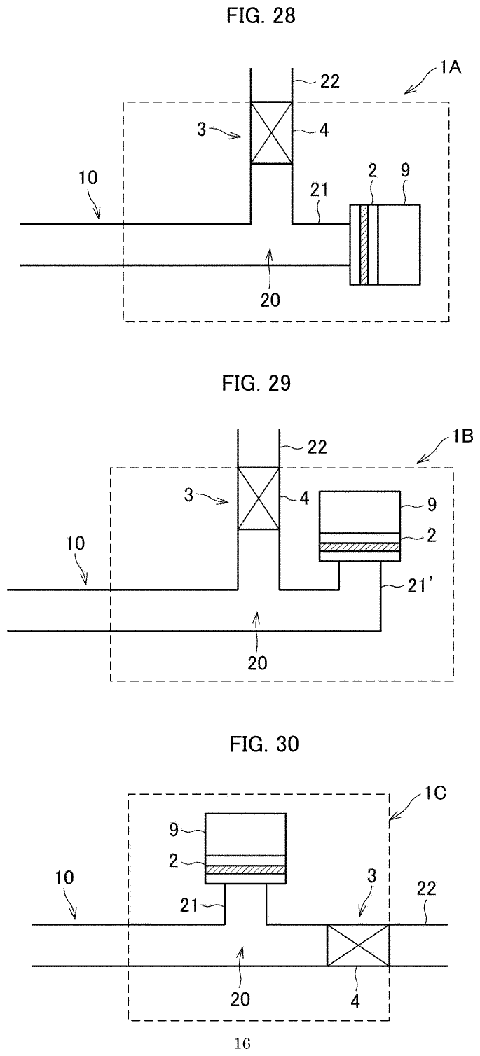

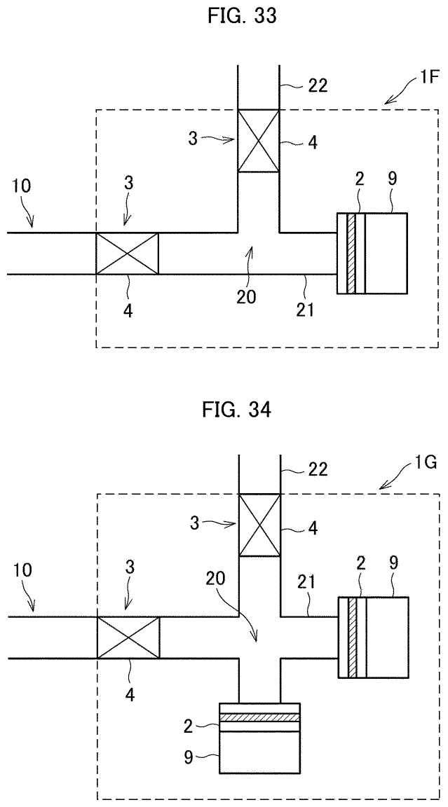

The following description will discuss, with reference to FIGS. 27 and 28, a structure in which the raw gas does not flow straight in a normal state. In this configuration, the connective piping section 20 which connects the pressure reduction section 2 to the flame propagation suppression section 3 has a structure in which a flow path through which the raw gas passes is not straight. In other words, a structure is employed in which the raw gas which is supplied from the left side in the drawing in a normal state flows to the upper side in the drawing. In this case, the connective piping section 20 has a T-shape branch structure. This configuration is preferable because propagation of a shock wave or detonation flame which is comparatively rich in property to propagate straight is easily suppressed. FIG. 29 illustrates a further application aspect of this aspect. As a development form from the aspects illustrated in FIG. 27 through FIG. 29, it is possible to employ a structure in which the basic configuration of the present invention is duplicated while omitting common parts. In a configuration as illustrated in FIG. 33 in which the passage path of the raw gas in a normal state is not straight in the connective piping section 20, flame propagation suppression sections (3 and 3) are provided on both the first pipe side and the second pipe side. With this configuration, in a case of ignition on any of the first pipe 10 side and the second pipe 22 side, it is possible to achieve flame propagation suppression by the flame propagation suppression sections (3 and 3) temporally earlier than pressure reduction by the pressure reduction section 2. This configuration is preferable because the pressure reduction section 2 may be constituted in a comparatively simple method. For example, it is possible to provide a pressure reduction effect by the pressure reduction section 2 with a simple safety valve or the like.

The following description will discuss an application configuration with reference to FIG. 32. In this configuration, two pressure reduction sections are prepared, and pressure reduction by the pressure reduction section (2 and 2A) is carried out first with respect to flame coming from either side. In a case where a configuration is employed in which a timing of flame arrival at the flame propagation suppression section is temporally later than pressure reduction by the pressure reduction section, the flame propagation suppression section may be constituted in a comparatively simple method. Therefore, such a configuration is preferable. For example, it is possible to omit a porous portion that can be preferably provided in the flame propagation suppression section. FIG. 32 illustrates an aspect in which a plurality of pressure reduction sections are further surrounded by a single shock absorption section 9. In this aspect, the shock absorption section is easy to have a large volume. Therefore, this configuration is preferable because it is possible to comparatively easily mitigate influence of a pressure released by the pressure reduction section 2, and this configuration makes it easy to design pressure resistance, explosion resistance, and the like of the shock absorption section.

The configuration illustrated in FIG. 34 is a shape obtained by combining two basic configurations of the flame extinction device in accordance with the present invention. In this configuration, in a case of ignition on any of the first pipe 10 side and the second pipe 22 side, a high shock wave propagation suppressive effect and a high flame propagation suppressive effect are expected. FIG. 34 illustrates an example aspect in which all of the pressure reduction sections are respectively surrounded by separate shock absorption sections.

The following description will further discuss components in the foregoing basic configuration. The descriptions of the flame propagation suppression section here are identical with those described in paragraphs <0180> through <0202> in “Embodiment of first gist of present invention” described above.

Next, the following description will further discuss the pressure reduction section included in the foregoing basic structure, with reference to the drawings. The pressure reduction section in accordance with an aspect of the present invention is disposed at the end part of the third pipe, and is configured to reduce an internal pressure of the third pipe in a case where the internal pressure has risen. The following description will further discuss the pressure reduction section with reference to the drawings.

FIG. 20 illustrates an example of the pressure reduction section, which is a reversible pressure release device. Descriptions of the pressure reduction section here are identical with those described in paragraphs <0210> and <0211> in “Embodiment of first gist of present invention” described above.

FIG. 21 and FIG. 22 illustrate an example of the pressure reduction section, which is a rupture disk unit. Descriptions of the pressure reduction section here are identical with those described in paragraphs <0219> through <0224> in “Embodiment of first gist of present invention” described above.

The following description will discuss in detail configurations of the components of the present invention.

### <Shock Absorption Section>

The shock absorption section in the flame extinction device of the present invention has sufficient volume, pressure resistance, and explosion resistance to bring about functions of, in a case where a pressure is released from the pressure reduction section, mitigating the pressure change and processing the pressure change in the system. Descriptions of the shock absorption section here are substantially identical with those described in paragraphs <0228> through <0231> in “Embodiment of first gist of present invention” described above.

In general, in a case where the pressure reduction section brings about an effect thereof by releasing a pressure to the outside of the system, a combustible gas in the system may be released to the atmosphere. This leads to a possibility to induce further damage in reaction with oxygen or the like in the air. Therefore, in the present invention, a pressure released from the pressure reduction section is mitigated with the shock absorption section having a sufficient volume, pressure resistance, and explosion resistance, and the pressure is processed in the system.

In such a viewpoint, a pressure of the shock absorption section in a normal state is preferably substantially an atmospheric pressure. In the shock absorption section, it is preferable to cause a dilution gas to pass through at all times so that a gas (or, in some cases, a liquid or powder reactant, or the like) released from the pressure reduction section is not scattered to the periphery but is diluted. In this viewpoint, for example, in a case where an artificial photosynthesis plant includes pressure reduction sections at a plurality of locations, shock absorption sections that cover the pressure reduction sections at the respective locations may each preferably function alone, or it is preferable to connect the shock absorption sections to each other and cause a dilution gas to pass through the shock absorption sections. A dilution gas which is caused to pass through the shock absorption section can be selected arbitrarily from single gases and a mixed gas thereof, provided that the gas is chemically stable and does not easily react with other elements or compounds. For example, it is possible to select helium, neon, argon, krypton, xenon, or radon, which are rare gases, or nitrogen, which is usually poor in reactivity. Among those, a mixed gas containing nitrogen or a nitrogen gas is preferable. In a case of large-scale dilution, it is preferable to intentionally cause the atmospheric air to pass through. It is possible to provide flame extinction performance by causing a carbon dioxide gas to pass through.

The following description will further discuss the shock absorption section with reference to the drawings. FIG. 24 is a cross-sectional view schematically illustrating a configuration of an example of the shock absorption section in accordance with an embodiment of the present invention. FIG. 25 is a right side view schematically illustrating a side of the shock absorption section illustrated in FIG. 24. Descriptions of the shock absorption section here are identical with those described in paragraphs <0232> through <0234> in “Embodiment of first gist of present invention” described above.

### <Connective Piping Section>

The connective piping section in accordance with the present invention is a portion that allows a raw gas to flow from the first pipe to the second pipe and that simultaneously has a branch to the third pipe. As such, the connective piping section is connected to the first pipe and the second pipe through which a raw gas passes and is connected also to the third pipe. In the present invention, it is only necessary to include a branch toward the second pipe and a branch toward the third pipe for being directed to the shock absorption section. More preferably, a flow of the gas from the first pipe and a flow of the gas to the second pipe are not linearly connected to each other in the connective piping section. That is, the first pipe is extended in the gas flow direction in a normal state and the second pipe is extended in a direction opposite to the gas flow direction in a normal state, and a smaller value of angles formed by these two straight lines is important. The angle is preferably 30 degrees or more, preferably 60 degrees or more, particularly preferably 75 degrees or more, most preferably 90 degrees (i.e., orthogonal). If the angle is 90 degrees or more, the angle is shallow when seen from flame in the opposite direction. Therefore, the angle is most preferably 90 degrees.

What is necessary for bringing about the effect of the present invention is to hinder, at the connective piping section, propagation of detonation flame that is comparatively rich in property to propagate straight. Descriptions of bending of the pipe, the cross-sectional shape, and the pressure resistance here are substantially identical with those described in paragraphs <0153> through <0161> in “Embodiment of first gist of present invention” described above.

### <Flame Propagation Suppression Section>

The flame propagation suppression section in the flame extinction device in accordance with the present invention may include, on the first pipe side and/or the second pipe side when seen from the connective piping section, a porous portion through which the raw gas passes, and further include one of or both of a narrowed portion and a bent portion.

### (Housing of Flame Propagation Suppression Section)

In the flame propagation suppression section inside the flame extinction device in accordance with the present invention, it is possible to select, as a material of the housing including the narrowed flow path and the like, as appropriate from a metallic material, a resin material, a composite material of these, and the like. In addition, the material is preferably selected so that sufficient pressure resistance and explosion resistance can be achieved, and sufficient thermal conductivity can be ensured.

A pressure resistance of the flame propagation suppression section is preferably 0.5 MPa(G) or more, more preferably 1 MPa(G) or more, further preferably 2 MPa(G) or more, most preferably 4 MPa(G) or more. Note, however, that, if the pressure resistance and explosion resistance are excessively enhanced, the thickness of the housing excessively increases. This causes problems that the weight of the housing is excessively large and the cost is excessively high. Therefore, an upper limit thereof is preferably 25 MPa(G) or less, more preferably 20 Pa (G) or less, further preferably 15 MPa(G) or less, most preferably 10 MPa(G) or less.

A material of the flame propagation suppression section is preferably a material that can achieve both pressure resistance and thermal conductivity, and is preferably a metallic material or a composite material containing a metallic material. More preferably, the housing contains a metallic material. The material is further preferably an iron-based material or a stainless steel material. As such, the housing is preferably made of metal. It is possible to use different materials in accordance with locations of the housing.

A shape of the housing is preferably a cylindrical shape. With such a shape, it is possible to improve the pressure resistance and explosion resistance, as with the other pipes.

### (Bent Portion)

The bent portion in the housing largely changes a propagation direction of flame. The bent portion may be bent in a U-shape or an L-shape, or may have a branch in a T-shape or a cross-shape. Descriptions of the bent portion here are substantially identical with those described in paragraph <0166> in “Embodiment of first gist of present invention” described above.

### (Narrowed Portion)

First, a cross-sectional area of the narrowed portion in the housing of the flame propagation suppression section in accordance with the present invention is preferably smaller, as compared with each of a cross-sectional area of the first pipe, a cross-sectional area of the second pipe, and a cross-sectional area of the connective piping section. Descriptions of the cross-sectional 1 area, width, and shape of the narrowed portion here are substantially identical with those described in paragraphs <0167> through <0170> in “Embodiment of first gist of present invention” described above.

The narrowed portion may be formed by being filled with a substance which is metal, ceramic, or a composite material thereof in the form of particles. The narrowed portion thus formed includes a nonlinear part. Examples of the metal include Fe, Ni, Ti, Cr, Mo, Si, Al, Mg, and the like. Alternatively, the metal may be an alloy containing an element selected from those elements. Examples of the ceramic material include Al₂O₃-based materials, SiO₂-based materials, SiC-based materials, Zro₂-based materials, and the like. Alternatively, it is possible to employ a compound or a mixture of those materials. Alternatively, it is possible to employ mullite, zircon, or the like. Among those, in view of high thermal conductivity and stability, it is preferable to employ a ceramic material in a case where filling particles are used to form a flow path in the housing. Furthermore, among those, in view of a comparatively high melting point and stability against contact with detonation flame, one selected from alumina, mullite, zirconia, and zircon is preferable, one selected from mullite and zircon is more preferable, and zircon is further preferable. In filling, it is realistic and preferable to carry out filling at a filling factor equivalent to random filling. A grain shape in filling is preferably close to a spherical shape. According to the studies by the inventors of the present invention, it is preferable to employ fine particles in order to improve a flame propagation suppressive effect, and a particle diameter thereof is preferably 1000 μm or less, more preferably 500 μm or less, further preferably 250 μm or less, and most preferably 200 μm or less. Meanwhile, excessively fine particles excessively increase a pressure loss in a normal state. Therefore, the particle diameter is preferably 25 μm or more, more preferably 50 μm or more, further preferably 100 μm or more, most preferably 150 μm or more. According to the studies by the inventors of the present invention, in regard to a length of the filled part, there is a trade-off between the flame propagation suppression and the pressure loss. From the viewpoint of flame propagation suppression, the length is preferably 10 mm or more, more preferably 20 mm or more, further preferably 40 mm or more, most preferably 80 mm or more. Meanwhile, from the viewpoint of reduction of pressure loss, the length is preferably 200 mm or less, more preferably 175 mm or less, further preferably 150 mm or less, most preferably 125 mm or less.

In a case where a flow path is bent and is narrowed in width thereof, the effects of both the bent portion and the narrowed portion of the flow path in the housing of the flame propagation suppression section can be brought about by the single flow path.

### (Porous Portion of Flame Propagation Suppression Section)

In the flame propagation suppression section, it is preferable to further provide a porous portion which is constituted by a porous body that can allow a gas which passes through the narrowed flow path in the housing to pass therethrough and that has a gap. Descriptions of the porous portion here are substantially identical with those described in paragraphs <0171> through <0178> in “Embodiment of first gist of present invention” described above.

### <Shape of Pipe in Flame Extinction Device>

A cross section of the pipe in the flame extinction device is preferably substantially oval or substantially circular, more preferably substantially circular, and most preferably circular. Descriptions of the pipe in the flame extinction device here are substantially identical with those described in paragraphs <0155> through <0158> in “Embodiment of first gist of present invention” described above.

### <Arrangement of Pressure Reduction Section And Shape of Connective Piping>

Flame or a shock wave caused due to deflagration or detonation propagates in any direction while being rich in property to propagate straight. Therefore, in a case where it is intended to most effectively reduce influence of flame or a shock wave propagating from the first pipe side, the pressure reduction section is preferably disposed to confront an extension line of the first pipe in a flowing direction of the raw gas in a normal state. Most preferably, the pressure reduction section is disposed to confront this from the front. In a case of such an arrangement and while taking into consideration an arrangement of the second pipe as described above, the connective piping section is most preferably configured to have a T-shape.

The pressure reduction section may effectively function even when the pressure reduction section is disposed at an end part of the third pipe which is orthogonal to the extension line of the first pipe in the flowing direction of the raw gas in a normal state. In particular, in a case where an initial pressure of the raw gas in a normal state is relatively low or the like, it is preferable to employ such a configuration in view of easiness in arrangement.

Among two angles formed by (i) the third pipe to which the pressure reduction section is provided at the end part and (ii) an extension line of the first pipe in the flowing direction of the raw gas in a normal state, an angle of a smaller value can take an arbitrary value. In a case where an initial pressure of the raw gas is comparatively high, e.g., exceeds 0.1 MPa(G), the angle may be 90°. The angle is preferably 75° or less, more preferably 50° or less, further preferably 30° or less, still further preferably 15° or less, most preferably 0°. That is, in this case, the pressure reduction section confronts, from the front, the extension line of the first pipe in the flowing direction of the raw gas in a normal state. Meanwhile, in a case of 0.1 MPa(G) or less, the angle is preferably 30° or more, more preferably 50° or more, more preferably 75° or more, most preferably 80° or more. This is, as described above, to achieve easiness in arrangement, installation, and the like.

### <Pressure Reduction Section>

In a case where the pressure reduction section has a function of reducing a shock wave pressure propagating through the pipe, direct and indirect pressure changes associated with occurrence of deflagration or detonation, pressure change due to unexpected excessive chemical reaction, and the like, a form of the pressure reduction section may be selected in various ways.

One form of the pressure reduction section is a case of utilizing a so-called safety valve. In this case, if an internal pressure in the pipe is equal to or greater than a specific value, the pressure is released to the shock absorption section. As a result, the pressure in the pipe is reduced, and thus the state is reversibly returned to a closed state. Therefore, such a configuration may be limitedly used in a case in which pressure change or the like is assumed to be small. A lowest release pressure P(release) (MPa(G)) at which a pressure is released to the shock absorption section from the safety valve is preferably 0.1 MPa(G) or more, more preferably 0.2 MPa(G) or more, further preferably 0.3 MPa(G) or more, most preferably 0.4 MPa(G) or more. This is because, if a combustible gas or the like which passes through the system is inadvertently released to the shock absorption section in excessively small pressure change, it is possible that disturbance would be caused to the passage process which is actually safe. Meanwhile, in a case of using such a simple method, an excessively high lowest pressure released should be avoided from the viewpoint of ensuring safety. Therefore, an upper limit of the lowest release pressure is preferably 0.98 MPa(G) or less, more preferably 0.9 MPa(G) or less, further preferably 0.8 MPa(G) or less, most preferably 0.7 MPa(G) or less.

One of other aspects of the pressure reduction section is a so-called rupture disk unit. The rupture disk unit can expect at least the following three effects.

A first effect brought about by using the rupture disk unit is that rupture of the rupture disk irreversibly releases a pressure in the system to the shock absorption section. In this case, unlike the case of the safety valve, when a rupture disk provided in the rupture disk unit once ruptures and releases an excessive pressure to the shock absorption section, the part where the rupture disk has been provided is not closed. Therefore, it is possible to effectively and reliably reduce the pressure in the system. In a case where it is assumed that a shock wave pressure, direct and indirect pressure changes associated with occurrence of deflagration or detonation, and pressure change due to unexpected excessive chemical reaction are large, such a configuration is particularly suitable. According to the studies by the inventors of the present invention, in particular, in a case where pressure release by rupture of the rupture disk is assumed in the flame extinction device in accordance with the present invention, various forms can be selected from: a form in which a planer rupture disk confronts; a form in which a concave rupture disk confronts; a form in which a convex rupture disk confronts; a form in which those shapes are combined in the plane; and the like. All of the shapes are preferable. According to the studies by the inventors of the present invention, it has been experimentally confirmed that, with respect to the incident side where pressure change or the like occurs, the shape is more preferably a vertically planar surface, a concave surface, or a convex surface, further preferably a vertically planar surface or a concave surface, most preferably a concave surface. The mechanism in this case is not clear. However, in a case where pressure release is achieved by rupture of the rupture disk, it is inferred that, with respect to the direction in which the pressure change propagates, the rupture disk surface is more likely to receive a shock wave or a wave of the pressure change.

A second effect brought about by using the rupture disk unit is that a shock wave or associated direct and indirect pressure changes at the rupture disk can be suppressed by a shape of the rupture disk. This effect continues in terms of time unless the rupture disk ruptures. The rupture disk unit is constituted by a housing section that holds a rupture disk and the rupture disk that has a burst pressure (P(burst) (MPa(G)) designed based on quality of material, thickness, size, or shape of the rupture disk. In this configuration, particularly in regard to the shape of the rupture disk, various forms can be selected from: a form in which a planer rupture disk confronts a direction in which a shock wave or pressure change propagates; a form in which a concave rupture disk confronts that direction; a form in which a convex rupture disk confronts that direction; a form in which those shapes are combined in the plane; and the like. According to the studies by the inventors of the present invention, any one of the shapes is preferable in the flame extinction device of the present invention. It has been experimentally confirmed that the shape is more preferably a vertically planar surface, a concave surface, or a convex surface, further preferably a vertically planar surface or a convex surface, most preferably a convex surface. The mechanism in this case is not clear. However, in a case where the rupture disk does not rupture and a pressure is not released to the shock absorption section, with respect to the direction in which the pressure change propagates, reflection of a shock wave or a wave of the pressure change occurs on the rupture disk surface. It is inferred that the reflection interferes with an incident wave, and brings about an effect of reducing the pressure.

A third effect brought about by using the rupture disk unit is a synergistic effect of the second effect and the first effect described above. That is, until the rupture disk ruptures, the pressure in the system is reduced by the second effect described above. Nevertheless, in a case where the pressure in the system does not decrease, the rupture disk ruptures to reliably release the pressure in the system to the shock absorption section. Descriptions of the burst pressure of the rupture disk here are substantially identical with those described in paragraphs <0216> and <0217> in “Embodiment of first gist of present invention” described above.

In a case of using a rupture disk unit as the pressure reduction section, the third effect is assumed to be brought about. Results of whether or not rupture of the rupture disk occurs vary depending on conditions such as a gas which passes through, a pressure thereof, and a temperature.

In the pressure reduction section, it is possible to additionally provide a silencing device in a case of expecting a pressure releasing effect by rupture of the rupture disk. Such a configuration is preferable from the viewpoint of suppressing noise to the surrounding area. As the silencing device, it is possible to employ various kinds of silencers as appropriate. It is possible to employ any of types such as an absorption type and an interference type. For the absorption type, there is concern about deterioration due to influence on a sound absorbing material by occurrence of detonation. However, the absorption type silencing mechanism has a high sound pressure suppressive effect, and can be suitably used when noise suppression is particularly intended. Meanwhile, the interference type intends to achieve noise suppression by a shape thereof or the like. Although a sound pressure suppressive effect of the interference type silencing mechanism is not relatively high, it is possible to constitute an interference type member only by a metallic material. The interference type silencing mechanism can be used in a case where it is necessary to take into special consideration in terms of durability or the like.

### <Application of Flame Extinction Device to Artificial Photosynthesis Plant>

The flame extinction device in accordance with the present invention can be used in any mechanical equipment, chemical equipment, and the like which involve concern about occurrence of explosion or detonation. The flame extinction device in accordance with the present invention is applicable to any combustible gases and a mixed gas containing a combustible gas and a combustion-supporting gas. In particular, the flame extinction device in accordance with the present invention can be suitably used in chemical equipment through which a hydrogen detonating gas passes in which hydrogen and oxygen having particularly large explosion power coexist, and more suitably used in “equipment in which hydrogen and oxygen are generated using a photocatalyst and pass therethrough” or the like. The latter may be referred to as an “artificial photosynthesis plant”. In a case where a photocatalytic reactor is pressurized from the viewpoint of gas transportation, a hydrogen-oxygen mixed gas (hydrogen detonating gas) having a stoichiometric composition is to be generated in the pressurized state. In such a case, the flame extinction device in accordance with the present invention is most suitably applicable.

A hydrogen-oxygen mixed gas generated by such water decomposition contains saturated water vapor at a temperature thereof. The flame extinction device in accordance with the present invention is preferably constituted by a material that does not particularly deteriorate or the like upon passage of a gas containing water vapor. With such a configuration, it is considered that a hydrogen detonating gas containing saturated water vapor has detonation power lower than that in a dry state. Therefore, it is extremely preferable to include water in the passing gas.

From this viewpoint, the flame extinction device of the present invention preferably does not have a movable part. For example, the flame propagation suppression section may be provided with a shutoff valve or a nonreturn valve that prevents backflow of flame or a gas in detonation. Meanwhile, there is concern that, if a gas containing saturated water vapor passes through such a shutoff valve or the like at that temperature, the gas may be condensed due to change in an outside air temperature or the like. As a result, a failure is likely to occur. Therefore, it is preferable that a spring or a movable mechanism which, in some cases, depends on melt of a low melting point metal is not included in the flame propagation suppression section. The same applies to the pressure reduction section. That is, it is more preferable to provide effective pressure reduction by a rupture disk unit or a pipe end part shape, rather than a configuration having a reversibly-movable part such as a safety valve. A pressure releasing effect of the rupture disk is achieved by irreversible rupture (breakage) thereof. Therefore, it is not necessary to eliminate the rupture disk as a movable part.

As described above, the flame extinction device of the present invention can be suitably used in an artificial photosynthesis plant. In the plant, a hydrogen-oxygen mixed gas containing water vapor generated in the photocatalytic reactor is generated with a stoichiometric composition. A dehumidification tower or the like is disposed downstream thereof. A gas separator membrane is provided further downstream thereof which separates hydrogen and oxygen by a molecular sieving effect. Here, in a case where the present flame extinction device is disposed at an outlet of the photocatalytic reactor, a wet gas containing hydrogen:oxygen=2:1 passes through. In the case where the present flame extinction device is disposed at an outlet of the dehumidification tower, a dry gas containing hydrogen:oxygen=2:1 passes through. A ratio of hydrogen and oxygen in the gas which passes through on the permeation side of the gas separator membrane (i.e., the hydrogen-rich side at the hydrogen recovery side) depends on the performance of the separator membrane. A gas composition on the non-permeation side of the gas separator membrane (i.e., the oxygen-rich side where oxygen remains as a result of permeation of hydrogen through the separator membrane) also depends on the performance of the separator membrane.

In the flame extinction device of the present invention, it is possible to extinguish flame even for a pressurized hydrogen detonating gas of hydrogen:oxygen=2:1 that may cause most intense detonation. From this viewpoint, the composition of hydrogen and oxygen which pass through in the artificial photosynthesis plant may vary in accordance with a process, a material, a configuration, and the like. In any case, the power is assumed to be weaker than a case where the pressurized hydrogen detonating gas of hydrogen:oxygen=2:1 detonates. Therefore, it is considered t flame extinction is possible. It is possible to suitably use the present flame extinction device for a mixed gas having an arbitrary composition which is within an explosive range in which a flow ratio of hydrogen and oxygen that pass through is 99:1 to 1:99, more preferably 96:4 to 4:96.

The flame extinction device of the present invention can be suitably used in an artificial photosynthesis plant as described above. A pressure of the hydrogen-oxygen (water vapor) mixed gas that passes through can be selected as appropriate.

For example, in order to reduce detonation power, a pressure in the photocatalytic reactor is preferably a reduced pressure. However, in a case where the pressure in the photocatalytic reactor is reduced, an amount of water vapor which is entrained in generation of a hydrogen-oxygen mixed gas is enormous. Therefore, an excessively large load may be applied to the subsequent dehumidification process, which necessitates caution. Further, in order to transport the generated gas to the downstream process, the pressure of the hydrogen-oxygen mixed gas is to be increased once, and it is thus necessary to provide a new process.

In another case, in a case where, although detonation power is increased compared with that in a reduced pressure state, a pressure of the photocatalytic reactor is set to an atmospheric pressure, an amount of water vapor entrained in generation of a hydrogen-oxygen mixed gas can be reduced, as compared with that in the reduced pressure state. Such a configuration is preferable. However, a problem remains in ensuring a pressure for transporting the gas to the downstream process. In order to deal with this, in a case where, although power in occurrence of detonation is increased compared with that in a reduced pressure state and an atmospheric pressure state, a pressure of the photocatalytic reactor is increased, an amount of water vapor entrained in generation of a hydrogen-oxygen mixed gas can be reduced, as compared with that in the reduced pressure state and the atmospheric pressure state. Such a configuration is more preferable. Furthermore, the problem in ensuring a pressure for transporting the gas to the downstream process is also solved. Therefore, the pressure of the hydrogen detonating gas in the photocatalyst panel part is more preferably a raised pressure.

### <Regarding Artificial Photosynthesis Plant>

The flame extinction device in accordance with the present invention is applied to a hydrogen-oxygen production device for obtaining hydrogen and oxygen by decomposing water. In particular, there are several methods for producing green hydrogen. Known are a method for carrying out electrolysis of water using renewable energy such as sunlight, and complete decomposition of water (i.e., a method for decomposing water into hydrogen and oxygen to obtain hydrogen) using a photocatalyst. The flame extinction device in accordance with the present invention is applied to a hydrogen production device that includes a generation section for generating hydrogen while utilizing sunlight.

In the method of electrolysis, hydrogen and oxygen are obtained from respective electrodes. In practice, hydrogen and oxygen that are mixed to a certain extent are taken out. In a case where a solar battery is used, sunlight is once transformed to electricity, and water is decomposed using the electricity. Therefore, energy conversion efficiencies at respective stages are multiplied, and a loss is large. Moreover, the device cost tends to increase.

In contrast, in a case of complete decomposition of water with a photocatalyst, a loss of in energy conversion is only once, and collection of light energy and water decomposition can be carried out simultaneously. Therefore, such a process is preferable. As a photocatalyst unit that decomposes water by a photocatalyst, it is possible to use any of various kinds of known ones.

The photocatalyst unit is provided with a means for supplying water that is a raw material. The photocatalyst unit is, if necessary, further provided with a gas-liquid separation means for taking out a mixed gas of oxygen and hydrogen generated. The hydrogen-oxygen mixed gas thus obtained is supplied to a separation means for separating hydrogen and oxygen. The flame extinction device in accordance with the present invention can be provided at any location in the photocatalyst unit. It is inefficient to provide each of the photocatalyst units with a means for separating the hydrogen-oxygen mixed gas at this time. Therefore, oxygen-hydrogen mixed gases from the respective photocatalyst units are gathered to a certain extent and then collected, via flame extinction devices that are provided at appropriate intervals, at a location of the separation means for separating hydrogen and oxygen.

As the separation means for separating hydrogen and oxygen, it is possible to use various kinds of known methods, and is not particularly limited. It is preferable to use a separator membrane including a zeolite membrane, a silica membrane, or the like from the viewpoints of characteristics thereof and being an inorganic membrane. In particular, from the viewpoint of explosion resistance, it is important to employ an inorganic membrane. The separator membrane is used for separation into an oxygen-rich gas and a hydrogen-rich gas, and those gases may be used as they are. Alternatively, it is possible to increase purity of each of the gases with a method such as dehumidification, cooling, and quenching of a residual gas. Such a structure serves as the hydrogen production device in accordance with the present invention, or, if directed at oxygen, a production device for producing oxygen. The flame extinction device in accordance with the present invention can be provided in any location upstream or downstream the separator membrane. Even if a gas which is outside the explosive range passes through in a normal state, there is a possibility that a gas in the explosive range passes through in a case where the gas separation does not function sufficiently. Therefore, it is preferable to provide the present flame extinction device as a preventive measure in such a location.

### [Main Points of Embodiment of Second Gist of Present Invention]

As is clear from the above descriptions, various aspects in the second gist of the present invention indicated below are included in the gist described in paragraphs <0061> through <0085>. A first aspect in the second gist of the present invention is a flame extinction device, including: a connective piping section which is connected to a first pipe, a second pipe, and a third pipe, a raw gas passing through the first pipe and the second pipe; a flame propagation suppression section that has a porous portion through which the raw gas passes, the flame propagation suppression section being provided on the first pipe side and/or the second pipe side when seen from the connective piping section; a pressure reduction section that is disposed at an end part of the third pipe, the pressure reduction section reducing an internal pressure of the third pipe in a case where the internal pressure has risen; and a shock absorption section that surrounds and/or makes contact with the pressure reduction section, the shock absorption section receiving a pressure released when the pressure reduction section reduces the internal pressure. According to the first aspect, it is possible to: suppress damage to other apparatuses due to propagation of a shock wave to the outside of the system in operation of the flame extinction device; simultaneously prevent propagation of excessively large sound pressure to the outside; and continuously prevent leakage of the raw gas or the like from the flame extinction device to the outside of the system.

In a second aspect of the second gist of the present invention, in the first aspect: the flame propagation suppression section further includes a narrowed portion through which the raw gas passes. The second aspect is further effective from the viewpoint of suppressing flame propagation in detonation and from the viewpoint of suppressing generation of a pressure loss in a normal state.

In a third aspect of the second gist of the present invention, in the second aspect: a diameter of the narrowed portion is 0.3 mm or more and 4.5 mm or less. The third aspect is furthermore effective from the viewpoint of suppressing flame propagation in detonation and from the viewpoint of suppressing generation of a pressure loss in a normal state.

In a fourth aspect of the second gist of the present invention, in any of the first aspect through third aspect: the flame propagation suppression section further includes a bent portion through which the raw gas passes. The fourth aspect is further effective from the viewpoint of suppressing flame propagation in detonation and from the viewpoint of suppressing generation of a pressure loss in a normal state.

In a fifth aspect of the second gist of the present invention, in any of the first aspect through fourth aspect: the connective piping section has a substantially circular cross section. The fifth aspect is furthermore effective from the viewpoint of enhancing pressure resistance.

In a sixth aspect of the second gist of the present invention, in any of the first aspect through fifth aspect, a pressure resistance P(tube) (MPa(G)) of the connective piping section satisfies a formula below. The sixth aspect is furthermore effective from the viewpoint of achieving both improvement in pressure resistance and cost reduction.

2≤P(tube)≤30

In a seventh aspect of the second gist of the present invention, in any of the first aspect through the sixth aspect: the pressure reduction section includes a reversible pressure release device; and a lowest release pressure P(release) (MPa(G))) of the reversible pressure release device satisfies a formula below. The seventh aspect is furthermore effective from the viewpoint of achieving both prevention of external leakage of the raw gas and prevention of breakage of the device.

0.1≤P(release)≤0.98

In an eighth aspect of the second gist of the present invention, in any of the first aspect through the sixth aspect: the pressure reduction section includes a rupture disk unit that blocks the third pipe; and a burst pressure P(burst) (MPa(G)) of a rupture disk included in the rupture disk unit satisfies a formula below. The eighth aspect is furthermore effective from the viewpoint of achieving prevention of breakage of the device due to release in the system or interference of a shock wave.

0.25≤P(burst)≤12

In a ninth aspect of the second gist of the present invention, in the eighth aspect: the rupture disk is disposed to have a concave shape with respect to the third pipe. The ninth aspect is furthermore effective from the viewpoint of achieving prevention of breakage of the device due to release in the system or interference of a shock wave.

In a 10th aspect of the second gist of the present invention, in any of the first aspect through the ninth aspect: a pressure of the shock absorption section in a normal state is substantially an atmospheric pressure. The 10th aspect is furthermore effective from the viewpoint of mitigating influence of pressure release from the pressure reduction section in the system.

In an 11th aspect of the second gist of the present invention, in any of the first aspect through the 10th aspect: the shock absorption section allows a gas to pass through from outside the shock absorption section. The 11th aspect is furthermore effective from the viewpoint of preventing diffusion of the raw gas or diluting the raw gas in pressure release by the pressure reduction section.

In a 12th aspect of the second gist of the present invention, in the 11th aspect: the gas which passes through the shock absorption section contains nitrogen. The 12th aspect is furthermore effective from the viewpoint of use in dilution of the raw gas in the shock absorption section.

In a 13th aspect of the second gist of the present invention, in any of the first aspect through the 12th aspect: the flame propagation suppression section further includes a housing which is provided in the first pipe and/or the second pipe and through which the raw gas passes; and the porous portion is provided inside the housing. The 13th aspect is further effective from the viewpoint of enhancing pressure resistance of the flame propagation suppression section. In the 13th aspect, the housing may further include one of or both of a narrowed portion and a bent portion therein. This aspect is furthermore effective from the viewpoint of enhancing pressure resistance of the flame propagation suppression section.

In a 14th aspect of the second gist of the present invention, in the 13th aspect: the housing is made of metal. The 14th aspect is furthermore effective from the viewpoint of enhancing pressure resistance and heat transfer property of the flame propagation suppression section.

In a 15th aspect of the second gist of the present invention, in any of the first aspect through the 14th aspect, the narrowed portion includes a nonlinear part. The 15th aspect is furthermore effective from the viewpoint of providing a narrowed portion that also has the effect of the bent portion.

In a 16th aspect of the second gist of the present invention, in any of the first aspect through the 15th aspect: the porous portion is a substantially columnar porous body. The 16th aspect is furthermore effective from the viewpoint of enhancing pressure resistance in occurrence of detonation.

In a 17th aspect of the second gist of the present invention, in any of the first aspect through the 16th aspect: a porous body constituting the porous portion contains metal and/or ceramic. The 17th aspect is furthermore effective from the viewpoint of enhancing heat resistance, heat transfer property, and/or chemical stability of the porous portion.

In an 18th aspect of the second gist of the present invention, in any of the first aspect through the 17th aspect: a porous body constituting the porous portion has gaps each having a width of 0.50 μm or more and 2.45 μm or less in a longitudinal direction. The 18th aspect is furthermore effective from the viewpoint of achieving both gas permeability for the raw gas and flame propagation suppression in detonation.

In a 19th aspect of the second gist of the present invention, in any of the first aspect through the 18th aspect: a porous body constituting the porous portion has gaps each having a width of 50 μm or more and 100 μm or less in a longitudinal direction. The 19th aspect is furthermore effective from the viewpoint of suppressing a pressure loss in permeation of the raw gas.

In a 20th aspect of the second gist of the present invention, in any of the first aspect through the 19th aspect: the raw gas is a mixed gas containing hydrogen and oxygen. As indicated in the 20th aspect, the flame extinction device in accordance with an aspect of the present invention is suitable for use in a device that deals with a raw gas whose explosion power is large.

In a 21st aspect of the second gist of the present invention, in the 20th aspect: the mixed gas further contains water vapor. The 21st aspect is furthermore effective from the viewpoint of reducing detonation power of the mixed gas.

In a 22nd aspect of the second gist of the present invention, in any of the first aspect through the 21st aspect: the raw gas is used at an atmospheric pressure or at a pressure higher than an atmospheric pressure. The 22nd aspect is furthermore effective from the viewpoint of causing the raw gas to pass through in the system.

In a 23rd aspect of the second gist of the present invention, a hydrogen production device includes: a generation section that generates a hydrogen-containing gas; and a flame extinction device that communicates with the generation section, the flame extinction device being the flame extinction device described in any one of the first aspect through the 22nd aspect. According to the 23rd aspect, in the hydrogen production device, it is possible to: suppress damage to other apparatuses due to propagation of a shock wave to the outside of the system in operation of the flame extinction device; simultaneously prevent propagation of excessively large sound pressure to the outside; and continuously prevent leakage of the raw gas or the like from the flame extinction device to the outside of the system.

In a 24th aspect of the second gist of the present invention, in the 23rd aspect: the generation section generates hydrogen while utilizing sunlight. The 24th aspect is furthermore effective from the viewpoint of effective use of energy in generation of a raw gas.

The second gist of the present invention is not limited to the embodiments described above, but may be altered in various ways by a skilled person within the scope of the claims. Any embodiment derived from a proper combination of technical means disclosed in different embodiments is also encompassed in the technical scope of the second gist of the present invention.

### [Embodiment of Third Gist of Present Invention]

### [Photochemical Reaction Plant]

The following description will discuss an embodiment with reference to FIG. 1. FIG. 1 is a diagram schematically illustrating a configuration of photochemical reaction plant 100 in accordance with an embodiment of the present invention. The descriptions of the photochemical reaction plant 100 are substantially identical with those described in “Embodiment of first gist of present invention” and “Embodiment of second gist of present invention” above.

As illustrated in FIG. 1, the photochemical reaction plant 100 includes a photochemical reaction device 110 and a separator membrane device 140 that separates hydrogen and oxygen from a gas generated by the photochemical reaction device 110. The photochemical reaction plant 100 further includes a flame extinction device 160. The flame extinction device 160 will be described later. The photochemical reaction plant 100 further includes a condensate water removal device 120, a humidity reduction device 130, and a vacuum pump 170. As illustrated in FIG. 1, in the photochemical reaction plant 100, a set of four photochemical reaction devices 110 in series is disposed in three sets in parallel.

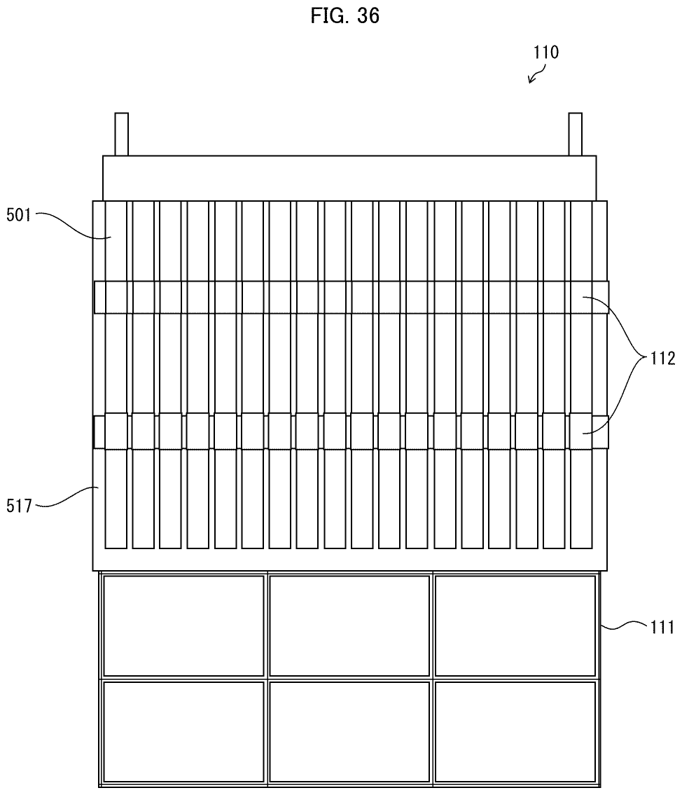

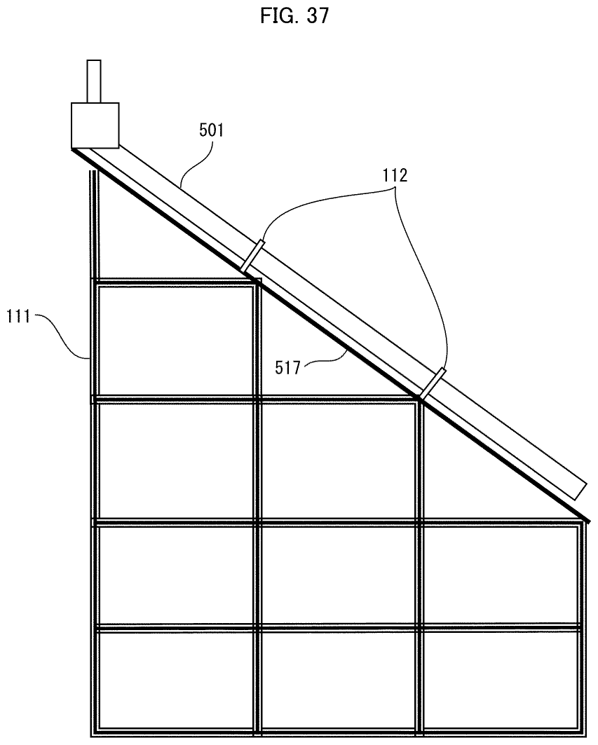

FIG. 36 is a diagram schematically illustrating a configuration of the photochemical reaction device 110 in accordance with an embodiment of the present invention. FIG. 37 is a diagram schematically illustrating a configuration of the photochemical reaction device 110, when seen laterally, in accordance with an embodiment of the present invention. As illustrated in FIGS. 36 and 37, the photochemical reaction device 110 includes: a base 111 on which a photochemical reactor 501 is placed; a fixture 112 which fixes the photochemical reactor 501 to the base 111; and a reflector plate 517 which is disposed on the surface of the base 115 on which the photochemical reactor 501 is placed.

The base 111 is a member for supporting the photochemical reactor 501 in an environment that is irradiated with light. For example, in an outside environment, the base 111 supports the photochemical reactor 501 in an inclined manner at an appropriate angle at which the photochemical reactor 501 is sufficiently irradiated with sunlight, while a manifold (described later) comes to the upper side. The base 111 is assembled, for example, with pipes.

The base 111 supports the photochemical reactor 501 via the reflector plate 517. That is, the photochemical reactor 501 is placed on the reflector plate 517. The reflector plate 517 is a plate-like member that reflects a part of light received by the photochemical reactor 501.

The photochemical reactor 501 is fixed to the base 111 and the reflector plate 517 by the fixture 112. The fixture 112 is a belt-like member having a corrugate shape that makes circumferential contact with outer peripheral surfaces of respective tube assemblies (described later) in the photochemical reactor 501. The fixtures 112 are disposed in two locations in a longitudinal direction of the tube assembly to fix the photochemical reactor 501. The fixture 112 is not limited to this, and may be disposed as appropriate according to a length of the tube assembly. The fixture 112 only needs to be provided at one or more locations. The photochemical reactor 501 will be described later.

The condensate water removal device 120 is a device that removes condensate water from the photochemical reaction device 110. The humidity reduction device 130 is a device that reduces humidity of the gas. The separator membrane device 140 is a device that separates hydrogen and oxygen from a gas generated by the photochemical reaction device 110. The flame extinction device 160 is a device that reduces flame propagation which occurs in a case where explosion or detonation occurs. The vacuum pump 170 is a device for generating, in the separator membrane device 140, a pressure difference at which a specific gas passes through the separator membrane. Descriptions of these devices here are substantially identical with those described in paragraphs <0129> through <0133> in “Embodiment of first gist of present invention” described above.

### <Photochemical Reactor>

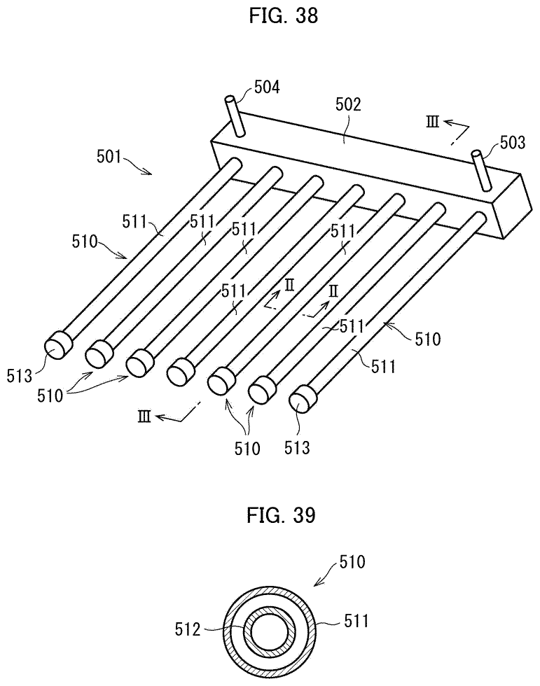

The following description will discuss the photochemical reactor 501 in accordance with an embodiment of the present invention with reference to FIGS. 38 through 40.

FIG. 38 is a perspective view illustrating a manifold 502 and a tube assembly 510 of the photochemical reactor 501 in accordance with an embodiment of the present invention. As illustrated in FIG. 38, the photochemical reactor 501 of the present embodiment includes a manifold 502 and a tube assembly 510 that communicates with the manifold 502. The photochemical reactor 501 is a reactor that carries out photochemical reaction.

The manifold 502 is a long box shape that is disposed in a substantially horizontal manner. Alternatively, the shape may be another shape such as a tubular shape, e.g., a cylindrical shape. A carrier gas inlet 503 is provided at one end side of the manifold 502 in a longitudinal direction, and a gas (carrier gas and a mixed gas containing the generated gas) outlet 504 is provided at the other end side. Although not illustrated, a water inlet for injecting water into the manifold 502, a drain outlet for drainage, and the like are provided. The carrier gas may be or may not be used, and the carrier gas inlet 503 may be omitted.

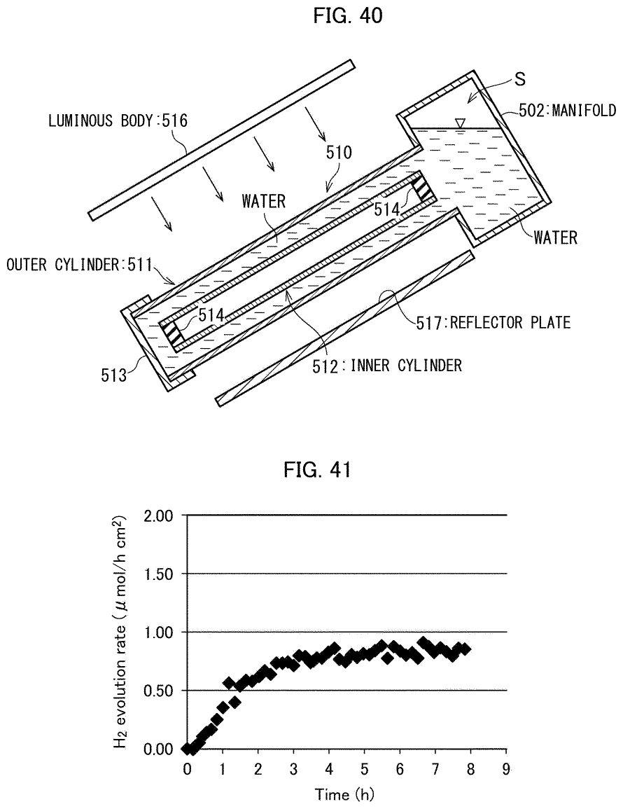

FIG. 39 is a diagram schematically illustrating a cross section of the tube assembly taken along the line II-II in FIG. 38. FIG. 40 is a diagram schematically illustrating a cross section of the photochemical reactor taken along the line III-III in FIG. 38. The tube assembly 510 includes, as illustrated in FIGS. 39 and 40, an outer cylinder 511 and an inner cylinder 512 that is disposed within the outer cylinder 511. The outer cylinder 511 houses the inner cylinder 512 and is constituted by a material that transmits light used in reaction. The inner cylinder 512 is preferably disposed in a coaxial manner with the outer cylinder 511, but is not limited to this. For example, the inner cylinder 512 may be disposed in an eccentric manner.

The outer cylinder 511 is made of a light transmissive material. The outer cylinder 511 is connected to the manifold 502 at one end. A space between the outer cylinder 511 and the inner cylinder 512 communicates with the inside of the manifold 502. The other end of the outer cylinder 511 is sealed by a sealing member 513. The sealing member 513 is a cap-like member in this embodiment, but is not limited thereto. The outer cylinder 511 and the sealing member 513 constitute a tubular container that can accommodate a liquid.

The inner cylinder 512 is sealed at both ends by sealing members 514. In FIG. 40, the sealing member is a plug-like member but is not limited thereto. The sealing member may have another shape such as, for example, a cap shape. The inner cylinder 512 is retained in the outer cylinder 511 by means of fixation with a retaining jig having a shape through which water can pass. Thus, the inner cylinder 512 and the sealing members 514 constitute a columnar structure. The columnar structure constituted by the inner cylinder 512 and the sealing members 514 is preferable from the viewpoint of light weight. The columnar structure only needs to be in a form to be housed in the outer cylinder 511. For example, the columnar structure may be a member (such as a glass rod) inside of which is filled. Alternatively, in the columnar structure constituted by the inner cylinder 512 and the sealing members 514, a liquid or solid may be accommodated in the inner cylinder 512 which is sealed with the sealing members 514.

A photocatalytic layer is provided to an outer peripheral surface of the inner cylinder 512. In this embodiment, the photocatalyst includes a promoter. Suitable examples of the photocatalyst and the promoter are as described later. The photocatalyst is a component that generates a high-energy substance in the presence of light from a liquid supplied into the outer cylinder 511. The high-energy substance is a substance which itself serves as an energy source or which is used as a raw material in a synthetic substance that serves as an energy source. Examples of the high-energy substance include hydrogen, carbohydrate, and ammonia. The high-energy substance is hydrogen in the present embodiment. The photocatalyst layer may be provided on an outer peripheral surface of the inner cylinder 512 or may be provided on both the inner peripheral surface of the outer cylinder 511 and the outer peripheral surface of the inner cylinder 512. The phrase “provided on the outer peripheral surface of the inner cylinder 512” means that the photocatalyst layer may be provided in direct contact with the outer peripheral surface of the inner cylinder 512, or the photocatalyst layer may be indirectly provided on the outer peripheral surface of the inner cylinder 512 via another member. For example, in a case where a light reflective film (described later) is provided to the outer peripheral surface of the inner cylinder, the photocatalytic layer is provided to the outer peripheral surface of the inner cylinder 512 via the light reflective film. For example, the liquid supplied into the outer cylinder 511 is water, and the photocatalyst is a photocatalyst for water decomposition reaction. The photocatalyst for water decomposition reaction generates a gas containing hydrogen and oxygen from water. In a case where the liquid supplied into the outer cylinder 511 is water and the photocatalyst is a photocatalyst for water decomposition reaction, the photochemical reaction plant 100 described above can be a production device for producing hydrogen and oxygen.

The photochemical reactor 501 is disposed in an inclined manner so that the manifold 502 side (base end side) of the tube assembly 510 comes to the upper position and the opposite side (tip side) comes to the lower position. An inclination angle of the tube assembly 510 with respect to the horizontal plane is preferably, but not limited to, 5° to 90°, in particular approximately 10° to 80°. In particular, in a case where the photochemical reactor 501 is used under irradiation with sunlight, it is possible to obtain, by a solar radiation simulation or the like, an installation angle that maximizes an amount of solar radiation in accordance with a latitude or the like of a land where the photochemical reactor 501 is disposed at an inclination angle in a range in which gas bubbles flow.

In this embodiment, a plurality of tube assemblies 510 are arranged in a longitudinal direction of the manifold 502 at certain intervals. As illustrated in FIG. 40, a luminous body 516 is disposed above the tube assembly 510, and a reflector plate 517 is disposed below the tube assembly 510. The reflector plate 517 is preferably a diffuse reflector plate. The luminous body 516 only needs to be a light source that emits light with which the photocatalyst provided to the tube assembly 510 exerts a catalytic ability thereof. The luminous body 516 can be, for example, a lighting device such as a light emitting diode (LED). In a case where the photocatalyst provided to the tube assembly 510 exerts a catalytic ability thereof also with sunlight (natural light), the photochemical reactor 501 can be disposed outdoors so that the tube assembly 510 is to be irradiated with sunlight. Alternatively, the photochemical reactor 501 can be disposed indoors with light guiding members (such as a mirror and an optical fiber) which guide sunlight.

In the photochemical reactor 501 thus constituted, water is supplied so that the entire space between the outer cylinder 511 and the inner cylinder 512 is filled with water, and a gas-passage space S is to be formed at an upper part in the manifold 502. The gas-passage space S is essential for carrying out gas-liquid separation of the generated gas and water in this space. A volume of the gas-passage space S or a water level in the manifold 502 is selected from a condition in which, with respect to an amount of gas generated and a total flow amount of a carrier gas, water in the manifold 502 is not entrained as spray. Light is emitted from the luminous body 516 toward the tube assembly 510, and also a gas such as nitrogen is supplied as necessary to the gas-passage space S as a carrier gas.

By a catalytic action of the photocatalyst, hydrogen and oxygen are generated. Gas bubbles containing the hydrogen and oxygen rise between the outer cylinder 511 and the inner cylinder 512 toward the manifold 502. The gas bubbles leave from the water surface into the gas phase in the manifold 502. Due to a pressure of a generated gas itself or while being accompanied by the carrier gas, the generated gas is taken out of the manifold 502 via the outlet 504.

The gas taken out is allowed to pass through a hydrogen separation device having a hydrogen permeable membrane and an oxygen separation device having an oxygen permeable membrane (both of the devices are not illustrated), and thus hydrogen and oxygen are obtained.

According to the photochemical reactor in accordance with this embodiment, as described above, the tube assembly 510 has a double-tube structure. As a result, leakage of the promoter is suppressed, and reprecipitation of the promoter is easy to occur. Therefore, it is possible to achieve high phototranstormation efficiency and a long lifetime of the photocatalyst. The gas is not retained in the tube assembly 510 or the manifold 502, and therefore safety is high. It is easy to control operation and possible to reduce the weight of the device.

A material of the outer cylinder 511 is preferably a material that transmits light (including infrared light and ultraviolet light) used in photoreaction, at a total light transmittance of preferably 50% or more, more preferably 60% or more, most preferably 70% or more, particularly with an absorption wavelength of the photocatalyst that seems to achieve photoreaction most efficiently. Light used in photoreaction is not particularly limited, and is usually sunlight. In this case, the material of the outer cylinder 511 is suitably a material that transmits, among sunlight, light having a wavelength used in photoreaction, in particular, visible light. Specifically, it is possible to use glass, a transparent resin, or the like.

In order to prevent reflection due to a refractive index difference between (i) air and (ii) the glass or transparent resin, it is preferable to provide a film having an intermediate refractive index between those of the air and the constituent material of the cylinder on the outer peripheral surface of the outer cylinder and/or the inner peripheral surface of the outer cylinder. Specifically, for example, for silica glass, it is preferable to provide a membrane having a refractive index reduced by silica containing fluorine and by providing minute hollows therein. As such, in a case where the columnar structure described above is an inner cylinder having sealed both ends, from the viewpoint of light use efficiency, the anti-light-reflective film is preferably provided on the outer peripheral surface of the outer cylinder and/or on the inner peripheral surface of the outer cylinder, and more preferably on the outer peripheral surface of the outer cylinder. The anti-light-reflective film is, for example, the layer of silica containing fluorine or the membrane having minute hollows therein in the above description. The anti-light-reflective film prevents light that has externally reached the outer cylinder from being reflected by the outer cylinder. Thus, the anti-light-reflective film can increase an amount of light which can be delivered from the outside of the outer cylinder to the photocatalyst provided on the outer peripheral surface of the inner cylinder. Therefore, it is possible to increase the efficiency of photochemical reaction and increase an amount of product obtained by the photochemical reaction.

It is preferable to provide, at least one of the inner peripheral surface and the outer peripheral surface of the inner cylinder, a reflective layer (light reflective film) that reflects light having a wavelength used in photoreaction. In a case where the inner cylinder includes a light reflective film on the outer peripheral surface thereof and a photocatalyst is provided on the outer peripheral surface thereof, the photocatalyst is stacked on the outer cylinder side of the light reflective film when seen from the inner cylinder. By reflecting light which has reached at least one of the inner peripheral surface side and the outer periphery side of the inner cylinder by the light reflective film, it is possible to increase an amount of light that can be delivered to the photocatalyst. Therefore, it is possible to increase reaction efficiency of photochemical reaction and increase an amount of product obtained by the photochemical reaction.

From the viewpoint of increasing an area in which the photocatalyst is provided and enhancing reaction efficiency, an outside diameter of the inner cylinder 512 is preferably 10% to 99% with respect to the inside diameter of the outer cylinder 511.

A diameter (outside diameter) of the outer cylinder 511 is not particularly limited, and is preferably 200 mm or less in diameter, preferably 100 mm or less, and more preferably 60 mm or less, in view of a weight in actual handling. Even in a case where a large number of tube assemblies 510 are provided, the diameter (outside diameter) of the outer cylinder 511 is preferable to 4 mm or more from the viewpoint of facilitating maintenance. The outside diameter of the inner cylinder 512 is preferably smaller than the inside diameter of the outer cylinder 511 in a range of 20 mm or less (a thickness of water is 10 mm when the outside diameter of the inner cylinder is smaller than the inside diameter of the outer cylinder by 20 mm), more preferably 10 mm or less. A difference between the inside diameter of the outer cylinder 511 and the outside diameter of the inner cylinder 512 may be determined as appropriate, taking into consideration an appropriate thickness of the water layer and extension and contraction due to thermal expansion. The difference between the inside diameter of the outer cylinder 511 and the outside diameter of the inner cylinder 512 is normally preferably 0.1 mm or more, more preferably 0.2 mm or more, further preferably 0.5 mm or more, particularly preferably 1 mm or more.

Cross sections of the outer cylinder 511 and the inner cylinder 512 are not particularly limited, provided that the inner cylinder 512 can be housed in the outer cylinder 511. The cross section of the outer cylinder 511 and the cross section of the inner cylinder 512 are normally preferably similar in shape, and most preferably the cross sections are circular in shape. This is due to the fact that a pressure is uniformly applied and that it is not necessary to take deeply into consideration a position with respect to sunlight or the like and stable reaction is likely to be achieved.

In this embodiment, the photocatalyst is provided to the outer peripheral surface of the inner cylinder 512. The photocatalyst may be provided on the inner peripheral surface of the outer cylinder 511 or may be provided on both the outer peripheral surface of the inner cylinder 512 and the inner peripheral surface of the outer cylinder 511. The photocatalyst may be in a form of slurry and enclosed between the outer cylinder 511 and the inner cylinder 512. However, in order that only the inner cylinder 512 can be replaced in a case where efficiency decreases, it is preferable to provide a photocatalyst to the outer peripheral surface of the inner cylinder 512.

A preferable provision amount of the photocatalyst is 0.01 g/m² to 50 g/m², particularly 0.1 g/m² to 50 g/m², especially 0.1 g/m² to 30 g/m², with respect to the outer peripheral surface of the inner cylinder 512 or the inner peripheral surface of the outer cylinder 511.

Next, suitable examples of a type of photocatalyst, a promoter, and the like are indicated below.

In a case where the photocatalyst is made of an optical semiconductor, the photocatalyst is preferably a compound containing a metallic element (including a metalloid element) that can be a metal ion of d0 or d10. More preferably, the photocatalyst is a compound containing a transition metal of do or d10. Examples of the metallic element that can be a metal ion of do include Ti, Zr, Nb, Ta, V, W, and La. Examples of the metallic element that can be a metal ion of d10 include Zn, Ga, Ge, In, Sn, Sb, Pb, and Bi. Preferable examples include oxides, nitrides, oxynitrides, chalcogenides, and oxychalcogenides, which contain one or more elements selected from the group consisting of Ti, V, Ga, Zn, Bi, Nb, and Ta. Specifically, used are: titanium-containing oxides such as TiO₂, CaTio₃, SrTiO₃, Al-doped SrTiO₃, Sr₃Ti₂O₇, Sr₄Ti₃O₁, K₂La₂Ti₃O₁₀, Rb₂La₂Ti₃O₁₀, Cs₂La₂Ti₃O₁₀, CsLaTi₂NbO₁₀, La₂TiO₅, La₂Ti₃O₉, La₂Ti₂O₇, La₂Ti₂O₇:Ba, KaLaZr_{0.3}Ti_{0.7}O₄, La₄CaTi₅O₇, KTiNbO₅, Na₂Ti₆O₁₃, BaTi₄O₉, Gd₂Ti₂O₇, Y₂Ti₂O₇, Na₂Ti₃O₇, K₂Ti₂O₅, K₂Ti₄O₉, Cs₂Ti₂O₅, H⁺—Cs₂Ti₂O₅ (H⁺—Cs indicates that Cs is ion-exchanged with H⁺, the same applies hereinafter), Cs₂Ti₅O₁₁, Cs₂Ti₆O₁₃, H⁺—CsTiNbO₅, H⁺—CsTi₂NbO₇, SiO₂-pillared K₂Ti₄O₉, SiO₂-pillared K₂Ti_{2.7}Mn_{0.3}O₇, BaTiO₃, BaTi₄O₉, and AgLi_{1/3}Ti_{2/3}O₂; titanium-containing oxynitrides such as LaTiO₂N; titanium-containing (oxy)chalcogenides such as La₅Ti₂CuS₅O₇, La₅Ti₂AgS₅O₇, and Sm₂Ti₂O₅S₂; gallium-containing nitrides such as GaN:ZnO (ZnO solid solution of gallium-containing nitride); germanium-containing nitrides such as ZnGeN₂:ZnO (ZnO solid solution of germanium-containing nitride); vanadium-containing oxides such as BiVO₄ and Ag₃VO₄; niobium-containing oxides such as KANb₆O₁₇, Rb₄Nb₆O₁₇, Ca₂Nb₂O₇, Sr₂Nb₂O₇, Ba₅Nb₄O₁₅, NaCa₂Nb₃O₁₀, ZnNb₂O₆, Cs₂Nb₄O₁₁, La₃NbO₇, H⁺—KLaNb₂O₇, H⁺—RbLaNb₂O₇, H⁺—CsLaNb₂O₇, H⁺— KCa₂Nb₃O₁₀, SiO₂-pillared KCa₂Nb₃O₁₀ (Chem. Mater. 1996, 8, 2534), H⁺—RbCa₂Nb₃O₁₀/H⁺—CsCa₂Nb₃O₁₀, H⁺—KSr₂Nb₃O₁₀, H⁺—KCa₂NaNb₄O₁₃), and PbBi₂Nb₂O₉; niobium-containing oxynitrides such as CaNbO₂N, BaNbO₂N, SrNbO₂N, and LaNbON₂; tantalum-containing oxides such as Ta₂O₅, K₂PrTa₅O₁₅, K₃Ta₃Si₂O₁₃, K₃Ta₃B₂O₁₂, LiTaO₃, NaTaO₃, KTaO₃, AgTaO₃, KTaO₃:Zr, NaTaO₃:La, NaTaO₃:Sr, Na₂Ta₂O₆, K₂Ta₂O₆ (pyrochlore), CaTa₂O₆, SrTa₂O₆, BaTa₂O₆, NiTa₂O₆, Rb₄Ta₆O₁₇, H₂La_{2/3}Ta₂O₇, K₂Sr_{1.5}Ta₃O₁₀, LiCa₂Ta₃O₁₀, KBa₂Ta₃O₁₀, Sr₅Ta₄O₁₅, Ba₅Ta₄O₁₅, H_{1.8}Sr_{0.81}Bi_{0.19}Ta₂O₇, Mg−Ta oxide (Chem. Mater. 2004 16, 4304-4310), LaTaO₄, and La₃TaO₇; tantalum-containing nitrides such as Ta₃N₅; tantalum-containing oxynitrides such as CaTaO₂N, SrTaO₂N, BaTaO₂N, LaTaO₂N, Y₂Ta₂O₅N₂, and TaON; and the like. The above compounds may further include different metals as dopants.

From the viewpoint of more efficiently causing water decomposition reaction using sunlight, it is preferable to use an optical semiconductor of visible light responsive type among the above various types of optical semiconductors. Specifically, BaNbO₂N, TaON, Ta₃N₅, LaTiO₂N, SnNb₂O₆, BaTaO₂N, La₅Ti₂CuS₅O₇, and BiVO₄ are preferable. Among these, BaNbO₂N, TaON, Ta₃N₅, LaTiO₂N, BaTaO₂N, BiVO₄, and GaN:ZnO are particularly preferable. These compounds may be partially substituted by a doped element. The above various types of optical semiconductors can be easily synthesized by known synthetic methods, such as a solid phase method and a solution method.

In a case of producing a composite photocatalyst from a plurality of types of optical semiconductors, a method for selecting types of optical semiconductors is not particularly limited, and it is preferable to select two or more types of optical semiconductors which are extremely different in absorption region from each other. This is because an absorption width of the obtained composite photocatalyst is widened when the absorption regions of the optical semiconductors are different, and it is possible to use more photons. An energy barrier with the promoter and/or the electric conductor is reduced by different absorption regions, and charge transfer is smooth. Therefore, such a configuration is preferable.

For example, in a case where two types of optical semiconductors are selected, it is preferable that an absorption end of one of the optical semiconductors is 350 nm to 550 nm, and an absorption end of the other of the optical semiconductors is 500 nm to 750 nm. In a case where three or more types of optical semiconductors are selected, at least two of those preferably have the absorption ends described above.

In a case where the absorption ends of two types of optical semiconductors among a plurality of types of optical semiconductors used are compared, it is preferable to include optical semiconductors between which a difference in the absorption end is 25 nm or more. The difference in the absorption end is more preferably 50 nm or more, preferably 250 nm or less. In a case of where three or more types of optical semiconductors are selected, it is preferable that at least two types of optical semiconductors are in the above relationship, and it is more preferable that all of the optical semiconductors are in the above relationship.

Examples of preferable combinations of optical semiconductors include GaN and LaTiO₂N, GaN and BaTaO₂N, TaON and LaTiO₂N, BiVO₄ and LaTiO₂N, TaON and BaTaO₂N, TaON and Ta₃N₅, BiVO₄ and BaTaO₂N, and the like.

A form (shape) of an optical semiconductor is not particularly limited, provided that the form can function as a photocatalyst while supporting a promoter described below. The photocatalyst for water decomposition reaction preferably supports a promoter (described later) on a surface of a particulate optical semiconductor. In this case, a lower limit of a particle diameter of the optical semiconductor is preferably 50 nm or more, and an upper limit is preferably 500 μm or less.

The term “particle diameter” means an average value (average particle diameter) of unidirectional tangential diameters (Feret diameter) and can be measured by a known means such as XRD, TEM, or an SEM method.

The above described optical semiconductor is preferably subjected to acid treatment in advance. That is, as a pre-step of the heating step, it is preferable to include: an organic acid contact step of bringing a solution of at least one organic acid containing a polyorganic acid into contact with a surface of an oxide, an oxynitride, or a nitride containing at least one element selected from Ti, V, Ga, Ge, Nb, and Ta; and, after the organic acid contact step, a recovery step of recovering an oxide, an oxynitride, or a nitride which has remained as a solid content, and to use the recovered solid content as an optical semiconductor. Details will be described later.

For the promoter source, a substance (component, element, ion) is used which can be used as a promoter by being heated with an optical semiconductor in a liquid. For example, in a case where a promoter containing Co (such as CoOₓ, which is a promoter for generating oxygen) is to be supported by an optical semiconductor, it is possible to use a compound containing Co as the promoter source. An example of the compound containing Co is preferably a salt containing Co, and is specifically Co(NO₃)₂, Co(NH₃)₆Cl₃, Co(OAC)₂, or the like. Furthermore, sodium phosphate or sodium borate can be added so as to be supported as CoPi or CoBi. The promoter for generating oxygen is not limited to CoOₓ. In an aspect of the present invention, examples of the promoter for generating oxygen to be supported include metals which are Cr, Sb, Nb, Th, Mn, Fe, Co, Ni, Ru, Rh, and Ir, and oxides, sulfides, and composite oxides (excluding CoOₓ) of the metals, and the like. Among those, the oxides of the metals are preferable in view of stability against oxidation. In a case where these substances are supported, for example, it is possible to use, as the promoter source, a salt containing those elements.

It is possible to cause an optical semiconductor to support a promoter for generating hydrogen. For example, in a case where Pt as a promoter for generating hydrogen is to be supported by an optical semiconductor, it is possible to use Pt itself or a compound containing Pt as a promoter source. An example of the compound containing Pt is preferably a salt containing Pt, and is H₂PtCl₆ or the like. The promoter for generating hydrogen is not limited to Pt. In an aspect of the present invention, examples of the promoter for generating hydrogen to be supported include Pd, Rh, Ru, Ni, Au, Fe, Ru—Ir, Pt—Ir, Nio, RuO₂, IrO₂, Rh₂O₃, Cr—Rh composite oxides, sulfides obtained by adding sulfur and/or thiourea to those metals, and the like. Among those, in view of reducing ability, the metals or oxidizable noble metal oxides are preferable. In a case where these substances are supported, for example, it is possible to use, as the promoter source, a salt containing those elements.

### <Flame Extinction Device>

The hydrogen and oxygen production device in accordance with an aspect of the present invention preferably includes a flame extinction device. Even in the device in accordance with an aspect of the present invention, since the gas which passes through the inside thereof is a mixed gas of hydrogen and oxygen, the burning velocity is extremely high, and ranges from 3000 m/s to 6000 m/s. Therefore, it is preferable to employ a combination with a flame extinction device which is particularly suitable for a mixed gas of hydrogen and oxygen. Examples of a suitable flame extinction device include the following two flame extinction devices, i.e., a flame extinction device A and a flame extinction device B. The flame extinction device A includes, for example, the following configurations.

The flame extinction device is disposed between (I) a first pipe to which a raw gas is supplied from one end side and (II) a second pipe which is disposed at an angle with the first pipe, and has constituent elements (i) through (iii) below:
(i) a connective piping section that allows a raw gas to flow from the first pipe to the second pipe and that simultaneously has a branch to a third pipe;
(ii) a flame propagation suppression section that is provided between the connective piping section and the first pipe and/or the second pipe and that has a housing, as well as a bent portion, a narrowed portion, and a porous portion in a flow path in the housing; and
(iii) a pressure reduction section that is disposed at an end part of the third pipe which is not orthogonal to an extension line of the first pipe in a flowing direction of the raw gas in the first pipe.

As such, the flame extinction device A includes: the connective piping section which is connected to the first pipe, the second pipe, and the third pipe, a raw gas being supplied to the first pipe and the second pipe; the flame propagation suppression section that has a porous portion through which the raw gas passes, the flame propagation suppression section being provided on the first pipe side and/or the second pipe side when seen from the connective piping section; and the pressure reduction section that is disposed at an end part of the third pipe, the pressure reduction section reducing an internal pressure of the third pipe in a case where the internal pressure has risen. The third pipe is not orthogonal to any of the first pipe and the second pipe.

Instead of reducing, by the pressure reduction section, an internal pressure of the third pipe when the internal pressure has risen, the flame extinction device A may reduce the internal pressure of the third pipe by generating, at the end part of the third pipe, a reflected wave which interferes with an incident wave of a shock wave.

In the descriptions of the flame extinction device A below, in a case where an expression such as “necessary” is used, it means that a subject is “necessary” in a case where the flame extinction device A is used which may be applied to the present invention.

### (Basic Configuration of Flame Extinction Device A)

The following description will discuss a basic configuration of the flame extinction device A and behaviors thereof, while using an aspect illustrated in FIG. 2. Descriptions here of the flame extinction device A in accordance with the present aspect are substantially identical with those described in paragraphs <0134> through <0143>, <0152> through <0183>, <0195> through <0197>, <0203> through <0209>, <0212> through <0231>, and <0235> in “Embodiment of first gist of present invention” described above.

### (Flame Extinction Device B)

Next, the following description will discuss a case in which the flame extinction device B is used as another aspect.

The flame extinction device B is suitably disposed between (i) a first pipe to which a raw gas is supplied from one end side and (ii) a second pipe, the flame extinction device B having constituent elements (1) through (4) below:
(1) a connective piping section that allows a raw gas to flow from the first pipe to the second pipe and that simultaneously has a branch to a third pipe;
(2) a flame propagation suppression section that is provided between the connective piping section and the first pipe and/or the second pipe and that has a housing, as well as a bent portion and a narrowed portion in a flow path in the housing;
(3) a pressure reduction section that is disposed via the third pipe; and
(4) a shock absorption section that surrounds and/or makes contact with the pressure reduction section.

As such, the flame extinction device B includes, in addition to the connective piping section, the flame propagation suppression section, and the pressure reduction section described above, a shock absorption section that surrounds and/or makes contact with pressure reduction section, the shock absorption section receiving a pressure released when the pressure reduction section reduces the internal pressure. In the flame extinction device B, unlike the flame extinction device A, the direction of the third pipe with respect to the first pipe and the second pipe is not limited.

The flame extinction device B has a configuration with an emphasis on the effect of the pressure reduction section, as compared with the flame extinction device A. Therefore, an effort has been made to achieve that, even in a case where the pressure reduction section is released, no explosive gas or the like leaks to the outside of the system.

First, the following description will discuss in detail a basic configuration of the flame extinction device B and behaviors thereof, while using an aspect illustrated in FIG. 30. FIG. 30 illustrates an example of the basic configuration of the present flame extinction device B. In a case of ignition at the first pipe 10 side to which a raw gas is supplied, a shock wave propagation mitigation effect and a flame propagation suppressive effect to the second pipe 22 side are expected. In particular, at the same time, in a case where the shock wave propagation mitigation effect is achieved by pressure release in a pressure reduction section B2, the flame extinction mechanism in accordance with the present invention releases pressure to a shock absorption section 9 in the system rather than outside the system. Therefore, there is no leakage of a gas such as a combustible gas or a gas which has undergone chemical combination, decomposition, or the like as a result of chemical reaction to the outside of the system, and such a state is very preferable.

In the following descriptions, it is assumed that the flame extinction device B is provided in a so-called “artificial photosynthesis plant”, which is equipment in which hydrogen and oxygen are generated using a photocatalyst and pass therethrough with use of the photochemical reactor of the present invention. Moreover, it is assumed that ignition occurs at the first pipe 10 side to which a raw gas is supplied. The following description will discuss operations of the flame extinction device B in such a case. In a case of ignition on the first pipe 10 side, a shock wave and flame after transition to detonation propagate to a connective piping section 20 that has a branch to a third pipe, depending on a distance of the pipe and a pipe diameter. After that, although the shock wave and detonation flame have the characteristic of being comparatively easy to propagate straight, the shock wave and detonation flame propagate in any direction, and therefore easily reach the pressure reduction section 2 through the third pipe 21. In order to suppress propagation of a shock wave and detonation flame, from experimental and theoretical studies, the inventors of the present invention have found that reducing pressure thereof is an important requirement. In view of this, if the pressure is released at the pressure reduction section or a shock wave is comparatively weak, flame is attenuated by a reflected wave from the pressure reduction section 2. Then, the flame propagation suppression section 3 prevents propagation of flame to the second pipe 22 side.

It has also been found experimentally that the pressure reduction section 2 alone is not sufficient to suppress a shock wave and detonation flame which can be generated by detonation of, in particular, a hydrogen detonating gas (hydrogen-oxygen mixed gas) and can propagate in any direction. In particular, for suppression of flame propagation, an appropriate flame propagation suppression section is essential. The flame propagation suppression section is joined to the pressure reduction section via the connective piping section that has several branches. By thus disposing the pressure reduction section 2 and the flame propagation suppression section 3 in combination in the system, it is possible to effectively exert a flame propagation suppressive effect by the flame propagation suppression while reducing detonation pressure, and thus prevent propagation of a shock wave and flame to the second pipe 22 due to detonation.

Next, the following description will discuss several variations in addition to the foregoing basic configuration.

<<Structure in which Raw Gas Cannot Flow Straight in Connective Piping Section>>

As a configuration with a higher flame extinction effect, the following description will discuss a structure in which the raw gas does not flow straight in a normal state. In this configuration, the connective piping section 20 which connects the pressure reduction section 2 to the flame propagation suppression section 3 has a structure in which a flow path through which the raw gas passes is not straight. In this case, the connective piping section 20 has a T-shape branch structure. This configuration is preferable because propagation of a shock wave and detonation flame which are comparatively rich in property to propagate straight is easily suppressed.

The following description will discuss in detail configurations of the components of the present invention.

### <<Shock Absorption Section>>

The shock absorption section in the flame extinction device B has sufficient volume, pressure resistance, and explosion resistance to bring about functions of, in a case where a pressure is released from the pressure reduction section, mitigating the pressure change and processing the pressure change in the system. Descriptions of the shock absorption section here are substantially identical with those described in paragraphs <0294> and <0296> through <0298> in “Embodiment of second gist of present invention” described above.

### <<Connective Piping Section>>

Descriptions here of the connective piping section in the flame extinction device B are substantially identical with those described in paragraphs <0299> and <0300> in “Embodiment of second gist of present invention” described above.

### <<Flame Propagation Suppression Section>>

Descriptions here of the flame propagation suppression section and the pressure reduction section in the flame extinction device in accordance with the present invention are substantially identical with those described in paragraphs <0301> through <0321> in “Embodiment of second gist of present invention” described above.

### <<Silencing Device>>

In the pressure reduction section, it is possible to additionally provide a silencing mechanism in a case of expecting a pressure releasing effect by rupture of the rupture disk. Such a configuration is preferable from the viewpoint of suppressing noise to the surrounding area. As the silencing mechanism, it is possible to employ various kinds of silencers as appropriate. It is possible to employ any of types such as an absorption type and an interference type. For the absorption type, there is concern about deterioration due to influence by occurrence of detonation on a sound absorbing material. However, the absorption type silencing mechanism has a high sound pressure suppressive effect, and can be suitably used when noise suppression is particularly intended. Meanwhile, the interference type intends to achieve noise suppression by a shape thereof or the like. Although a sound pressure suppressive effect of the interference type silencing mechanism is not relatively high, it is possible to constitute an interference type member only by a metallic material. The interference type silencing mechanism can be used in a case where it is necessary to take into special consideration in terms of durability or the like.

Examples of the flame extinction device suitable for a combination with the photochemical reactor in the third gist of the present invention have been described above. Of course, it is possible to employ a combination with another flame extinction device. Thus, it is possible to further enhance the safety of the photochemical reactor, the production device for producing hydrogen and oxygen, and the method for producing hydrogen and oxygen in the third gist of the present invention.

### [Method for Producing Hydrogen and Oxygen]

In the production method for producing hydrogen and oxygen in accordance with an aspect of the present invention, hydrogen and oxygen are produced by introducing water into a tubular container, and externally irradiating the outer cylinder 511 with light using the photochemical reaction plant 100 (production device for producing hydrogen and oxygen) described above.

Condensate water in the generated mixed gas of hydrogen and oxygen is removed from the mixed gas by the condensate water removal device 120. Humidity of the mixed gas is adjusted as appropriate by the humidity reduction device 130 so that the humidity is suitable for separation of a hydrogen gas from the mixed gas. In the separator membrane device 140, the hydrogen gas is separated from the mixed gas. The separated hydrogen gas is used as a high-energy component, for example, as a raw material for synthesis of hydrocarbon. An oxygen gas separated from the mixed gas may be released to the atmosphere or may be used in a specific application. In the flow path for the mixed gas in the photochemical reaction plant 100, the flame extinction device 160 described above is disposed as appropriate. Even in a case where detonation of the mixed gas occurs, flame propagation can be retained in a region demarcated by the flame extinction device 160 in the flow path.

### [Main Points of Embodiment of Third Gist of Present Invention]

As is clear from the above descriptions, various aspects in the third gist of the present invention indicated below are included in the gist described in paragraphs <0086> through <0092>. That is, the photochemical reactor (501, 110) in accordance with a first aspect of the third gist of the present invention is a photochemical reactor for carrying out photochemical reaction, the photochemical reactor including: a columnar structure (inner cylinder 512); and a tubular container for accommodating a liquid, the tubular container housing the columnar structure and including an outer cylinder (511) which is constituted by a material that transmits light used in reaction, in the photochemical reactor, a photocatalyst that generates a high-energy substance from the liquid in the presence of light being provided on at least one of an outer peripheral surface of the columnar structure and an inner peripheral surface of the outer cylinder.

In the photochemical reactor in accordance with a second aspect of the third gist of the present invention, it is possible in the first aspect that: the columnar structure is an inner cylinder having both ends which are sealed.

In the photochemical reactor in accordance with a third aspect of the third gist of the present invention, it is possible in the second aspect that: an anti-light-reflective film is provided to an outer peripheral surface of the outer cylinder.

In the photochemical reactor in accordance with a fourth aspect of the third gist of the present invention, it is possible in the second aspect that: a light reflective film is provided to at least one of an inner peripheral surface and an outer peripheral surface of the inner cylinder.

In the photochemical reactor in accordance with a fifth aspect of the third gist of the present invention, it is possible in any one of the first aspect through the fourth aspect that: the liquid is water; and the photocatalyst is a photocatalyst for water decomposition reaction.

A production device for producing hydrogen and oxygen (photochemical reaction plant 100) in accordance with a sixth aspect of the third gist of the present invention may include: the photochemical reactor described in the fifth aspect; and a separator membrane device (140) that separates hydrogen and oxygen from a gas generated by the photochemical reactor.

The production device for producing hydrogen and oxygen in accordance with a seventh aspect of the third gist of the present invention, in the sixth aspect, may further include: a flame extinction device (160).

In the production device for producing hydrogen and oxygen in accordance with an eighth aspect of the third gist of the present invention, it is possible in the seventh aspect that the flame extinction device includes: a connective piping section (20) which is connected to a first pipe (10), a second pipe (22), and a third pipe (21), a raw gas passing through the first pipe and the second pipe; a flame propagation suppression section (3) that has a porous portion through which the raw gas passes, the flame propagation suppression section being provided on the first pipe side and/or the second pipe side when seen from the connective piping section; and a pressure reduction section (2) that is disposed at an end part of the third pipe, the pressure reduction section reducing an internal pressure of the third pipe in a case where the internal pressure has risen, the third pipe being not orthogonal to any of the first pipe and the second pipe.

In the production device for producing hydrogen and oxygen in accordance with a ninth aspect of the third gist of the present invention, it is possible in the seventh aspect that the flame extinction device includes: a connective piping section which is connected to a first pipe, a second pipe, and a third pipe, a raw gas passing through the first pipe and the second pipe; a flame propagation suppression section that has a porous portion through which the raw gas passes, the flame propagation suppression section being provided on the first pipe side and/or the second pipe side when seen from the connective piping section; and a pressure reduction section that is disposed at an end part of the third pipe, the pressure reduction section reducing an internal pressure of the third pipe by generating, at the end part, a reflected wave which interferes with an incident wave of a shock wave, the third pipe being not orthogonal to any of the first pipe and the second pipe.

In the production device for producing hydrogen and oxygen in accordance with a tenth aspect of the third gist of the present invention, it is possible in the seventh aspect that the flame extinction device includes: a connective piping section which is connected to a first pipe, a second pipe, and a third pipe, a raw gas passing through the first pipe and the second pipe; a flame propagation suppression section that has a porous portion through which the raw gas passes, the flame propagation suppression section being provided on the first pipe side and/or the second pipe side when seen from the connective piping section; and a pressure reduction section that is disposed at an end part of the third pipe, the pressure reduction section reducing an internal pressure of the third pipe in a case where the internal pressure has risen; and a shock absorption section (9) that surrounds and/or makes contact with the pressure reduction section, the shock absorption section receiving a pressure released when the pressure reduction section reduces the internal pressure.

In the production method for producing hydrogen and oxygen in accordance with an 11th aspect of the third gist of the present invention, it is possible that: hydrogen and oxygen are produced by causing water to be present in a space between the outer cylinder and the columnar structure of the photochemical reactor of the production device described in any one of the sixth aspect through the 10th aspect, and externally irradiating the outer cylinder with light.

The third gist of the present invention is not limited to the embodiments described above, but may be altered in various ways by a skilled person within the scope of the claims. Any embodiment derived from a proper combination of technical means disclosed in different embodiments is also encompassed in the technical scope of the third gist of the present invention.

### [Embodiment of Fourth Gist of Present Invention]

The following description will discuss an embodiment with reference to the drawings.

### [Photochemical Reaction Plant]

The following description will discuss an embodiment with reference to FIG. 1. FIG. 1 is a diagram schematically illustrating a configuration of a photochemical reaction plant 100 in accordance with an embodiment of the present invention. Among the configurations of the photochemical reaction plant 100 in the present embodiment, the descriptions of the configurations illustrated in FIG. 1 are substantially identical with those described in paragraphs <0362> and <0367> in “Embodiment of third gist of present invention” described above.

### [Hydrogen-Oxygen Production Device]

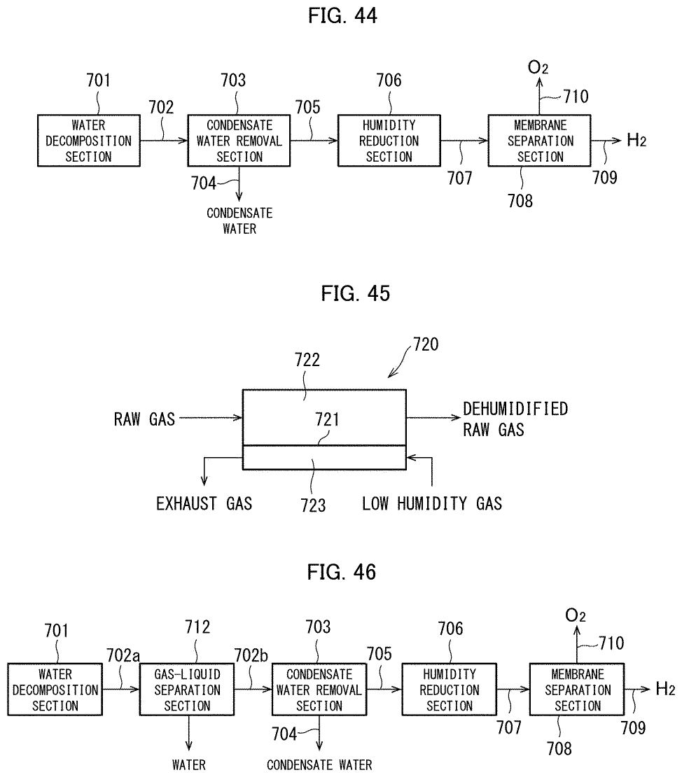

FIG. 44 is a diagram schematically illustrating a configuration of a hydrogen-oxygen production device in accordance with a first embodiment. The hydrogen-oxygen production device includes a water decomposition section 701 that generates hydrogen and oxygen by decomposing water with a photocatalyst. The hydrogen-oxygen production device in accordance with the first embodiment further includes a condensate water removal section 703, a humidity reduction section 706, and a membrane separation section 708. The sections of the hydrogen-oxygen production device in accordance with the first embodiment are disposed, from upstream, in the order of the water decomposition section 701, the condensate water removal section 703, the humidity reduction section 706, and the membrane separation section 708. In the hydrogen-oxygen production device in accordance with the first embodiment, a pipe 702 is provided between the water decomposition section 701 and the condensate water removal section 703, a pipe 705 is provided between the condensate water removal section 703 and the humidity reduction section 706, a pipe 707 is provided between the humidity reduction section 706 and the membrane separation section 708, and a pipe 709 is provided downstream of the membrane separation section 708. The pipe 702 guides the gas from the water decomposition section 701 to the condensate water removal section 703. The pipe 705 guides the gas from the condensate water removal section 703 to the humidity reduction section 706. The pipe 709 guides the gas from the humidity reduction section 706 to the membrane separation section 708. The hydrogen-oxygen production device corresponds to the photochemical reaction plant 100 described above. The water decomposition section 701 corresponds to a member included in the photochemical reaction device 110 described above. The humidity reduction section 706 corresponds to the humidity reduction device 130 described above. The membrane separation section 708 corresponds to the separator membrane device 140 described above.

In the water decomposition section 701 in this embodiment, hydrogen and oxygen are generated by irradiating the photocatalyst and water with sunlight. A raw gas containing generated hydrogen and oxygen and water vapor generated by evaporation of the water or further water droplets entrained in the gas is introduced into the condensate water removal section 703 via the pipe 702. While the raw gas passes through the pipe 702, a part of the water vapor may condense and form a liquid. Thus, the water decomposition section 701 decomposes water by a photocatalyst, and generates a gas containing hydrogen and oxygen. The pipe 702 is preferably provided in a downslope manner toward the water decomposition section 701 from the viewpoint of preventing retention of condensate water (prevention of pressure loss due to retention of condensate water in the pipe 702) and reuse of condensate water.

The condensate water removal section 703 may be, but not limited to, a drain trap, a gas trap, or the like. A condensation means (condensation device), in which water vapor in the raw gas is condensed by a cooling means (cooling device) such as a chiller, may be provided to an upstream side of the drain trap, gas trap, or the like. Thus, the condensate water removal section 703 carries out a condensate water removal process with respect to the gas supplied from the water decomposition section 701.

The condensate water separated from the gas in the condensate water removal section 703 is taken out from the condensate water removal section 703 through the pipe 704, and is preferably returned to the water decomposition section 701. Note, however, that the condensate water may be discharged to the outside of the system.

In order to return the condensate water to the water decomposition section 701, it is possible to employ a configuration in which the condensate water removal section 703 is disposed at a position higher than the water decomposition section 701 so that the condensate water passes through the pipes 702 and 704 by gravity to the water decomposition section 701. (In a second embodiment described later, the gas-liquid separation section 712 and the condensate water removal section 703 may be arranged in a similar manner.) In a case where condensate water is returned to the water decomposition section 701, it is possible to carry out a purification process such as filtration or distillation.

In a case where a drain (condensate water) trap is used in the condensate water removal section 703, a pressure of the drain trap is preferably −100 kPaG to −10 kPaG, 10 kPaG to 980 kPaG.

The gas from which the condensate water has been removed by the condensate water removal section 703 is supplied to the humidity reduction section 706 via the pipe 705. As the humidity reduction section 706, it is possible to use a moisture adsorption tower that has a hygroscopic material (such as silica gel) which adsorbs moisture, a membrane gas dryer, a water vapor selective permeation tube described in Japanese Patent Application Publication Tokukai No. 2017-213477, or the like. As the humidity reduction section 706, it is possible to use a relative humidity reduction means for raising a temperature of the gas by a temperature raising means such as a heater (e.g., a heat exchanger). As such, the humidity reduction section 706 carries out a humidity reduction process with respect to the gas from the condensate water removal section 703.

FIG. 45 is a diagram schematically illustrating an example of a configuration of a membrane gas dryer. The membrane gas dryer 720 includes chambers 722 and 723 which are partitioned by a water vapor permeable membrane 721. The raw gas is caused to pass through the one chamber 722 and a low humidity gas is caused to pass through the other chamber 723, and thus a water vapor concentration in the raw gas is reduced. As the low humidity gas, it is possible to use air which has been cooled by a cooler for dehumidification, or air which has been heated by a heater.

The gas (preferably a gas in which a water vapor pressure is lower than a saturated water vapor pressure at a separator membrane operating temperature (gas temperature in separator membrane)) in which humidity has been reduced in the humidity reduction section 706 is introduced into the membrane separation section 708 via the pipe 707. The membrane separation section 708 separates, by membrane, hydrogen and/or oxygen from the gas supplied from the humidity reduction section 706. The membrane separation section 708 is provided with a module for separating a hydrogen gas and an oxygen gas. The hydrogen-rich gas is taken out from the pipe 709, and the oxygen-rich gas is taken out from the pipe 710.

FIG. 46 is a diagram schematically illustrating a configuration of a hydrogen-oxygen production device in accordance with a second embodiment. In the second embodiment, the raw gas from the water decomposition section 701 is introduced into the gas-liquid separation section 712 via a pipe 702a, and after liquid water in the raw gas is separated, the raw gas is supplied to the condensate water removal section 703 via a pipe 702b. The other configurations are identical with those illustrated in FIG. 2, and the same reference signs indicate the same components. In the second embodiment, the hydrogen-oxygen production device further includes a gas-liquid separation section 712 between the water decomposition section 701 and the condensate water removal section 703. The gas is introduced into the gas-liquid separation section 712 from the water decomposition section 701, and the gas-liquid separation section 712 separates a liquid from the gas containing hydrogen and oxygen generated by the water decomposition section 701. The pipe 702a is provided between the water decomposition section 701 and the gas-liquid separation section 712 so as to guide the gas from the water decomposition section 701 to the gas-liquid separation section 712. The pipe 702b is provided between the gas-liquid separation section 712 and the condensate water removal section 703 so as to guide the gas from the gas-liquid separation section 712 to the condensate water removal section 703. The pipe 702a is preferably provided in a downslope manner toward the water decomposition section 701 from the viewpoints of preventing retention of condensate water and entrained water in the pipe 702 which would cause a pressure loss and, in addition, reusing water by returning the condensate water.

In this embodiment, the gas-liquid separation section 712 is provided. Therefore, an amount of liquid moisture in the exhaust gas introduced into the condensate water removal section 703 is markedly reduced. This makes it possible to reduce a load of the humidity reduction section and to keep a low amount of water vapor in the gas introduced into the membrane separation section 708.

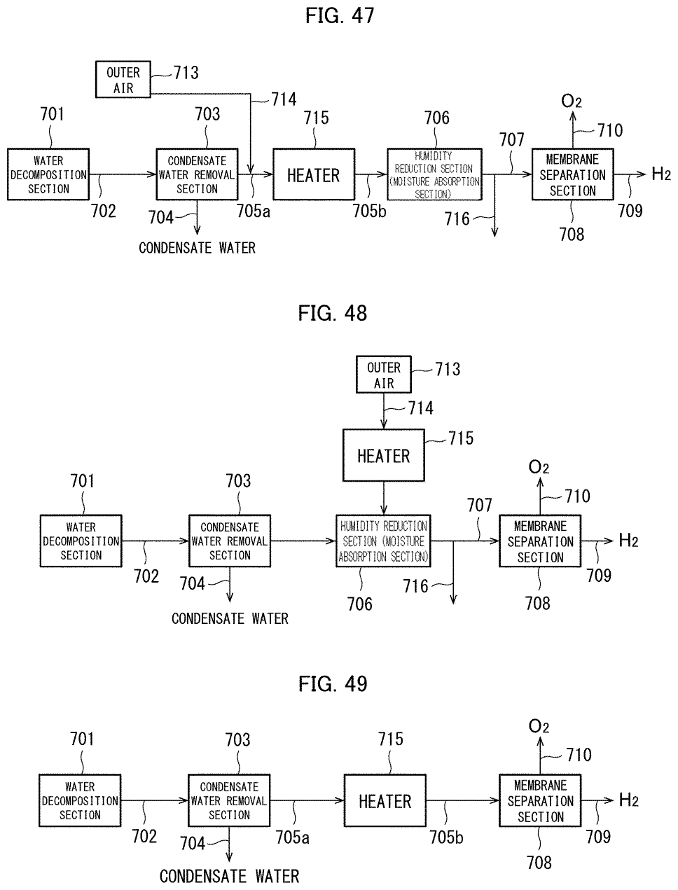

FIG. 47 illustrates a configuration of a hydrogen-oxygen production device in accordance with a third embodiment. In this hydrogen-oxygen production device, the humidity reduction section 706 includes a moisture absorption section using a hygroscopic material (such as silica gel) that adsorbs moisture. Hereinafter the “humidity reduction section” is also referred to as a “moisture absorption section”. The humidity reduction section 706 preferably includes a hygroscopic material that adsorbs moisture from the viewpoint of avoiding use of energy due to temperature rise and temperature drop.

A heater 715 for raising a temperature of gas is provided upstream of the moisture absorption section 706. The gas from the condensate water removal section 703 is introduced into the moisture absorption section 706 via a pipe 705a, the heater 715, and a pipe 705b. The heater 715 can be, but not limited to, a heat exchanger or the like.

In this embodiment, included are: an outer air supply pipe 713 such as a blower for supplying outer air (atmospheric air); and a pipe 714 for guiding the outer air to the pipe 705a. The pipes 705a and 14 are provided with a flow path switching means (not illustrated) such as a valve for introducing only one of the raw gas from the water decomposition section 701 and outside air from the outer air supply pipe 713 into the heater. The outer air is a regenerative gas for removing moisture from the hygroscopic material included in the humidity reduction section 706. The outer air supply pipe 713 may be a known outer air supply device (e.g., a blower) for supplying outer air. The flow path switching means may be a known flow path switching device, (e.g., a flow path switching valve) for switching a flow path.

In addition, in this embodiment, a pipe 716 for releasing a high humidity exhaust gas from the moisture absorption section 706 to the outside of the system is branch from the pipe 707. The pipes 707 and 716 are provided with a flow path selection means (not illustrated) such as a valve for switching the gas from the moisture absorption section 706 between flow path selection for guiding the gas from the pipe 707 to the membrane separation section 708 and flow path selection for discharging the gas from the pipe 716. The other configurations in FIG. 47 are identical with those illustrated in FIG. 44, and the same reference signs indicate the same components.

In FIG. 47, in the daytime when being irradiated with sunlight, the outer air supply pipe 713 is stopped, and the raw gas from the water decomposition section 701 is supplied from the pipe 702 to the condensate water removal section 703. The heater 715 is stopped.

In the nighttime when being not irradiated with sunlight or in a case where it is necessary to regenerate the hygroscopic material of the moisture absorption section 706 (moisture removal process), introduction of the raw gas from the water decomposition section 701 is stopped, the outer air supply pipe 713 and the heater 715 are activated, and outer air is supplied through the condensate water removal section 703 and the heater 715 to the moisture absorption section 706 as warmed air with low humidity.

By causing the warmed air from the heater 715 to pass through the moisture absorption section 706, moisture which has been adsorbed by the hygroscopic material of the moisture absorption section 706 is removed, and is discharged to the outside of the system through the pipe 716. Thus, the hygroscopic material of the moisture absorption section 706 is regenerated.

The raw gas described herein refers to a whole of or a part of a fluid that is supplied into a part of interest in a normal state. For example, in FIG. 44, a fluid that passes from the water decomposition section 701 through the pipe 702 and reaches the condensate water removal section 703 can be a gas such as hydrogen, oxygen, or water vapor, or water as a liquid in the form of spray or droplets that is entrained in the gas. All of or a part of these may be referred to as a raw gas.

FIG. 48 illustrates an example case in which a position of outer air to be introduced for regeneration of the moisture absorption section 706 is changed. FIG. 49 illustrates an example case in which the heater 715 is provided instead of the moisture absorption section 706, and a temperature of the raw gas is increased to lower relative humidity, and the raw gas is then supplied to the membrane separation section 708.

For the atmospheric air for regeneration described above, a means for removing water vapor in the atmospheric air by a cooling means such as a chiller may be provided at the upstream side. It is possible to use the atmospheric air after removing impurities (such as carbon dioxide, oil, and dust) contained therein.

As the gas for regenerating the hygroscopic material of the moisture absorption section 706, it is possible to use a hydrogen gas, as well as the foregoing atmospheric air, in order to avoid retention of atmospheric air in the moisture absorption section 706 after regeneration and the humidity reduction section 706. Alternatively, after regeneration is carried out using atmospheric air, the gas in the system may be replaced with a hydrogen gas.

In general, the separation performance of a gas separator membrane is usually impaired due to adsorption of water to small pores having separation activity or the like, regardless of the quality of material of the gas separator membrane. For dehumidification operation in the humidity reduction section 706, it is preferable to adjust relative humidity in order to properly suppress a decrease in characteristics of the separator membrane. The relative humidity is preferably approximately 1% RH or less, more preferably approximately 0.8% RH or less, further preferably approximately 0.6% RH or less, most preferably approximately 0.4% RH or less. Meanwhile, it is not preferable to achieve an excessively low relative humidity, because a dehumidification process is to be excessively carried out. Therefore, the relative humidity is preferably approximately 0.1% RH or more, more preferably approximately 0.2% RH or more, further preferably approximately 0.3% RH or more, most preferably approximately 0.4% RH or more.

### <Flame Extinction Device>

The hydrogen-oxygen production device in accordance with an aspect of the present invention preferably includes a flame extinction device. Descriptions here of the flame extinction device are identical with those described in paragraphs <0401> through <0422> of the embodiment in the “third gist of the present invention” described above.

### [Hydrogen-Oxygen Production Method]

In the hydrogen-oxygen production method in accordance with an aspect of the present invention, the hydrogen-oxygen production device described above is used to produce hydrogen and oxygen.

Condensate water in the generated mixed gas of hydrogen and oxygen is removed from the mixed gas by the condensate water removal device 120. Humidity of the mixed gas is adjusted as appropriate by the humidity reduction device 130 so that the humidity is suitable for separation of a hydrogen gas from the mixed gas. In the separator membrane device 140, the hydrogen gas is separated from the mixed gas. The separated hydrogen gas is used as a high-energy component, for example, as a raw material for synthesis of hydrocarbon. An oxygen gas separated from the mixed gas may be released to the atmosphere or may be used in a specific application. In the flow path for the mixed gas in the photochemical reaction plant 100, the flame extinction device 160 described above is disposed as appropriate. Even in a case where detonation of the mixed gas occurs, flame propagation can be retained in a region demarcated by the flame extinction device 160 in the flow path.

The hydrogen-oxygen production method in accordance with an aspect of the present invention preferably includes a hydrogen-oxygen production step and a hygroscopic material regeneration step. In the hydrogen-oxygen production step, a regenerative gas supply means (outer air supply pipe 713) is stopped, and the gas from the water decomposition section 701 is processed to obtain hydrogen and oxygen from the membrane separation section 708. In the hygroscopic material regeneration step, gas supply from the water decomposition section 701 is stopped, the regenerative gas supply means (outer air supply pipe 713) is activated, and moisture adsorbed by the hygroscopic material is removed. The hydrogen-oxygen production method in accordance with an aspect of the present invention preferably includes a hygroscopic material regeneration step from the viewpoint of maintaining a state in which the hygroscopic material can adsorb moisture and sufficiently reducing an amount of moisture contained in the ultimate gas.

From the viewpoint of efficiently producing hydrogen and oxygen in which the amount of moisture has been sufficiently reduced, it is preferable that the production step is carried out during the daytime, and the hygroscopic material regeneration step is carried out during the nighttime. In a case where a photocatalyst exerts catalytic ability by sunlight, the photocatalyst is irradiated with sunlight in the daytime, and the photocatalyst operates to cause water decomposition reaction and generate the gas. Therefore, the daytime is suitable as a time to carry out the production step. The photocatalyst is not irradiated with sunlight in the nighttime, and the photocatalyst does not operate. Therefore, water decomposition reaction does not occur and the gas is not generated. Therefore, the nighttime is suitable as a time to carry out the hygroscopic material regeneration step. In a case where light other than sunlight is used, during a period of being irradiated with the light, the catalyst operates to cause water decomposition reaction and generate the gas. Therefore, it is preferable to carry out the production step during such a period.

During a period in which the photocatalyst is not irradiated with the light, the photocatalyst does not operate. Therefore, water decomposition reaction does not occur and the gas is not generated. Therefore, it is preferable to carry out the hygroscopic material regeneration step during such a period. That is, the hygroscopic material regeneration step may be carried out in a state where operation of the water decomposition section 701 is stopped and generation of the gas does not occur, regardless of the presence or absence of sunlight.

### [Main Points of Embodiment of Fourth Gist of Present Invention]

As is clear from the above descriptions, various aspects in the fourth gist of the present invention indicated below are included in the gist described in paragraphs <0093> through <0102>. That is, the hydrogen-oxygen production device (100) in accordance with a first aspect of the fourth gist of the present invention includes: a water decomposition section (701) that generates a gas containing hydrogen and oxygen by decomposing water with a photocatalyst; a condensate water removal section (703) that carries out a condensate water removal process with respect to the gas supplied from the water decomposition section; a humidity reduction section (706) that carries out a humidity reduction process with respect to the gas supplied from the condensate water removal section; and a membrane separation section (708) that separates, by a membrane, hydrogen and/or oxygen from the gas supplied from the humidity reduction section.

The hydrogen-oxygen production device in accordance with a second aspect of the fourth gist of the present invention may, in the first aspect, further include: a gas-liquid separation section (712) into which the gas is introduced from the water decomposition section, the gas which has passed through the gas-liquid separation section being introduced into the condensate water removal section.

The hydrogen-oxygen production device in accordance with a third aspect in the fourth gist of the present invention may, in the first aspect, further include: a pipe (702) for guiding the gas from the water decomposition section to the condensate water removal section, the pipe being provided in a downslope manner toward the water decomposition section.

The hydrogen-oxygen production device in accordance with a fourth aspect in the fourth gist of the present invention may, in the second aspect, further include: a pipe (702a) for guiding the gas from the water decomposition section to the gas-liquid separation section, the pipe being provided in a downslope manner toward the water decomposition section.

In the hydrogen-oxygen production device in accordance with a fifth aspect in the fourth gist of the present invention, it is possible in any one of the first aspect through the fourth aspect that: the humidity reduction section includes a hygroscopic material that adsorbs moisture.

The hydrogen-oxygen production device in accordance with a sixth aspect in the fourth gist of the present invention may, in the fifth aspect, further include: a regenerative gas supply means (713) for supplying a regenerative gas for removing moisture from the hygroscopic material.

The hydrogen-oxygen production device in accordance with a seventh aspect of the fourth gist of the present invention may, in the first aspect, further include: a flame extinction device (160).

In the hydrogen-oxygen production device in accordance with an eighth aspect of the fourth gist of the present invention, it is possible in the seventh aspect that the flame extinction device includes: a connective piping section (20) which is connected to a first pipe (10), a second pipe (22), and a third pipe (21), a raw gas passing through the first pipe and the second pipe; a flame propagation suppression section (3) that has a porous portion through which the raw gas passes, the flame propagation suppression section being provided on the first pipe side and/or the second pipe side when seen from the connective piping section; and a pressure reduction section (2) that is disposed at an end part of the third pipe, the pressure reduction section reducing an internal pressure of the third pipe in a case where the internal pressure has risen, the third pipe being not orthogonal to any of the first pipe and the second pipe.

In the production device for producing hydrogen and oxygen in accordance with a ninth aspect of the fourth gist of the present invention, it is possible in the seventh aspect that the flame extinction device includes: a connective piping section which is connected to a first pipe, a second pipe, and a third pipe, a raw gas passing through the first pipe and the second pipe; a flame propagation suppression section that has a porous portion through which the raw gas passes, the flame propagation suppression section being provided on the first pipe side and/or the second pipe side when seen from the connective piping section; and a pressure reduction section that is disposed at an end part of the third pipe, the pressure reduction section reducing an internal pressure of the third pipe by generating, at the end part, a reflected wave which interferes with an incident wave of a shock wave, the third pipe being not orthogonal to any of the first pipe and the second pipe.

In the hydrogen-oxygen production device in accordance with a tenth aspect of the fourth gist of the present invention, it is possible in the seventh aspect that the flame extinction device includes: a connective piping section which is connected to a first pipe, a second pipe, and a third pipe, a raw gas passing through the first pipe and the second pipe; a flame propagation suppression section that has a porous portion through which the raw gas passes, the flame propagation suppression section being provided on the first pipe side and/or the second pipe side when seen from the connective piping section; and a pressure reduction section that is disposed at an end part of the third pipe, the pressure reduction section reducing an internal pressure of the third pipe in a case where the internal pressure has risen; and a shock absorption section (9) that surrounds and/or makes contact with the pressure reduction section, the shock absorption section receiving a pressure released when the pressure reduction section reduces the internal pressure.

The hydrogen-oxygen production method in accordance with an 11th aspect of the fourth gist of the present invention may produce hydrogen and oxygen by using the hydrogen-oxygen production device described in any one of the first aspect through the 10th aspect.

The hydrogen-oxygen production method in accordance with a 12th aspect of the fourth gist of the present invention may use the hydrogen-oxygen production device described in the sixth aspect, and the hydrogen-oxygen production method may include: a hydrogen-oxygen production step of stopping the regenerative gas supply means, processing the gas supplied from the water decomposition section, and obtaining hydrogen and oxygen from the membrane separation section; and a hygroscopic material regeneration step of stopping supply of the gas from the water decomposition section, activating the regenerative gas supply means, and removing moisture adsorbed by the hygroscopic material.

In the hydrogen-oxygen production method in accordance with a 13th aspect in the fourth gist of the present invention, it is possible in the 12th aspect that: the hydrogen-oxygen production step is carried out during the daytime, and the hygroscopic material regeneration step is carried out during the nighttime.

The fourth gist of the present invention is not limited to the embodiments described above, but may be altered in various ways by a skilled person within the scope of the claims. Any embodiment derived from a proper combination of technical means disclosed in different embodiments is also encompassed in the technical scope of the fourth gist of the present invention.

### EXAMPLES

### [Examples of First Gist of Present Invention]

The following description will discuss in more detail the first gist of the present invention, with reference to Examples.

### Example 1-1

In order to confirm the effect of the flame extinction mechanism schematically illustrated in FIG. 4, the following experiment was carried out. In the following descriptions, the terms “upstream” and “downstream” refer to a direction in which a gas mainly passes through in a normal state, in which detonation and the like do not occur.

At the upstream side of the first pipe 10, the following devices were disposed for convenience of the experiment. At the most upstream side, a premixer for mixing a gas with which an arbitrary gas could be adjusted to have an intended pressure was disposed. At the gas outlet of the premixer, a valve was prepared and a discharging electrode for ignition was prepared on the further downstream side.

To the downstream side thereof, the first pipe illustrated in the drawings was connected, and at the downstream side of the first pipe, the flame propagation suppression section 3 was disposed. The connective piping section 20 having a T-shape was disposed downstream of the flame propagation suppression section. The pressure reduction section 2 was disposed on one downstream side of the connective piping section (on the straight line from the first pipe). The second pipe 22 was disposed at the other downstream side of the connective piping section.

At the further downstream side of the second pipe (not illustrated), high-speed and highly-sensitive pressure sensor and temperature sensor were disposed for convenience of the experiment so as to be able to confirm whether flame intentionally generated using the discharging electrode for ignition reached the second pipe.

In the configuration, the first pipe was made of polyvinyl chloride, and a gas passage part thereof had a circular cross section, an inside diameter of 1 cm, a cross-sectional area of approximately 0.875 cm², a length of 100 cm, and pressure resistance of 8 MPa(G). The same applied to the connective piping section and the second pipe. These pipes were transparent, and the above devices were configured so that flame propagation or flame extinction could be confirmed visually or by a high-speed camera.

In the flame propagation suppression section, a bent flow path was prepared in a metallic housing. A part of the flow path was provided with a narrowed portion having an inside diameter of 0.2 cm and a cross-sectional area of approximately 0.0314 cm². A metal sintered body was disposed downstream from the narrowed portion. The metal sintered body was configured such that, in the metal sintered body, a large number of small pores were intentionally provided so that passage of gas in a normal state could be achieved while avoiding occurrence of an excessive pressure loss. The metal sintered body had a substantially columnar three-dimensional outer shape (height: 18 mm) with a substantially columnar internal space that penetrated from top to bottom at a center in a radial direction of the metal sintered body. A gas passage direction in a normal state, in which detonation and the like do not occur, was set as follows. That is, the gas passes substantially radially through the metal sintered body having a thickness of approximately 3.5 mm from the internal space side toward the outer surface. The small pores in the metal sintered body are randomly connected to each other. Thus, the metal sintered body was configured so that the gas was caused to ultimately pass through in a random direction from the internal space side toward the outer surface. The metal sintered body was configured so as to have gaps each having a width of 0.50 μm or more and 2.45 μm or less, simultaneously have gaps of 50 μm to 100 μm, in a longitudinal direction thereof on the surface of the metal sintered body used.

In the pressure reduction section, as a pressure release device, a rupture disk unit was used which included a rupture disk. A burst pressure of the rupture disk was 0.5 MPa(G).

In order to confirm the flame extinction effect by this flame extinction mechanism, hydrogen and oxygen were directly mixed in a ratio of 2 to 1, without dilution, in the premixer. After that, the whole flame extinction mechanism section illustrated in the drawing was filled with the mixed gas of hydrogen:oxygen=2:1, and a pressure thereof was increased to 0.2 MPa(G). After completion of pressure adjustment, the valve disposed at the gas outlet of the premixer was closed, and thus preparation for ignition was completed. After that, the discharging electrode connected to a neon-sign transformer was caused to discharge electricity, and thus ignited the 0.2 MPa(G) hydrogen-oxygen mixed gas.

At the occurrence of detonation, a detonation sound pressure measured at a location approximately 1 m away from the above device was approximately 87 db. When confirmed with the pressure sensor and the temperature sensor disposed at the further downstream side of the second pipe, the flame did not propagate to the second pipe. The rupture disk did not rupture, and no gas leaked to the outside of the system. A pressure loss of the flame propagation suppression mechanism in a normal state which was separately measured was sufficiently small, i.e., 30 kPa (G) during the passage of gas at approximately 10 L/min.

### [Reference Example 1-1] (Measurement of Explosion Velocity)

The following points were changed from Example 1-1, and the explosion velocity at occurrence of detonation was measured. The flame propagation suppression section was not disposed, and the first pipe 10 and the connective piping section 20 were directly connected to each other. The pressure of the mixed gas of hydrogen:oxygen=2:1 with which the measurement system was filled was reduced to 0.0 MPa(G) (atmospheric pressure). Here, the flame propagation velocity measured with the high-speed camera in the first pipe was approximately 6500 m/sec. That is, it can be said that, in the case of this Reference Example 1-1, detonation definitely occurred. Furthermore, it can be inferred that the detonation had greater power in Example 1-1, considering that the initial pressure of the mixed gas was 0.2 MPa(G) which was higher than that of this Reference Example 1-1. Thus, it can be found that the flame extinction mechanism of the present invention can suppress also flame propagation due to detonation of the pressurized hydrogen-oxygen mixed gas which has greater power than a normal state.

### Example 1-2

At the upstream side of the first pipe 10, a photocatalyst panel (reactor) for artificial photosynthesis was provided which included a photocatalyst that can decompose water into hydrogen and oxygen by irradiation with sunlight and contact with the water (or water vapor). From the photocatalyst panel (reactor) for artificial photosynthesis, a hydrogen-oxygen water vapor mixed gas was generated which contained saturated water vapor with a composition of hydrogen:oxygen=2:1. In order to transport the hydrogen-oxygen water vapor mixed gas to the downstream side, a pressure thereof was adjusted to 0.2 MPa(G). Under such conditions, deflagration or detonation may occur upon ignition of the mixed gas. Therefore, it is necessary to provide a flame extinction mechanism which is more powerful than conventional ones.

In view of this, as with Example 1-1, the flame propagation suppression section 3 was disposed at the downstream side of the first pipe 10. The connective piping section having a T-shape was disposed downstream of the flame propagation suppression section. The pressure reduction section was disposed on one downstream side of the connective piping section (on the straight line from the first pipe). The second pipe was disposed at the other downstream side of the connective piping section.

Here, the first pipe was made of stainless steel, and a gas passage part thereof had a circular cross section, an inside diameter of 1.07 cm, a cross-sectional area of approximately 0.900 cm², a length of 20 cm, and pressure resistance of 21.6 MPa(G). A part of the connective piping section which was joined to the first pipe was configured similarly to the first pipe. Meanwhile, the second pipe had an inside diameter of 2.39 cm, a cross-sectional area of approximately 4.486 cm², a length of 120 m, and pressure resistance of 14.5 MPa(G). A part of the connective piping section which was joined to the second pipe was configured similarly to the second pipe.

In the flame propagation suppression section, a bent flow path was prepared in a metallic housing. A part of the flow path was provided with a narrowed portion having an inside diameter of 0.3 cm and a cross-sectional area of approximately 0.0707 cm². A metal sintered body was disposed downstream from the narrowed portion. In the metal sintered body, a large number of small pores were intentionally provided so that passage of gas in a normal state could be achieved while avoiding occurrence of an excessive pressure loss.

The metal sintered body had a substantially columnar three-dimensional outer shape (height: 46 mm) with a substantially columnar internal space that penetrated from top to bottom at a center in a radial direction of the metal sintered body. A gas passage direction in a normal state, in which detonation and the like do not occur, was set as follows. That is, the gas passes substantially radially through the metal sintered body having a thickness of approximately 5.1 mm from the external space side toward the inner surface. Meanwhile, the small pores in the metal sintered body are randomly connected to each other. Thus, the gas is caused to ultimately pass through in a random direction.

The metal sintered body was configured so as to have gaps each having a width of 0.50 μm or more and 2.45 μm or less, simultaneously have gaps of 50 μm to 100 μm, in a longitudinal direction thereof on the surface of the metal sintered body used.

In the pressure reduction section, as pressure release device, a rupture disk unit was used which included a rupture disk. A burst pressure of the rupture disk was 0.5 MPa(G).

In the photocatalyst panel (reactor) for artificial photosynthesis including such a flame extinction mechanism, flame ignited at the first pipe side does not propagate to the second pipe 22 side. Flame ignited on the second pipe side does also not propagate to the first pipe side, and breakage of various apparatuses disposed at the further upstream side is suppressed.

### Example 1-3

In order to confirm the effect of the flame extinction mechanism schematically illustrated in FIG. 2, a flame extinction mechanism was constituted in a manner similar to that in Example 1-1, except that the following points were changed, and an effect confirmation experiment for the mechanism was carried out.

The connective piping section 20 having a T-shape was disposed at the downstream side of the first pipe 10. The pressure reduction section was disposed on one downstream side of the connective piping section (on the straight line from the first pipe). The flame propagation suppression section 3 was disposed at the other downstream side of the connective piping section. The second pipe 22 was disposed at the further downstream side of the flame propagation suppression section. The length of the first pipe was changed to 200 cm.

At the occurrence of detonation, a detonation sound pressure measured at a location approximately away from the above device was approximately 132 db. When confirmed with the pressure sensor and the temperature sensor disposed at the further downstream side of the second pipe, the flame did not propagate to the second pipe. The rupture disk ruptured, and thus the pressure releasing effect of the rupture disk unit was also confirmed. A pressure loss of the flame propagation suppression mechanism in a normal state which was separately measured was sufficiently small, i.e., 30 kPa (G) during the passage of gas at approximately 10 L/min.

### [Reference Example 1-2] (Measurement of Explosion Velocity)

The following points were changed from Example 1-3, and the explosion velocity at occurrence of detonation was measured. The flame propagation suppression section was not disposed, and the connective piping section 20 and the second pipe 22 were directly connected to each other. The pressure of the mixed gas of hydrogen:oxygen=2:1 with which the measurement system was filled was reduced to 0.0 MPa(G) (atmospheric pressure). Here, the flame propagation velocity measured with the high-speed camera in the first pipe was approximately 5300 m/sec. That is, it can be said that, in the case of this Reference Example 1-2, detonation definitely occurred. Furthermore, it can be inferred that the detonation had greater power in Example 1-3, considering that the initial pressure of the mixed gas was 0.2 MPa(G) which was higher than that of this Reference Example 1-2. Thus, it can be found that the flame extinction mechanism of the present invention can suppress also flame propagation due to detonation of the pressurized hydrogen-oxygen mixed gas which has greater power than a normal state.

### Example 1-4

A flame extinction mechanism was constituted in a manner similar to that in Example 1-3, except that a burst pressure of the rupture disk in the rupture disk unit, which was used as a pressure release device in the pressure reduction section 2, was 4 MPa(G), and a flame extinction effect confirmation experiment for the mechanism was carried out. At the occurrence of detonation, a detonation sound pressure measured at a location approximately 1 m away from the above device was approximately 131 db. When confirmed with the pressure sensor and the temperature sensor disposed at the further downstream side of the second pipe 22, the flame did not propagate to the second pipe. The rupture disk ruptured, and thus the pressure releasing effect of the rupture disk unit was also confirmed.

### Example 1-5

A flame extinction mechanism was constituted in a manner similar to that in Example 1-3, except that a burst pressure of the rupture disk in the rupture disk unit, which was used as a pressure release device in the pressure reduction section 2, was 7 MPa(G), and a flame extinction effect confirmation experiment for the mechanism was carried out. At the occurrence of detonation, a detonation sound pressure measured at a location approximately 1 m away from the above device was approximately 84.3 db. When confirmed with the pressure sensor and the temperature sensor disposed at the further downstream side of the second pipe, the flame did not propagate to the second pipe. The rupture disk did not rupture, and no gas leaked to the outside of the system.

### Example 1-6

A flame extinction mechanism was constituted in a manner similar to that in Example 1-2, except for changing the following points, and a flame extinction mechanism which was more powerful than conventional ones was mounted on a photocatalyst panel (reactor) for artificial photosynthesis. The connective piping section 20 having a T-shape was disposed at the downstream side of the first pipe 10. The pressure reduction section 2 was disposed on one downstream side of the connective piping section (on the straight line from the first pipe). The flame propagation suppression section 3 was disposed at the other downstream side of the connective piping section. The second pipe 22 was disposed at the further downstream side of the flame propagation suppression section. Thus, the basic configuration was similar to the aspect illustrated in FIG. 2.

Here, the first pipe was made of stainless steel, and a gas passage part thereof had a circular cross section, an inside diameter of 2.39 cm, a cross-sectional area of approximately 4.486 cm², a length of 120 m, and pressure resistance of 14.5 MPa(G). A part of the connective piping section which was joined to the first pipe was configured similarly to the first pipe. Meanwhile, the second pipe had an inside diameter of 3.94 cm, a cross-sectional area of approximately 12.186 cm², a length of 100 m, and pressure resistance of 10.2 MPa(G). The pressure resistance of a part of the connective piping section through which the gas passes to the second pipe side was similar to that of the second pipe. In the flame propagation suppression section, three flame propagation suppression parts were disposed in parallel.

In the photocatalyst panel (reactor) for artificial photosynthesis including such a flame extinction mechanism, flame occurred in the first pipe did not propagate to the second pipe, and flame occurred in the second pipe did not propagate to the first pipe. Thus, breakage of apparatuses and the like were suppressed.

### Example 1-7

An experiment was carried out to confirm the flame extinction effect of the mechanism in a manner similar to that in Example 1-5, except that a shutoff valve that operates in a case where a shock wave or flame propagates toward the downstream side was provided additionally to the flame propagation suppression section 3. At the occurrence of detonation, a detonation sound pressure measured at a location approximately 1 m away from the above device was approximately 95 db. When confirmed with the pressure sensor and the temperature sensor disposed at the further downstream side of the second pipe 22, the flame did not propagate to the second pipe. The shutoff valve that operates in a case where a shock wave or flame propagates toward the downstream side was confirmed to be closed. The rupture disk did not rupture, and no gas leaked to the outside of the system.

### Example 1-8

At the upstream side of the first pipe 10, a photocatalyst panel (reactor) for artificial photosynthesis was which included a provided photocatalyst that can decompose water into hydrogen and oxygen by irradiation with sunlight and contact with the water (or water vapor). From the photocatalyst panel (reactor) for artificial photosynthesis, a hydrogen-oxygen water vapor mixed gas was generated which contained saturated water vapor with a composition of hydrogen:oxygen=2:1. In order to transport the hydrogen-oxygen water vapor mixed gas to the downstream side, a pressure thereof was adjusted to 0.02 MPa(G) for pressurization. Under such conditions, deflagration or detonation may occur upon ignition of the mixed gas. Therefore, it is necessary to provide a flame extinction mechanism which is more powerful than conventional ones.

In view of this, as schematically illustrated in FIG. 3, a flame extinction device was used in which a connective piping section 20A and a pressure reduction section 2A were disposed also on the second pipe 22 side in a symmetrical manner with respect to the flame propagation suppression section 3. That is, the connective piping section 20 having a T-shape was disposed at the downstream side of the first pipe, and the pressure reduction section 2 was disposed on one downstream side of the connective piping section (on the straight line from the first pipe). The flame propagation suppression section 3 was disposed at the other downstream side of the connective piping section. The second pipe 22 was disposed at the downstream side of the flame propagation suppression section. At the further downstream side thereof, the connective piping section 20A having a T-shape (which may have the same shape as the connective piping section) was disposed. A rupture disk unit 2A (which may have the same shape as the pressure reduction section) was disposed at one downstream side of the T-shaped pipe, and a most-downstream pipe was disposed at the other side.

Here, the first pipe was made of stainless steel, and a gas passage part thereof had a circular cross section, an inside diameter of 0.78 cm, a cross-sectional area of approximately 0.478 cm², a length of 20 cm, and pressure resistance of 47.7 MPa(G). A part of the connective piping section which was joined to the first pipe was configured similarly to the first pipe. Meanwhile, the second pipe had an inside diameter of 3.57 cm, a cross-sectional area of approximately 4.486 cm², a length of 240 m, and pressure resistance of 18.0 MPa(G). The pressure resistance of a part of the connective piping section through which the gas passes to the second pipe was similar to that of the second pipe. The pressure resistance of the T-shaped pipe was similar to that of the second pipe.

In the flame propagation suppression section, a bent flow path was prepared in a metallic housing. A part of the flow path was provided with a narrowed portion having an inside diameter of 0.3 cm and a cross-sectional area of approximately 0.0707 cm². A metal sintered body was disposed downstream from the narrowed portion. In the metal sintered body, a large number of small pores were intentionally provided so that passage of gas in a normal state could be achieved while avoiding occurrence of an excessive pressure loss. The metal sintered body had a substantially columnar three-dimensional outer shape (height: 92 mm) with a substantially columnar internal space that penetrated from top to bottom at a center in a radial direction of the metal sintered body.

A gas passage direction in a normal state, in which detonation and the like do not occur, was set as follows. That is, the gas passes substantially radially through the metal sintered body having a thickness of approximately 8.5 mm from the external space side toward the inner surface. Meanwhile, the small pores in the metal sintered body are randomly connected to each other. Thus, the gas is caused to ultimately pass through in a random direction. The metal sintered body was configured so as to have gaps each having a width of 0.50 μm or more and 2.45 μm or less, simultaneously have gaps of 50 μm to 100 μm, in a longitudinal direction thereof on the surface of the metal sintered body used.

In the pressure reduction section, as a pressure release device, a rupture disk unit was used which included a rupture disk. A burst pressure of the rupture disk was 4 MPa(G).

In the photocatalyst panel (reactor) for artificial photosynthesis including such a flame extinction mechanism, flame occurred in the first pipe did not propagate to the second pipe or the most-downstream pipe, and flame occurred in the most-downstream pipe side did not propagate to the first pipe. Thus, breakage of apparatuses and the like were suppressed.

### Example 1-9

A flame extinction mechanism was constituted in a manner similar to that in Example 1-8, except for changing the following points, and a flame extinction mechanism which was more powerful than conventional ones was mounted on a photocatalyst panel (reactor) for artificial photosynthesis. FIG. 9 illustrates a schematic diagram. The form obtained included two flame extinction devices in accordance with the present invention which were connected to each other.

The connective piping section 20 having a T-shape was disposed at the downstream side of the first pipe 10, and the pressure reduction section 2 was disposed on one downstream side of the connective piping section (on the straight line from the first pipe). The flame propagation suppression section 3 was disposed at the other downstream side of the connective piping section. The second pipe 22 was disposed at the downstream side of the flame propagation suppression section 3. A flame propagation suppression section 3A was disposed at the further downstream side thereof. At the downstream side thereof, a T-shaped pipe (which may have the same shape as the connective piping section) was disposed. A pressure reduction section 2A was disposed at one downstream side of the T-shaped pipe, and a most-downstream pipe was disposed at the other side.

In addition, shock absorption sections 41 and 42 were provided to surround the pressure reduction sections 2 and 2A, respectively. The shock absorption sections 41 and 42 were connected to each other by a dilution gas passage pipe 44 so that a large amount of air could pass therethrough. The pressure reduction sections were respectively surrounded by shock absorption sections that were each constituted by a stainless steel cylindrical vessel such that, if deflagration, detonation, or the like occurs in the system, pressure change in the system would be mitigated by the shock absorption sections, and the shock absorption sections were connected to each other with a stainless steel pipe for a dilution fluid. In the cylindrical vessel, the pressure resistance was 0.98 MPa(G), and a volume of each cylindrical vessel was approximately 20 times a value obtained by dividing the total pipe volume of the system by the number of the pressure reduction sections. Thus, it was possible to mitigate influence of detonation or the like with the sufficient volume even in a case of rupture of the rupture disk.

Here, the first pipe was made of stainless steel, and a gas passage part thereof had a circular cross section, an inside diameter of 0.78 cm, a cross-sectional area of approximately 0.478 cm², a length of 20 cm, and pressure resistance of 47.7 MPa(G). A part of the connective piping section which was joined to the first pipe was configured similarly to the first pipe. Meanwhile, the most-downstream pipe had an inside diameter of 3.57 cm, a cross-sectional area of approximately 4.486 cm², a length of 240 m, and pressure resistance of 18.0 MPa(G). The pressure resistance of a part of the connective piping section through which the gas passes to the second pipe side was similar to that of the most-downstream pipe. The pressure resistance of the T-shaped pipe was also similar to that of the most-downstream pipe.

In the photocatalyst panel (reactor) for artificial photosynthesis including such a flame extinction mechanism, flame occurred in the first pipe did not propagate to the most-downstream pipe side, and flame occurred in the most-downstream pipe side did not propagate to the first pipe. Thus, breakage of apparatuses and the like were suppressed. Even in a case where the rupture disk had ruptured and detonation pressure was released, dilution was achieved by a large amount of air which passed through the shock absorption sections. Therefore, it was possible to continuously dilute hydrogen, oxygen, and the like which were continuously generated from the photocatalyst panel (reactor) for artificial photosynthesis. Therefore, safety was improved more.

### Comparative Example 1-1

Prepared was a configuration in which the flame propagation suppression section 3 was omitted from the configuration illustrated in FIG. 4. In the configuration, “the first pipe was made of polyvinyl chloride, and a gas passage part thereof had a circular cross section, an inside diameter of 1 cm, a cross-sectional area of approximately 0.875 cm², a length of 200 cm”, and “pressure resistance of 8 MPa(G)” and “a burst pressure of the rupture disk in the pressure reduction section was 0.2 MPa(G)”. An explosion experiment similar to that in Example 1-1 was carried out, except that “the whole mechanism section was filled with a mixed gas of hydrogen:oxygen=2:1, and a pressure thereof was 0.0 MPa(G)”. As a result, although pressure release by rupture of the rupture disk was confirmed, flame propagated from the first pipe to the second pipe.

### Comparative Example 1-2

In FIG. 4, the pressure reduction section 2 was omitted, and the end was closed. An explosion experiment similar to that in Example 1-1 was carried out, except that “a commercially available flame arrester (DA-G-O2H2 manufactured by Fike) was disposed instead of the flame propagation suppression section”, and “the whole mechanism section was filled with a mixed gas of hydrogen:oxygen=2:1, and a pressure thereof was 0.1 MPa(G)”. As a result, the initial pressure of the mixed gas of hydrogen:oxygen=2:1 was 0.1 MPa(G), which was relatively lower than that in Example 1-1. Flame propagated from the first pipe to the second pipe, although the commercially available flame arrester for a hydrogen-oxygen mixed gas was disposed.

### Comparative Example 1-3

An explosion experiment similar to that in Example 1-3 was carried out, except that, in FIG. 2, the flame propagation suppression section 3 was omitted and, instead, a particle-filled pipe was provided which was filled with zircon having a particle diameter of 0.5 mmφ at a height of 17.7 cm at a location of the flame propagation suppression section 3. As a result, although pressure release by rupture of the rupture disk was confirmed, flame propagated from the first pipe 10 to the second pipe 22.

### Comparative Example 1-4

An explosion experiment similar to that in Example 1-3 was carried out, except that a particle-filled pipe was filled with zircon having a particle diameter of 0.26 mmφ at a height of 17.7 cm. As a result, although pressure release by rupture of the rupture disk was confirmed, flame propagated from the first pipe 10 through the second pipe 22.

### Example 1-10

An explosion experiment similar to that in Example 1-3 was carried out, except that a particle-filled pipe was filled with zircon having a particle diameter of 0.19 mmφ at a height of 10.0 cm, and a filling pressure of a mixed gas of hydrogen:oxygen=2:1 was 0.15 MPa(G). As a result, pressure release by rupture of the rupture disk was confirmed. No flame propagation occurred from the first pipe 10 to the second pipe 22. A pressure loss of the filled pipe section in a normal state was 76 kPa (G) during the passage of gas at approximately 10 L/min, which was approximately 2.5 times the pressure loss of the flame propagation suppression section in Example 1-3.

### Comparative Example 1-6

An experiment was carried out to confirm the flame extinction effect in a manner similar to that in Example 1-5, except that the metal sintered body was removed from the flame propagation suppression section. When confirmed with the pressure sensor and the temperature sensor disposed at the further downstream side of the second pipe 22, flame propagated to the downstream side.

### Comparative Example 1-7

An experiment was carried out to confirm the flame extinction effect of the mechanism in a manner similar to that in Example 1-5, except that the metallic housing of the flame propagation suppression section was replaced with a resin housing, and the flow path was made linear. When confirmed with the pressure sensor and the temperature sensor disposed at the further downstream side of the second pipe 22, flame propagated to the downstream side.

### Example 1-11

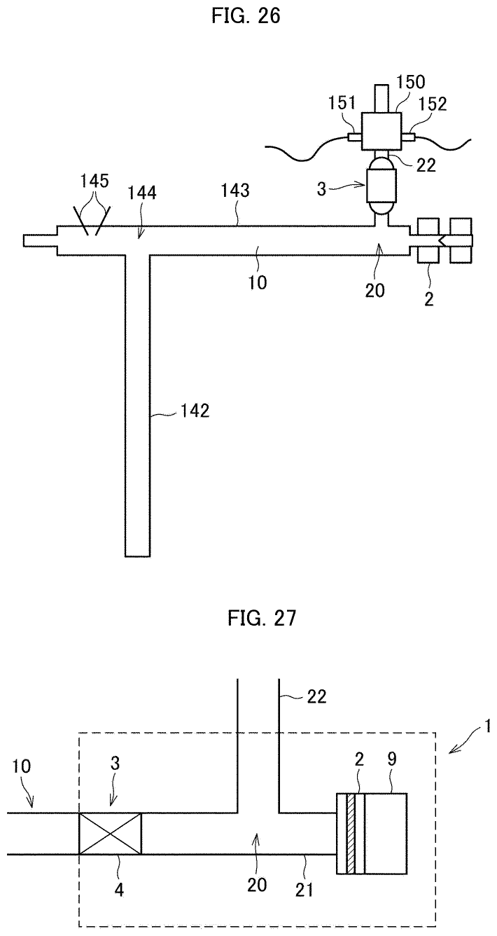

A device as illustrated in FIG. 26 was prepared, and an experiment was carried out. A small photocatalyst panel for virtual artificial photosynthesis was provided at the upstream side of the first pipe 10. The panel included: a glass column section (pressure resistance: 5 MPa(G)) 142 having a length of 1 m, an inside diameter of 2 cm, and a circular cross section to which a photocatalyst can be provided; and a manifold section (pressure resistance: 7 MPa(G)) 143 having a length of 1 m and an inside diameter of 2 cm, in which a mixed gas of hydrogen, oxygen, and water vapor generated from the glass column section was gathered; and the like. Furthermore, a glass column-manifold joint section 144 for joining the glass column section to the manifold section was provided.

The small photocatalyst panel (reactor) may be filled with water. There is a difference in volume of hydrogen detonating gas that can ignite between cases of being filled with water and not being filled with water. Therefore, the following experiment was carried out.

In preparation for the experiment, at the further upstream side of the manifold section (in the left part of FIG. 26 but not illustrated), a premixer for mixing a gas with which an arbitrary gas could be adjusted to have an intended pressure was disposed, and a valve was disposed at the gas outlet of the premixer. A discharging electrode 145 for ignition was prepared at the most upstream part in the manifold section. Here, in the following three water volumes, the effect of the flame extinction device in accordance with the present invention was confirmed: “a case where the manifold section was filled with water to substantially the upper end (with a space at the upper end) and the glass column section was entirely filled with water” (water sealing volume high); “a case where water was removed from the manifold section and the glass column section was entirely filled with water” (no water sealing); and “a case where water was removed from the manifold section and water was removed entirely from the glass column section” (no water sealing, no water in the column).

The flame extinction device was provided at the downstream side of the manifold section as follows. In this case, the downstream side of the manifold corresponds to the first pipe 10. A connective piping section 20 was connected to the manifold, and a pressure reduction section 2 (rupture disk) was provided which included a rupture disk at an end of one downstream side of the connective piping section 20 (on the straight line from the first pipe 10). A flame propagation suppression section 3 was disposed at the other downstream side of the connective piping section 20, and the second pipe 22 was disposed at the downstream side thereof. At the downstream side of the second pipe 22, a detector 150 was disposed which included a temperature sensor 151 and a pressure sensor 152.

In the flame propagation suppression section 3, a bent flow path was prepared in a metallic housing. A part of the flow path was provided with a narrowed portion having an inside diameter of 0.2 cm and a cross-sectional area of approximately 0.0314 cm². A porous body constituted by a metal sintered body was disposed downstream from the narrowed portion. In the metal sintered body, a large number of small pores were intentionally provided so that passage of gas in a normal state could be achieved while avoiding occurrence of an excessive pressure loss. The metal sintered body had a substantially columnar three-dimensional outer shape (height: 18 mm) with a substantially columnar internal space that penetrated from top to bottom at a center in a radial direction of the metal sintered body. A gas passage direction in a normal state, in which detonation and the like do not occur, was set as follows. That is, the gas passes substantially radially through the metal sintered body having a thickness of approximately 3.5 mm from the internal space side toward the outer surface. Meanwhile, the small pores in the metal sintered body are randomly connected to each other. Thus, the gas is caused to ultimately pass through in a random direction. Gaps on the surface of the metal sintered body used included gaps each having a width of 0.50 μm or more and 2.45 μm or less, and simultaneously included gaps of 50 μm to 100 μm, in a longitudinal direction thereof.

As the pressure reduction section 2, a rupture disk unit was used which included a rupture disk. A burst pressure of the rupture disk was 0.5 MPa(G). In this experiment, a silencer was additionally provided to a pressure releasing part of the pressure reduction section 2 so as to reduce a sound pressure.

In order to confirm the flame extinction effect by this flame extinction device, hydrogen and oxygen were directly mixed in a ratio of 2 to 1, without dilution, in the premixer. After that, the whole flame extinction device illustrated in the drawing was filled with the mixed gas of hydrogen:oxygen=2:1, and a pressure thereof was 0.2 MPa(G). After completion of pressure adjustment, the valve disposed at the gas outlet of the premixer was closed, and thus preparation for ignition was completed. After that, the discharging electrode connected to a neon-sign transformer was caused to discharge electricity, and thus ignited the 0.2 MPa(G) hydrogen-oxygen mixed gas.

In all of the three cases (“a case where the manifold section was filled with water to substantially the upper end and the glass column section was entirely filled with water”; “a case where water was removed from the manifold section and the glass column section was entirely filled with water”; and “a case where water was removed from the manifold section and water was removed entirely from the glass column section”) carried out in this experiment, flame did not propagate to the second pipe as a result of confirmation using the pressure sensor and the temperature sensor disposed at the downstream side from the second pipe 22. At the occurrence of detonation, a detonation sound pressure measured at a location approximately 1 m away from the above device did not reach 130 db, and thus a sound pressure reduction effect was confirmed. A pressure loss of the flame propagation suppression mechanism in a normal state which was separately measured was sufficiently small, i.e., 30 kPa (G) during the passage of gas at approximately 10 L/min.

### [Examples of Second Gist of Present Invention]

### Example 2-1

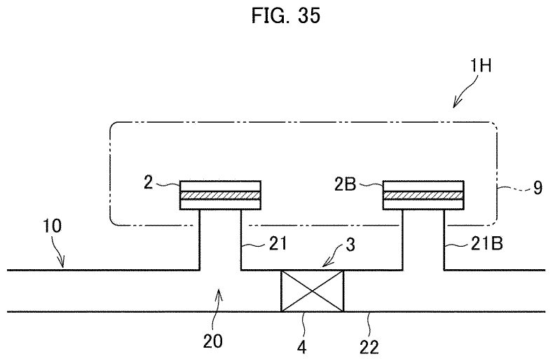

A flame extinction device 1H illustrated in FIG. 35 was prepared.

Stainless steel pipes were used as a first pipe 10, a second pipe 22, and the other pipes, each having a circular cross section with an outside diameter of 6 mm, an inside diameter of 4 mm, and pressure resistance of 29 MPa(G). Pressure reduction sections 2 and 2B were each constituted by a rupture disk unit, and circular rupture disks were each disposed to have a concave shape when seen from the side of a third pipe 21 or 21B, and a burst pressure thereof was 0.5 MPa(G). A shock absorption section 9 that was entirely constituted by a stainless steel cylindrical vessel was provided such that, if deflagration, detonation, or the like occurs in the system, pressure change in the system would be mitigated by the mitigation section. In the cylindrical vessel, pressure resistance was 0.98 MPa(G), and a total volume thereof was approximately 160 times a pipe volume in the system. Thus, it was configured to mitigate influence of detonation or the like with the sufficient volume even in a case of rupture of the rupture disk.

A flame propagation suppression section 3 included a housing which had a circular cross section and was a stainless steel pipe itself, and was filled with zircon beads having a diameter of 250 μm. A narrowed flow path of the flame propagation suppression section was constituted by the randomly charged zircon beads. Thus, the flow path included a large number of nonlinear parts (i.e., bent portions) and the filling density was 62.8%. The flame propagation suppression section thus prepared had a length of 90 mm.

A hydrogen-oxygen mixed gas separation device including three flame extinction devices 1H was prepared as follows. A gas to be supplied to a separator membrane was a hydrogen detonating gas (hydrogen-oxygen mixed gas), and one of the flame extinction devices was provided on the supply side, which was the upstream side of the separator membrane section. When seen from the flame extinction device, the gas supply side was the first pipe side. Another one of the flame extinction devices was also provided to the permeation side, which was the downstream side of the separator membrane section. Another one of the flame extinction devices was also provided to the non-permeation side, which was the further downstream side of the separator membrane section. All of shock absorption sections included in the three flame extinction devices were joined together via stainless steel pipes, and a nitrogen gas was caused to constantly flow in a slightly-pressurized state which was substantially equivalent to an atmospheric pressure.

The hydrogen-oxygen separation device including the flame extinction devices was used to carry out a separation experiment on a hydrogen-oxygen mixed gas using a silylated CHA membrane in which a surface of zeolite having a CHA-type skeletal structure was modified. In this was case, back-pressure control carried out from the non-permeation side, and a supply pressure was 0.1 MPa(G). In regard to the gas composition, the supply side composition was hydrogen:oxygen=2:1, the permeation side composition was hydrogen:oxygen=95.6:4.4, and the non-permeation side composition was hydrogen:oxygen=6.4:93.6. In this case, in addition to the supply side, the permeation side and the non-permeation side were also gases in the detonation range, that is, in a state which needed to take sufficient risk reduction measures, and a flame extinction device was essential.

### Reference Example 2-1

In order to confirm a function and an effect of a structure similar to the flame extinction device illustrated in FIG. 28, an ignition/flame extinction confirmation experiment was carried out using a hydrogen detonating gas as follows. The terms “upstream” and “downstream” in the following descriptions refer to a direction in which the gas passes from the first pipe 10 through the connective piping section 20 to the flame propagation suppression section 3 and further downstream to the second pipe 22 in a normal state.

At the upstream side of the first pipe 10, a premixer for mixing a gas with which an arbitrary gas could be adjusted to have an intended pressure was disposed. At a gas outlet of the premixer, a valve was prepared and a discharging electrode for ignition was prepared on the further downstream side. A length between (i) the premixer and (ii) the branch between the first pipe and the connective piping section was 200 cm.

At the further downstream side of the second pipe 22, high-speed and highly-sensitive pressure sensor and temperature sensor were disposed so as to be able to confirm whether flame intentionally generated using the foregoing discharging electrode for ignition reached the second pipe 22.

The pipes were all made of polyvinyl chloride, and had a circular cross section, an inside diameter of 1 cm, a cross-sectional area of approximately 0.875 cm², and pressure resistance of 8 MPa(G). The polyvinyl chloride used was transparent, and configured so that flame extinction and the like could be confirmed visually or by a high-speed camera.

In the flame propagation suppression section 3, a pipe made of polyvinyl chloride identical with the foregoing one was used as a housing, the pipe was filled with zircon beads having a diameter of 250 μm, and the gas flow path was narrowed. The narrowed flow path of the flame propagation suppression section was constituted by the randomly charged zircon beads. Thus, the flow path included a large number of nonlinear parts (i.e., bent portions). Two types of flame propagation suppression sections were used, one having a length of 45 mm and the other having a length of 60 mm.

In the pressure reduction section 2, as a pressure release device, a rupture disk unit was used which included a rupture disk. A burst pressure of the rupture disk was 0.5 MPa(G), and release of the pressure from the pressure reduction section was carried out with respect to the atmosphere outside the system.

In order to confirm the flame extinction effect by this flame extinction device, hydrogen and oxygen were directly mixed in a ratio of 2 to 1, without dilution, in the premixer. After that, the whole flame extinction device section illustrated in the drawing was filled with the mixed gas of hydrogen:oxygen=2:1, and a pressure thereof was 0.1 MPa(G). After completion of pressure adjustment, the valve disposed at the gas outlet of the premixer was closed, and thus preparation for ignition was completed. After that, the discharging electrode connected to a neon-sign transformer was caused to discharge electricity, and thus ignited the 0.1 MPa(G) hydrogen-oxygen mixed gas.

In both of f the cases where the flame propagation suppression sections were 45 mm and 60 mm in length, the rupture disk ruptured and the gas leaked to the outside of the system. However, when confirmed with the pressure sensor and the temperature sensor, flame did not propagate to the downstream side of the flame propagation suppression section 3.

In view of these, the effect in the case described in Example 2-1 is expected to be greater than that described in this Reference Example 2-1 because the flame propagation suppression section is longer, i.e., 90 mm in Example 2-1. Moreover, in the case described in Example 2-1, the plurality of flame extinction devices and the plurality of pressure reduction sections therein are provided. Therefore, the effect is expected to be greater than that described in this Reference Example 2-1. In addition, in the case described in Example 2-1, all of the pressure reduction sections are disposed inside the shock absorption section through which nitrogen passes. Under such conditions, therefore, it seems that gas leakage to the outside of the system does not occur, and flame propagation would be suppressed more safely if ignition occurs at any location.

### Reference Example 2-2

The following points were changed from Reference Example 2-1, and an explosion velocity at occurrence of detonation was measured. That is, the flame propagation suppression section 3 was not disposed, and the connective piping section 20 and the second pipe 22 were directly connected to each other. The pressure of the mixed gas of hydrogen:oxygen=2:1 with which the measurement system was filled was reduced to 0.0 MPa(G) (atmospheric pressure).

As a result, the flame propagation velocity measured with the high-speed camera was approximately 6500 m/sec. From this result, it can be said that, in the case of Reference Example 2-1, detonation occurred. Furthermore, considering that the initial pressure of the mixed gas was 0.1 MPa(G) in Reference Example 2-1 which was higher than that of this Reference Example 2-2, it can be inferred that the detonation had further greater power. Thus, it can be found that the flame extinction device of Reference Example 2-1 can suppress also flame propagation due to detonation of the pressurized hydrogen-oxygen mixed gas which has still greater power than a normal state.

Considering Reference Example 2-1 and Reference Example 2-2 together, it seems that, in the case described in Example 2-1, if detonation which is more intense than a normal state occurs at any location, flame propagation would be suppressed more safely.

### Example 2-2

At the upstream side of the first pipe, a panel (reactor) for artificial photocatalyst photosynthesis was provided which included a photocatalyst that can decompose water into hydrogen and oxygen by irradiation with sunlight and contact with the water (or water vapor). From the photocatalyst panel (reactor) for artificial photosynthesis, a hydrogen-oxygen water vapor mixed gas was generated which contained saturated water vapor with a composition of hydrogen:oxygen=2:1. In order to transport the hydrogen-oxygen water vapor mixed gas to the downstream side, a pressure thereof was adjusted to 0.1 MPa(G). Under such conditions, deflagration and detonation may occur upon ignition of the mixed gas. Therefore, it is necessary to provide a flame extinction device which is more powerful than conventional ones.

In view of this, as illustrated in FIG. 31, a flame propagation suppression section 3 was disposed at the downstream side of the first pipe 10. A connective piping section 20 having a T-shape was disposed downstream of the flame propagation suppression section 3. A pressure reduction section 2 was disposed on one downstream side of the connective piping section. A second pipe 22 was disposed at the other downstream side (on the straight line from the first pipe) of the connective piping section. A shock absorption section 9 was further disposed so as to make contact with the pressure reduction section 2.

Here, the first pipe was made of stainless steel, and a gas passage part thereof had a circular cross section, an inside diameter of 1.07 cm, a cross-sectional area of approximately 0.900 cm², a length of 20 cm, and pressure resistance of 21.6 MPa(G). Meanwhile, the second pipe had an inside diameter of 2.39 cm, a cross-sectional area of approximately 4.486 cm², a length of 120 m, and pressure resistance of 14.5 MPa(G). A part of the connective piping section 20 which was joined to the second pipe 22 was configured similarly to the second pipe.

In the flame propagation suppression section 3, a bent flow path was prepared in a metallic housing 4. A part of the flow path was provided with a narrowed portion having an inside diameter of 0.3 cm and a cross-sectional area of approximately 0.0707 cm². A metal sintered body was disposed downstream from the narrowed portion. In the metal sintered body, a large number of small pores were intentionally provided so that passage of gas in a normal state could be achieved while avoiding occurrence of an excessive pressure loss. The metal sintered body had a substantially columnar three-dimensional outer shape (height: 46 mm) with a substantially columnar internal space that penetrated from top to bottom at a center in a radial direction of the metal sintered body. A gas passage direction in a normal state, in which detonation and the like do not occur, was set as follows. That is, the gas passes substantially radially through the metal sintered body having a thickness of approximately 5.1 mm from the external space side toward the inner surface. Meanwhile, the small pores in the metal sintered body are randomly connected to each other. Thus, the gas is caused to ultimately pass through in a random direction. Gaps on the surface of the metal sintered body used included gaps each having a width of 0.50 μm or more and 2.45 μm or less, and simultaneously included gaps of 50 μm to 100 μm, in a longitudinal direction thereof.

In the pressure reduction section 2, as a pressure release device, a rupture disk unit was used which included a rupture disk. The rupture disk had a burst pressure of 0.5 MPa(G), and was provided so as to have a concave surface with respect to the connective piping section side. The shock absorption section 9 was provided to make contact with the rupture disk unit so as to receive a release pressure if the rupture disk ruptures. The shock absorption section was a cylindrical vessel made of stainless steel, and was constituted by an SUS material having pressure resistance of 15 MPa(G). A total volume thereof was approximately 3 times a pipe volume in the system. Thus, it was configured to mitigate influence of detonation or the like with the sufficient volume even in a case of rupture of the rupture disk. Moreover, a large volume of an air gas was caused to constantly pass through the shock absorption section in a slightly-pressurized state which was substantially equivalent to an atmospheric pressure.

In the photocatalyst panel (reactor) for artificial photosynthesis including such a flame extinction device, flame ignited in the first pipe 10 does not propagate to the second pipe 22. Flame ignited in the second pipe 22 does also not propagate to the first pipe 10, and breakage of various apparatuses disposed at the further upstream side is suppressed.

### [Examples of Third Gist of Present Invention]

### Example 3-1

Water was decomposed using the photochemical reactor illustrated in FIGS. 38 through 40, and hydrogen was generated.

The main configuration of the device was as follows.

Length of manifold 502: 450 mm
Number of tube assemblies 510: nine
Inclination angle of tube assembly 510: 30°
Material of outer cylinder 511: borosilicate glass
Length of outer cylinder 511: 370 mm
Outside diameter of outer cylinder 511: 24 mm
Inside diameter of outer cylinder 511: 1.9 mm
Material of inner cylinder 512: borosilicate glass
Length of inner cylinder 512: 360 mm
Outside diameter of inner cylinder 512: 18 mm
Inside diameter of inner cylinder 512: 15.6 mm
Sealing member 514: silicon resin plug

A photocatalyst was produced as follows, and was disposed on the outer peripheral surface of the inner cylinder 512.

### <Preparation of Photocatalyst SrTiO₃:Al>

With 100 g of strontium titanate SrTiO₃ (Mitsuwa Chemicals Co., Ltd.), 1.11 g of aluminum oxide Al₂O₃ (Sigma Aldrich) was mixed, and a resultant mixture was sufficiently mixed with 500 g of strontium chloride SrCl₂ (KANTO CHEMICAL CO., INC., 98.0%) which was separately subjected to a pulverizing process. A resultant mixture was divided into three equal parts in alumina crucibles B5 (SSA-S, 280 mL), the lids were closed, and then sintered at 1150° C. for 48 hours in an electric oven. After cooling to room temperature, the sample was cleaned with water, and thus aluminum-doped strontium titanate SrTiO₃:Al, which is a photocatalyst, was obtained.

<Preparation of Promoter-Supporting Photocatalyst RhCrOₓ/SrTiO₃:Al>

The aluminum-doped strontium titanate SrTiO₃:Al powder was suspended in Milli-Q ultrapure water. To a resultant suspension, separately prepared rhodium chloride RhCl₃·nH₂O (n≈3) aqueous solution and chromium nitrate Cr(NO₃)₃(H₂O)₉ aqueous solution were added so that Rh and Cr metals were each 0.1 wt %. After that, water was evaporated while stirring. This sample was heated in an electric oven at 350° C. for 2 hours, and thus a promoter-supporting RhCrOₓ/SrTiO₃:Al was obtained.

<Preparation of Glass Tube to which Sample of Promoter-Supporting Photocatalyst is Applied>

The promoter-supporting photocatalyst RhCrOₓ/SrTiO₃:Al powder was suspended in Milli-Q ultrapure water, and silica colloid (Sigma Aldrich, HS-30) was added to the suspension so that a weight ratio was photocatalyst powder:silica=1:1. This mixed solution was applied to a cleaned borosilicate glass tube (inner cylinder) using an air brush while being heated on a hot plate. After that, the coated glass tube was heated at 200° C. for 2 hours in a forced circulation style constant temperature bath while causing air to pass through. Thus, a photocatalyst-coated inner cylinder was obtained. An amount of the photocatalyst applied was 20 g/m² to 25 g/m² with respect to the outer surface of the inner cylinder.

### <Evaluation of Photocatalytic Reaction>

As illustrated in FIG. 40, water was introduced into the manifold 502 so that a whole of the outer peripheral surface of the inner cylinder 512 was completely immersed in water. After that, irradiation with pseudo-sunlight (IWASAKI ELECTRIC CO., LTD.) was carried out while a nitrogen gas was caused to pass through the gas-passage space S at 200 mL/min. In this condition, the photocatalytic activity was evaluated by measuring the hydrogen-oxygen generation amount using gas chromatography (Agilent 490MicroGC).

A result is indicated in FIG. 41. FIG. 41 is a graph illustrating the result of Example 3-1. As illustrated in FIG. 41, the hydrogen generation rate almost reached a steady-state value in 3 to 4 hours after the start of irradiation with light, and was 0.8 μmol/h cm² to 0.9 μmol/h cm².

### Comparative Example 3-1

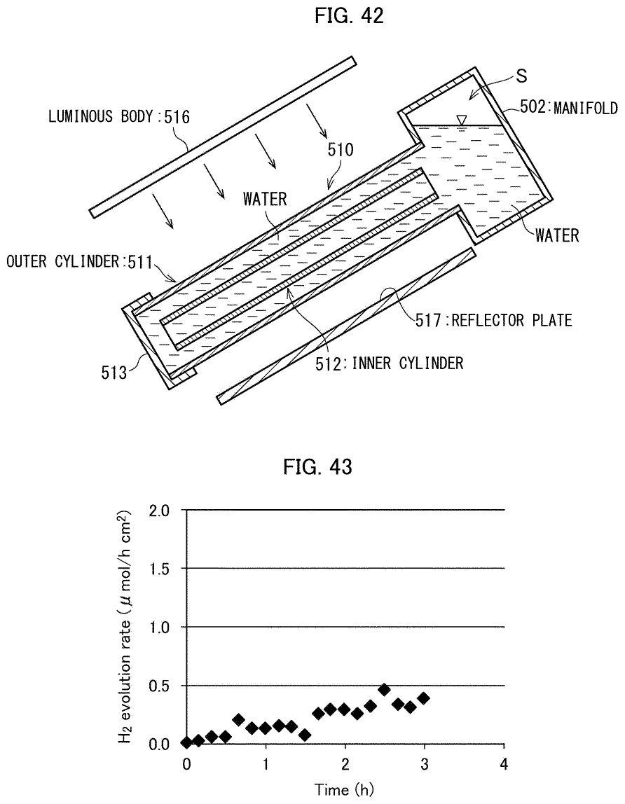

FIG. 42 is a schematic cross-sectional view illustrating a device of Comparative Example 3-1. As illustrated in FIG. 42, the water decomposition activity was evaluated in a manner similar to that in Example 3-1, except that the sealing member 514 was not provided and the inner cylinder 512 was also immersed in water. A result is indicated in FIG. 43. FIG. 43 is a graph illustrating the result of Comparative Example 3-1. As illustrated in FIG. 43, the hydrogen generation rate was approximately 0.3 μmol/h cm² to 0.4 μmol/h cm² in 3 hours after the start of irradiation with light, and the activity was considerably lower than in Example.

As indicated in Example 3-1 and Comparative Example 3-1 above, the hydrogen generation rate is higher and the water decomposition efficiency of the reactor is higher in the case where both ends of the inner cylinder are sealed so that water does not enter the inside. This seems to be because: the promoter of the photocatalyst is partially eluted by immersion in water before irradiation with light, and a reprecipitation phenomenon has occurred by light irradiation; in Example 3-1 in which both ends of the inner cylinder are sealed, the eluted promoter does not move to the inside of the inner cylinder, and therefore the promoter can be present in the vicinity of the photocatalyst surface and reprecipitation of the promoter on the photocatalyst surface is likely to occur; in contrast, in Comparative Example 3-1 in which water is also supplied inside the inner cylinder, the eluted promoter moves to the inside of the inner cylinder, and the promoter does not re-precipitate on the photocatalyst surface.

In water decomposition reaction using sunlight, irradiation with sunlight occurs during the daytime and irradiation with light does not occur during the nighttime, and these states are repeated alternately. Therefore, elution of t the promoter is inevitable. Therefore, as in the present invention, by providing a structure in which both ends of the inner cylinder are sealed or the inner cylinder is formed into a rod shape so that water does not enter the inside, it is possible to promote reprecipitation of the promoter, improve water decomposition efficiency, and extend the lifetime of the photocatalyst. These effects are advantageous for reducing the cost of the hydrogen production process.

### REFERENCE SIGNS LIST

1, 1A through H, 160: Flame extinction device
2, 2A, 2B, 210, 220: Pressure reduction section
3, 3A, 300, 310, 320, 330, 340, 350, 360, 370, 380, 390: Flame propagation suppression section
4, 4A, 301, 351, 381: Housing
9, 41, 42, 400: Shock absorption section
10: First pipe
20, 20A: Connective piping section
21, 21′, 21A, 21B: Third pipe
22: Second pipe
43 through 45: Dilution gas passage pipe
100: Photochemical reaction plant (production device for producing hydrogen and oxygen, hydrogen-oxygen production device)
110: Photochemical reaction device
111: Base
112: Fixture
120: Condensate water removal device
130: Humidity reduction device
140: Separator membrane device
142: Glass column section
143: Manifold section
144: Glass column-manifold joint section
145: Discharging electrode
150: Detector
151: Temperature sensor
152: Pressure sensor
170: Vacuum pump
200: Safety valve
201: Valve chest
202: Valve seat
203: Spring
204: Valve element
205: Communicating pipe
211, 212: Flange
213, 223: Rupture disk
302: Baffle plate
303, 363: Porous body
312: Screw
352: Communicating plate
354: Communicating hole
365: Top section
366, 386: Disk part
367, 387: Shaft part
388: First cylindrical part
389: Second cylindrical part
401: Main body
402: Lid part
403: Inlet pipe
404: Exhaust pipe
405: Bolt band
501: Photochemical reactor
502: Manifold
503: Carrier gas inlet
504: Gas outlet
510: Tube assembly
511: Outer cylinder
512: Inner cylinder (columnar structure)
513, 514: Sealing member
516: Luminous body
517: Reflector plate
701: Water decomposition section
702, 702a, 702b, 704, 705, 705a, 705b, 707, 709, 710, 714, 716: Pipe
703: Condensate water removal section
706: Humidity reduction section (moisture absorption section)
708: Membrane separation section
712: Gas-liquid separation section
713: Outside air supply means
715: Heater
720: Membrane gas dryer
721: Water vapor permeable membrane
722, 723: Chamber

1. A flame extinction device, comprising:
a connective piping section which is connected to a first pipe, a second pipe, and a third pipe, a raw gas being supplied to the first pipe and the second pipe;
a flame propagation suppression section that has a porous portion through which the raw gas passes, the flame propagation suppression section being provided on the first pipe side and/or the second pipe side when seen from the connective piping section; and
a pressure reduction section that is disposed at an end part of the third pipe, the pressure reduction section reducing an internal pressure of the third pipe in a case where the internal pressure has risen,
the third pipe being not orthogonal to any of the first pipe and the second pipe.

2. A flame extinction device, comprising:
a connective piping section which is connected to a first pipe, a second pipe, and a third pipe, a raw gas passing through the first pipe and the second pipe;
a flame propagation suppression section that has a porous portion through which the raw gas passes, the flame propagation suppression section being provided on the first pipe side and/or the second pipe side when seen from the connective piping section; and
a pressure reduction section that is disposed at an end part of the third pipe, the pressure reduction section reducing an internal pressure of the third pipe by generating, at the end part, a reflected wave which interferes with an incident wave of a shock wave,
the third pipe being not orthogonal to any of the first pipe and the second pipe.

3. The flame extinction device as set forth in claim 1, wherein:
the flame propagation suppression section further includes a narrowed portion through which the raw gas passes.

4. The flame extinction device as set forth in claim 3, wherein:
a diameter of the narrowed portion is 0.3 mm or more and 4.5 mm or less.

5. The flame extinction device as set forth in claim 1, wherein:
the flame propagation suppression section further includes a bent portion through which the raw gas passes.

6. The flame extinction device as set forth in claim 1, wherein:
a pressure resistance P(tube) (MPa(G)) of the connective piping section satisfies a formula below:
2≤P(tube)≤30.

7. The flame extinction device as set forth in claim 1, wherein:
the pressure reduction section includes a reversible pressure release device; and
a lowest release pressure P(release) (MPa(G)) of the reversible pressure release device satisfies a formula below:
0.1≤P(release)≤0.98.

8. The flame extinction device as set forth in claim 1, wherein:
the pressure reduction section includes a rupture disk unit that blocks the third pipe; and
a burst pressure P(burst) (MPa(G)) of a rupture disk included in the rupture disk unit satisfies a formula below:
0.25≤P(burst)≤12.

9. The flame extinction device as set forth in claim 1, wherein:
the flame propagation suppression section further includes a housing which is provided in the first pipe and/or the second pipe and through which the raw gas passes; and
the porous portion is provided inside the housing.

10. The flame extinction device as set forth in claim 9, wherein:
the housing is made of metal.

11. The flame extinction device as set forth in claim 1, wherein:
the porous portion is a substantially cylindrical porous body.

12. The flame extinction device as set forth in claim 1, wherein:
a porous body constituting the porous portion has gaps each having a width of 0.50 μm or more and 2.45 μm or less in a longitudinal direction.

13. The flame extinction device as set forth in claim 1, wherein:
a porous body constituting the porous portion has gaps each having a width of 50 μm or more and 100 μm or less in a longitudinal direction.

14. The flame extinction device as set forth in claim 1, wherein:
the raw gas is a mixed gas containing hydrogen and oxygen.

15. The flame extinction device as set forth in claim 14, wherein:
the mixed gas further contains water vapor.

16. A hydrogen production device, comprising:
a generation section that generates a hydrogen-containing gas; and
a flame extinction device that communicates with the generation section,
the flame extinction device being a flame extinction device recited in claim 1.

17. A flame extinction device, comprising:
a connective piping section which is connected to a first pipe, a second pipe, and a third pipe, a raw gas passing through the first pipe and the second pipe;
a flame propagation suppression section that has a porous portion through which the raw gas passes, the flame propagation suppression section being provided on the first pipe side and/or the second pipe side when seen from the connective piping section; and
a pressure reduction section that is disposed at an end part of the third pipe, the pressure reduction section reducing an internal pressure of the third pipe in a case where the internal pressure has risen; and
a shock absorption section that surrounds and/or makes contact with the pressure reduction section, the shock absorption section receiving a pressure released when the pressure reduction section reduces the internal pressure.

18. The flame extinction device as set forth in claim 17, wherein:
the flame propagation suppression section further includes a narrowed portion through which the raw gas passes.

19. The flame extinction device as set forth in claim 17, wherein:
a pressure of the shock absorption section in a normal state is substantially an atmospheric pressure.

20. The flame extinction device as set forth in claim 17, wherein:
the shock absorption section allows a gas to pass therethrough from outside the shock absorption section.

21. The flame extinction device as set forth in claim 18, wherein:
the narrowed portion includes a nonlinear part.
